(19) United States
(12) Patent Application Publication
(10) Pub. No.: US 2017/0264371 A1
(43) Pub. Date: Sep. 14, 2017

(54) TRANSMISSION APPARATUS AND WAVELENGTH SETTING METHOD

(71) Applicant: FUJITSU LIMITED, Kawasaki-shi (JP)

(72) Inventors: Shinsuke FUKUI, Ebetsu (JP); Noriaki Mizuguchi, Sapporo (JP); Miki Onaka, Kawasaki (JP)

(73) Assignee: FUJITSU LIMITED, Kawasaki-shi (JP)

(21) Appl. No.: 15/436,026

(22) Filed: Feb. 17, 2017

(30) Foreign Application Priority Data
Mar. 10, 2016 (JP) 2016-047479

(51) Int. Cl. H04B 10/572; H04J 14/02; H04B 10/079

(52) U.S. Cl. CPC H04B 10/572; H04B 10/07957; H04J 14/02

(57) ABSTRACT

There is provided a transmission apparatus including: generators to generate optical signals having wavelengths included in a predetermined band, the wavelengths being variable; a transmitter to multiplex the optical signals and transmit the optical signals to another transmission apparatus; a memory; and a processor coupled to the memory and the processor to: monitor reception quality of an optical signal for monitoring received by the another transmission apparatus while changing a wavelength of the optical signal for monitoring which is generated by the generators, determine a first wavelength of a first optical signal having a longest wavelength and a second wavelength of a second optical signal having a shortest wavelength, based on the reception quality monitored, determine a wavelength of an optical signal except for the first and second optical signals, based on the first second wavelengths, and control the wavelength generated by the generators, based on the wavelength determined.

### CROSS-REFERENCE TO RELATED APPLICATION

This application is based upon and claims the benefit of priority of the prior Japanese Patent Application No. 2016-047479, filed on Mar. 10, 2016, the entire contents of which are incorporated herein by reference.

### FIELD

The embodiments discussed herein are related to a transmission apparatus and a wavelength setting method.

### BACKGROUND

In the related art, known is a wavelength division multiplexing (WDM) system that communicates by using optical signals of a plurality of wavelengths at the same time. In addition, known is a technology in that strength of a specific frequency component is measured while performing sweeps of wavelength of a wavelength-selective light source across a wide wavelength range before the start of operation and the optimum wavelength for communication is determined (for example, refer to Japanese Laid-open Patent Publication No. 11-346191).

### SUMMARY

According to an aspect of the invention, a transmission apparatus includes: a plurality of generators configured to generate a plurality of optical signals having wavelengths included in a predetermined band, the wavelengths being variable; a transmitter configured to multiplex the plurality of optical signals generated by the plurality of generators and transmit the plurality of optical signals multiplexed thereby to another transmission apparatus; a memory; and a processor coupled to the memory and the processor configured to: monitor reception quality of an optical signal for monitoring received by the another transmission apparatus while changing a wavelength of the optical signal for monitoring which is generated by a generator of the plurality of generators, determine a first wavelength of a first optical signal having a longest wavelength in the plurality of optical signals and a second wavelength of a second optical signal having a shortest wavelength in the plurality of optical signals, based on the reception quality monitored, determine a wavelength of an optical signal of the plurality of optical signals except for the first optical signal and the second optical signal, based on the first wavelength and the second wavelength, and control the wavelengths of the plurality of optical signals generated by the plurality of generators, based on the wavelength of the plurality of optical signals determined.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of a transfer system according to a first embodiment;

FIG. 2 is a diagram illustrating one example of a super-channel method that may be applied to the transfer system according to the first embodiment;

FIG. 3 is a diagram illustrating one example of an optical transfer system according to the first embodiment;

FIG. 4 is a diagram illustrating one example of an optical transmitter according to the first embodiment;

FIG. 5 is a diagram illustrating one example of an optical receiver according to the first embodiment;

FIG. 6 is a diagram illustrating one example of a case where the spacing between sub-carriers is narrow in the optical transfer system according to the first embodiment;

FIG. 7 is a diagram illustrating one example of a case where the spacing between a sub-carrier and a restricted band is narrow in the optical transfer system according to the first embodiment;

FIG. 8 is a diagram illustrating one example of a low-frequency side sub-carrier sweep in the optical transfer system according to the first embodiment;

FIG. 9 is a diagram illustrating one example of determining the frequency of a sub-carrier #1 in the optical transfer system according to the first embodiment;

FIG. 10 is a diagram illustrating one example of a high-frequency side sub-carrier sweep in the transfer system according to the first embodiment;

FIG. 11 is a diagram illustrating one example of determining the frequency of a sub-carrier #4 in the transfer system according to the first embodiment;

FIG. 12 is a diagram illustrating one example of determining the frequency of a sub-carrier #3 in the optical transfer system according to the first embodiment;

FIG. 13 is a diagram illustrating one example of determining the frequency of the sub-carrier #4 in the optical transfer system according to the first embodiment;

FIG. 14 is a flowchart (part 1) illustrating one example of a process performed at the start of operation by a control device according to the first embodiment;

FIG. 15 is a flowchart (part 2) illustrating one example of the process performed at the start of operation by the control device according to the first embodiment;

FIG. 16 is a diagram illustrating one example of a high-frequency side sub-carrier sweep in an optical transfer system according to a second embodiment;

FIG. 17 is a diagram illustrating one example of determining the frequency of the sub-carrier #1 in the optical transfer system according to the second embodiment;

FIG. 18 is a flowchart (part 1) illustrating one example of a process performed at the start of operation by a control device according to the second embodiment;

FIG. 19 is a flowchart (part 2) illustrating one example of the process performed at the start of operation by the control device according to the second embodiment;

FIG. 20 is a flowchart (part 1) illustrating one example of a frequency control process performed during operation by a control device according to a third embodiment;

FIG. 21 is a flowchart (part 2) illustrating one example of the frequency control process performed during operation by the control device according to the third embodiment;

FIG. 22 is a flowchart (part 3) illustrating one example of the frequency control process performed during operation by the control device according to the third embodiment;

FIG. 23 is a flowchart (part 1) illustrating another example of the frequency control process performed during operation by the control device according to the third embodiment;

FIG. 24 is a flowchart (part 2) illustrating another example of the frequency control process performed during operation by the control device according to the third embodiment;

FIG. 25 is a flowchart (part 3) illustrating another example of the frequency control process performed during operation by the control device according to the third embodiment;

FIG. 26 is a flowchart (part 4) illustrating another example of the frequency control process performed during operation by the control device according to the third embodiment;

FIG. 27 is a diagram illustrating one example of an optical transfer system according to a fourth embodiment;

FIG. 28 is a diagram illustrating one example of an optical receiver according to the fourth embodiment;

FIG. 29 is a flowchart (part 1) illustrating one example of a process performed at the start of operation by a control device according to the fourth embodiment;

FIG. 30 is a flowchart (part 2) illustrating one example of the process performed at the start of operation by the control device according to the fourth embodiment;

FIG. 31 is a diagram illustrating one example of an optical transfer system according to a fifth embodiment;

FIG. 32 is a diagram illustrating one example of setting the transmission bandwidth of an optical channel filter according to the fifth embodiment;

FIG. 33 is a flowchart illustrating one example of a process performed at the start of operation by a control device according to the fifth embodiment;

FIG. 34 is a diagram illustrating one example of setting the baud rate of each sub-carrier performed by a control device according to a sixth embodiment;

FIG. 35 is a flowchart illustrating one example of a process performed at the start of operation by the control device according to the sixth embodiment;

FIG. 36 is a diagram illustrating one example of setting a Nyquist filter performed at the start of operation by the control device according to the sixth embodiment;

FIG. 37 is a diagram illustrating one example of setting the Nyquist filter performed at the time of operation by the control device according to the sixth embodiment;

FIG. 38 is a diagram illustrating one example of a low-frequency side sub-carrier sweep in an optical transfer system according to a seventh embodiment;

FIG. 39 is a diagram illustrating one example of a high-frequency side sub-carrier sweep in the optical transfer system according to the seventh embodiment;

FIG. 40 is a flowchart (part 1) illustrating one example of a process performed at the start of operation by a control device according to an eighth embodiment;

FIG. 41 is a flowchart (part 2) illustrating one example of the process performed at the start of operation by the control device according to the eighth embodiment;

FIG. 42 is a diagram illustrating one example of each sub-carrier in an optical transfer system according to a ninth embodiment;

FIG. 43 is a diagram (part 1) illustrating one example of determining the frequency of a sub-carrier other than both end sub-carriers in the optical transfer system according to the ninth embodiment; and

FIG. 44 is a diagram (part 2) illustrating one example of determining the frequency of a sub-carrier other than both end sub-carriers in the optical transfer system according to the ninth embodiment.

### DESCRIPTION OF EMBODIMENTS

The technology for determining the optimum wavelength in the related art poses, for example, a problem that adjusting arrangement of the wavelength of each optical signal takes time or a problem that the size of a calculation circuit for adjusting arrangement of the wavelength of each optical signal is increased, before the start of operation of a WDM system.

Hereinafter, embodiments of a transmission apparatus and a wavelength setting method that may reduce an increase in the size of a calculation circuit and adjust wavelength arrangement in a small amount of time will be described in detail with reference to the drawings.

### First Embodiment

[Transfer System According to First Embodiment]

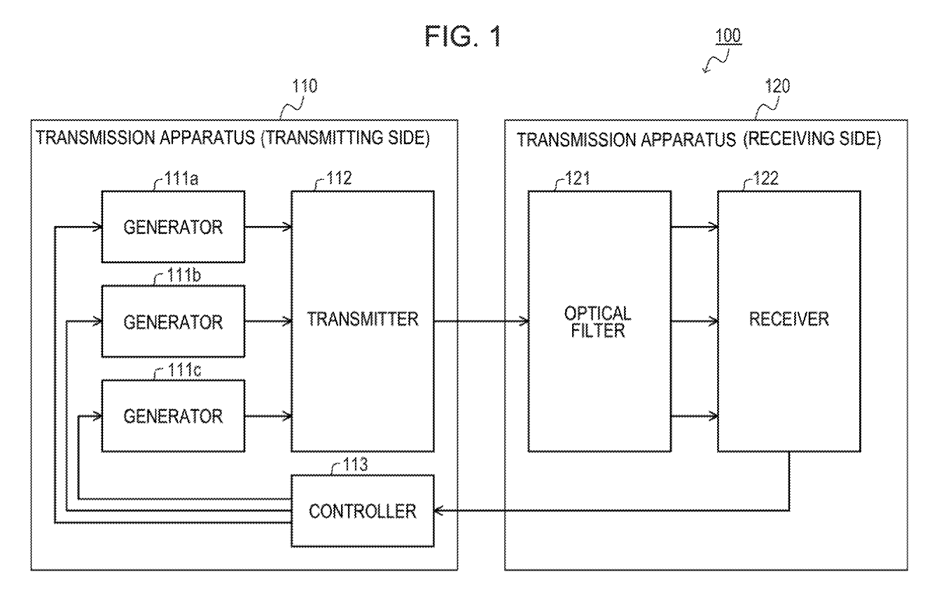

FIG. 1 is a diagram illustrating one example of a transfer system according to a first embodiment. As illustrated in FIG. 1, a transfer system 100 according to the first embodiment includes a transmission apparatus 110 and a transmission apparatus 120. The transmission apparatus 110 is a transmission apparatus of transmitting side that multiplexes and transmits each optical signal of different wavelengths (frequencies) included in a predetermined bandwidth. The predetermined bandwidth is, for example, the bandwidth of one super-channel described later. The transmission apparatus 120 is a transmission apparatus of receiving side that uses an optical filter to extract an optical component of the predetermined bandwidth from the optical signal transmitted by the transmission apparatus 110 and receives an optical signal included in the extracted optical component.

The transmission apparatus 110 includes, for example, generators 111a to 111c, a transmitter 112, and a controller 113. The generators 111a to 111c are a plurality of generators that generate each optical signal of different wavelengths included in the predetermined bandwidth. The wavelength of each optical signal generated by the generators 111a to 111c is controlled by the controller 113. The generators 111a to 111c output each generated signal to the transmitter 112.

The transmitter 112 multiplexes each optical signal output from the generators 111a to 111c and transmits the multiplexed optical signal to the transmission apparatus 120. Each optical signal output from the generators 111a to 111c is each optical signal having different wavelengths and thus may be wavelength-multiplexed by being multiplexed by the transmitter 112.

The controller 113, while changing the wavelength of an optical signal for monitoring generated by a generator included in each of the generators 111a to 111c, monitors the reception quality of the transmission apparatus 120 for the optical signal having a wavelength thereof changed. The optical signal for monitoring is an optical signal that may be used to monitor reception quality for determining the wavelength of an optical signal. The optical signal for monitoring may be an optical signal for testing or may be an optical signal that includes real data. Changing the wavelength of an optical signal is changing the frequency of an optical signal. For example, the controller 113, while changing the wavelength of the optical signal generated by the generator 111a, receives a detection result from the transmission apparatus 120 for the reception quality of the transmission apparatus 120 for the optical signal generated by the generator 111a and thereby monitors reception quality.

In addition, the controller 113, while changing the wavelength of the optical signal generated by the generator 111a to at least two types of wavelengths, receives a detection result from the transmission apparatus 120 for each reception quality at the time of change to at least two types of wavelengths.

The controller 113 determines each wavelength of a first optical signal and a second optical signal of each optical signal generated by the generators 111a to 111c based on the result of monitoring reception quality, the first optical signal having the longest wavelength (low frequency) and the second optical signal having the shortest wavelength (high frequency). Determining the wavelength of an optical signal is determining the frequency of an optical signal. For example, the controller 113 determines a wavelength Fa of the optical signal generated by the generator 111a as the first optical signal of the longest wavelength and determines a wavelength Fc of the optical signal generated by the generator 111c as the second optical signal of the shortest wavelength.

In addition, the controller 113 determines the wavelength of an optical signal of each optical signal generated by the generators 111a to 111c except for the first optical signal and the second optical signal by calculation based on each wavelength of the first optical signal and the second optical signal determined. For example, the controller 113 determines a wavelength Fb of the optical signal generated by the generator 111b as an optical signal except for the first optical signal and the second optical signal of each optical signal by calculation based on the wavelengths Fa and Fc.

For example, the controller 113 determines the wavelength of an optical signal of each optical signal except for the first optical signal and the second optical signal such that the wavelengths of optical signals generated by the generators 111a to 111c are set with equal frequency spacing. For example, the controller 113 determines the wavelength Fb of the optical signal generated by the generator 111b by Fb=(Fa+Fc)/2.

The controller 113 controls the generators 111a to 111c to generate an optical signal of each determined wavelength. Controlling the generators 111a to 111c to generate an optical signal of each determined wavelength is controlling the generators 111a to 111c to generate an optical signal of each determined frequency. Accordingly, for example, each wavelength of the generators 111a to 111c may be set at the start of operation in which real data is transmitted by optical signal from the transmission apparatus 110 to the transmission apparatus 120.

The transmission apparatus 120 includes an optical filter 121 and a receiver 122. The optical filter 121 extracts an optical component of the predetermined bandwidth from the optical signal transmitted by the transmission apparatus 110 and outputs the extracted optical component of the predetermined bandwidth to the receiver 122. For example, the optical filter 121 is an optical filter that has a wavelength transmission characteristic in which the transmittance thereof in the predetermined bandwidth is higher than the transmittance thereof in other than the predetermined bandwidth. For example, the optical filter 121 may be realized by a liquid crystal on silicon (LCOS) element.

The receiver 122 receives an optical signal included in the optical component of the predetermined bandwidth output from the optical filter 121. For example, the receiver 122 receives each optical signal that is generated by the generators 111a to 111c and included in the optical component of the predetermined bandwidth output from the optical filter 121. In addition, the receiver 122 transmits a detection result for reception quality for each received optical signal to the controller 113 in a case where the wavelength of the optical signal generated by a generator included in the generators 111a to 111c is changed by the controller 113.

The transmission apparatus 110, while changing the wavelength of the optical signal generated by any generator of the generators 111a to 111c, monitors the reception quality of the transmission apparatus 120 for the optical signal generated by the generator. In addition, the transmission apparatus 110, based on the result of monitoring, determines each wavelength of the first optical signal of the longest wavelength and the second optical signal of the shortest wavelength and determines the wavelengths of the remaining optical signals by calculation based on each determined wavelength. The transmission apparatus 110 controls the generators 111a to 111c to generate an optical signal of each determined wavelength.

Accordingly, the wavelength of an optical signal other than the first optical signal and the second optical signal may be determined by simple calculation based on each wavelength of the first optical signal and the second optical signal. Thus, an increase in the size of a calculation circuit may be reduced, and arrangement of wavelengths may be adjusted in a small amount of time.

While the controller 113 is configured to be disposed in the transmission apparatus 110 in the example illustrated in FIG. 1, the present embodiment is not limited to such a configuration. For example, the controller 113 may be configured to be disposed in the transmission apparatus 120. In this case, the controller 113 performs monitoring by, for example, transmitting to the transmission apparatus 110 a control signal that changes the wavelength of the optical signal generated by the generator 111a and acquiring from the receiver 122 a detection result for the reception quality of the receiver 122 for the optical signal generated by the generator 111a. In addition, the controller 113 controls the generators 111a to 111c to generate an optical signal of each determined wavelength by transmitting to the transmission apparatus 110 a control signal that provides an instruction to generate an optical signal of each determined wavelength. The controller 113 may be configured to be disposed in a different apparatus from the transmission apparatus 110 and the transmission apparatus 120.

While the transmission apparatus 110 is configured to be a transmission apparatus of transmitting side and the transmission apparatus 120 is configured to be a transmission apparatus of receiving side, the transmission apparatus 110 may further include a configuration that receives an optical signal from another transmission apparatus such as the transmission apparatus 120. The transmission apparatus 120 may further include a configuration that transmits an optical signal to another transmission apparatus such as the transmission apparatus 110.

While the transmission apparatus 110 is configured to include three generators (the generators 111a to 111c) to wavelength-multiplex three optical signals, the present embodiment is not limited to such a configuration. For example, the transmission apparatus 110 may be configured to include four or more generators to wavelength-multiplex four or more optical signals. In this case, a plurality of optical signals exist as the above optical signals of each optical signal except for the first optical signal and the second optical signal.

[Applicable Super-Channel Method]

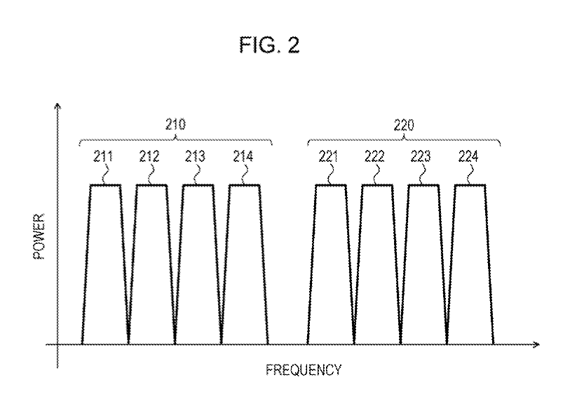

FIG. 2 is a diagram illustrating one example of a super-channel method that may be applied to the transfer system according to the first embodiment. In FIG. 2, the horizontal axis denotes the frequency of an optical signal, and the vertical axis denotes light intensity (Power). Super-channels 210 and 220 illustrated in FIG. 2 are channels in each of which a plurality of optical signals are combined. In the example illustrated in FIG. 2, the super-channel 210 includes sub-carriers 211 to 214. The super-channel 220 includes sub-carriers 221 to 224. The sub-carriers 211 to 214 and 221 to 224 are optical signals that are arranged at different frequencies.

According to the super-channel method, efficient use of a frequency bandwidth and an increase in the transfer capacity compared with a WDM method in the related art may be achieved by setting the frequencies of the sub-carriers 211 to 214 and 221 to 224 to be flexible.

[Optical Transfer System]

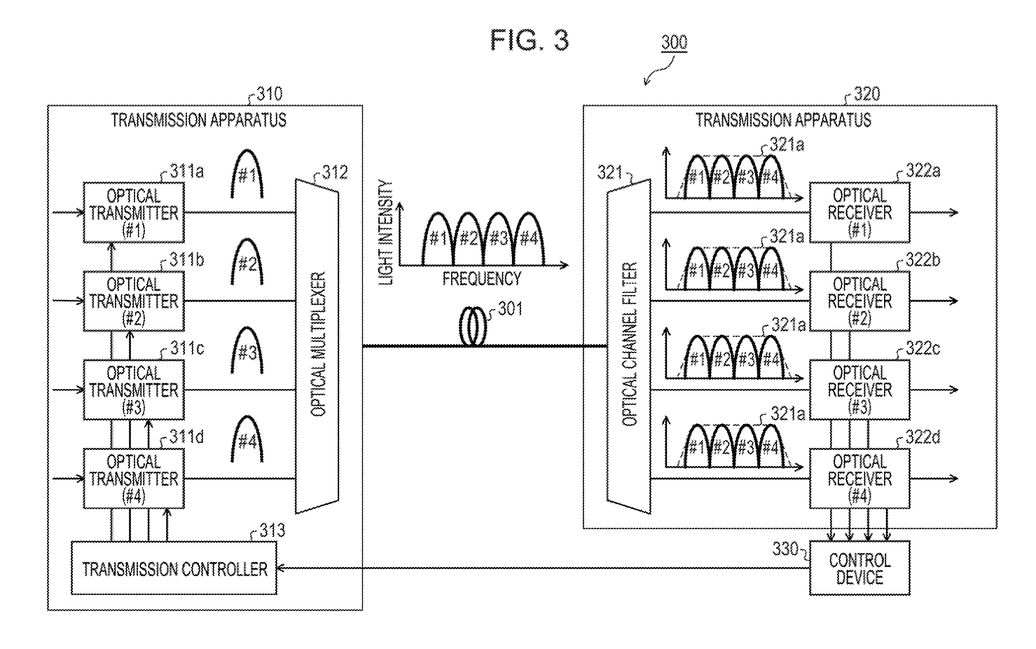

FIG. 3 is a diagram illustrating one example of an optical transfer system according to the first embodiment. An optical transfer system 300 illustrated in FIG. 3 includes a transmission apparatus 310 of transmitting side, a transmission apparatus 320 of receiving side, and a control device 330. Description will be provided in the case of accommodating four sub-carriers (sub-carriers #1 to #4) in one super-channel. The transmission apparatus 110 illustrated in FIG. 1 may be realized by, for example, the transmission apparatus 310. The transmission apparatus 120 illustrated in FIG. 1 may be realized by, for example, the transmission apparatus 320. The controller 113 illustrated in FIG. 1 may be realized by, for example, the control device 330.

The control device 330 may be disposed in the transmission apparatus 310, may be disposed in the transmission apparatus 320, or may be disposed in a different apparatus from the transmission apparatuses 310 and 320. Communication that the control device 330 performs with the transmission apparatuses 310 and 320 may use an optical transfer path such as an optical transfer path 301 or various transfer paths such as an electrical signal line and a wireless line. Description will be provided in a case where the control device 330 is disposed in the transmission apparatus 320.

The transmission apparatus 310 includes optical transmitters 311a to 311d (#1 to #4), an optical multiplexer 312, and a transmission controller 313. The generators 111a to 111c illustrated in FIG. 1 may be realized by, for example, the optical transmitters 311a to 311d. The transmitter 112 illustrated in FIG. 1 may be realized by, for example, the optical multiplexer 312.

Each of the optical transmitters 311a to 311d generates an optical signal (coherent light) based on an input electrical signal and outputs the generated optical signal to the optical multiplexer 312. The frequency (wavelength) of each optical signal generated by the optical transmitters 311a to 311d is controlled by the transmission controller 313 to be included in a bandwidth corresponding to one super-channel and to be a different frequency from each other.

Given that the signals generated by the optical transmitters 311a to 311d are respectively sub-carriers #1 to #4, the sub-carriers #1 to #4 constitute one super-channel. The sub-carrier #1 of the sub-carriers #1 to #4 has the lowest frequency (longest wavelength), and the frequency increases (wavelength shortens) in the order of the sub-carriers #2, #3, and #4.

The optical multiplexer 312 multiplexes each optical signal (the sub-carriers #1 to #4) output from the optical transmitters 311a to 311d. Each optical signal (the sub-carriers #1 to #4) output from the optical transmitters 311a to 311d has a different frequency from each other as described above and thus is wavelength-multiplexed by being multiplexed by the optical multiplexer 312. The optical multiplexer 312 transmits the multiplexed optical signal to the transmission apparatus 320 through the optical transfer path 301. The optical multiplexer 312 may be realized by an optical element such as an optical coupler.

While the example illustrated in FIG. 3 is described in a case where the sub-carriers #1 to #4 which are one super-channel are input into the optical multiplexer 312, a plurality of super-channels may be input into the optical multiplexer 312. In this case, the optical multiplexer 312 multiplexes and transmits each sub-carrier of the plurality of super-channels.

The transmission controller 313, in accordance with an instruction from the control device 330, controls ON/OFF of light emission of the optical transmitters 311a to 311d or the frequency (wavelength) of each optical signal generated by the optical transmitters 311a to 311d. The transmission controller 313 may have a function of controlling a modulation scheme (baud rate), a bandwidth, and the like for each optical signal generated by the optical transmitters 311a to 311d in accordance with an instruction from the control device 330.

The transmission apparatus 320 includes an optical channel filter 321 and optical receivers 322a to 322d. The optical filter 121 illustrated in FIG. 1 may be realized by, for example, the optical channel filter 321. The receiver 122 illustrated in FIG. 1 may be realized by, for example, the optical receivers 322a to 322d.

The optical channel filter 321 is an optical filter that has a bandwidth corresponding to one super-channel. The optical channel filter 321 extracts an optical signal of the bandwidth (predetermined bandwidth) of the super-channel of the sub-carriers #1 to #4 from optical signals transmitted from the transmission apparatus 310 through the optical transfer path 301 and outputs the extracted optical signal to the optical receivers 322a to 322d.

Accordingly, a super-channel including the sub-carriers #1 to #4 is output from the optical channel filter 321 to each of the optical receivers 322a to 322d. A frequency transmission characteristic 321a represents the transmittance to frequency characteristic of the optical channel filter 321. The frequency transmission characteristic 321a is a characteristic that has a high transmittance in the bandwidth of the super-channel including the sub-carriers #1 to #4 and a low transmittance in other bandwidths thereof.

For example, the optical receiver 322a receives the sub-carrier #1 of the sub-carriers #1 to #4 output from the optical channel filter 321 and outputs a reception result (decoding result) for the sub-carrier #1. In addition, the optical receiver 322a detects reception quality for the sub-carrier #1 and outputs to the control device 330 reception quality information that indicates the detected reception quality.

In the same manner, the optical receivers 322b to 322d respectively receive the sub-carriers #2 to #4 of the sub-carriers #1 to #4 output from the optical channel filter 321 and respectively output reception results (decoding results) for the sub-carriers #2 to #4. In addition, the optical receivers 322b to 322d respectively detect reception quality for the sub-carriers #2 to #4 and output the reception quality information indicating the detected reception quality to the control device 330.

Reception quality detected by the optical receivers 322a to 322d may be, for example, a bit error rate (BER). Reception quality is not limited to BER, and various types of reception quality such as received power, the Q value, state of clock deviation, the number of retransmissions, the number of error corrections in FEC, and BLER may be used. FEC is the abbreviation for forward error correction. BLER is the abbreviation for block error ratio.

An optical receiver of the optical receivers 322a to 322d that corresponds to a sub-carrier for which the control device 330 does not acquire the reception quality information may not detect reception quality and output the reception quality information.

The control device 330, based on the reception quality information output from the optical receivers 322a to 322d, transmits to the transmission controller 313 a control signal that provides an instruction to control the frequency of each optical signal generated by the optical transmitters 311a to 311d. Control of the control device 330 will be described later.

[Optical Transmitter]

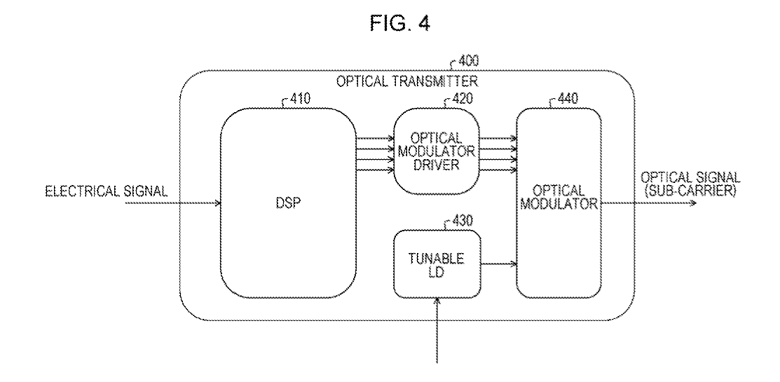

FIG. 4 is a diagram illustrating one example of an optical transmitter according to the first embodiment. Each of the optical transmitters 311a to 311d illustrated in FIG. 3 may be realized by, for example, an optical transmitter 400 illustrated in FIG. 4. The optical transmitter 400 is, for example, a 100 [Gbps] coherent optical transmitter.

The optical transmitter 400 includes a DSP 410, an optical modulator driver 420, a tunable LD 430, and an optical modulator 440. DSP is the abbreviation for digital signal processor. LD is the abbreviation for laser diode.

The DSP 410 is a large scale integration (LSI) that performs signal processing such as various coding processes based on an input electrical signal and outputs a transmitted signal acquired by signal processing to the optical modulator driver 420. In the example illustrated in FIG. 4, a four-channel transmitted signal is output from the DSP 410 to the optical modulator driver 420.

The optical modulator driver 420 is a drive circuit of the optical modulator 440 that drives the optical modulator 440 based on the transmitted signal output from the DSP 410. For example, the optical modulator driver 420 generates a drive current corresponding to the transmitted signal output from the DSP 410 and outputs the generated drive current to the optical modulator 440. In the example illustrated in FIG. 4, a four-channel drive current is output from the optical modulator driver 420 to the optical modulator 440.

The tunable LD 430 renders continuous light to oscillate and outputs the light to the optical modulator 440. The frequency (center frequency) of the continuous light that is rendered to oscillate by the tunable LD 430 is controlled by the transmission controller 313 illustrated in FIG. 3.

The optical modulator 440 is an external modulator that modulates the continuous light output from the tunable LD 430 according to the drive current from the optical modulator driver 420. The optical modulator 440 outputs an optical signal (coherent light) acquired by modulation as one sub-carrier to the optical multiplexer 312 illustrated in FIG. 3. A Mach-Zehnder optical modulator, for example, may be used as the optical modulator 440.

The frequency of the optical signal (sub-carrier) output from the optical modulator 440 is the same as a frequency set in the tunable LD 430. In the example illustrated in FIG. 4, the optical signal output from the optical modulator 440 is, for example, an optical signal of four channels configured of I and Q channels and X and Y polarized channels.

[Optical Receiver]

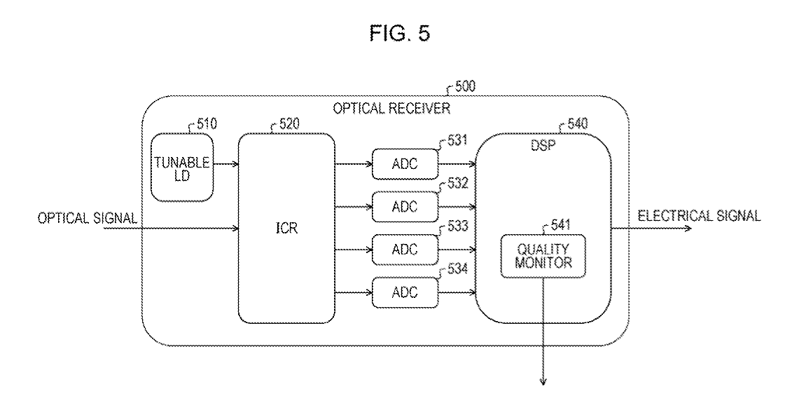

FIG. 5 is a diagram illustrating one example of an optical receiver according to the first embodiment. Each of the optical receivers 322a to 322d illustrated in FIG. 3 may be realized by, for example, an optical receiver 500 illustrated in FIG. 5. The optical receiver 500 is, for example, a 100 [Gbps] coherent optical receiver.

The optical receiver 500 includes a tunable LD 510, an ICR 520, ADCs 531 to 534, and a DSP 540. ICR is the abbreviation for integrated coherent receiver. ADC is the abbreviation for analog/digital converter.

The tunable LD 510 renders local light (continuous light) to oscillate and outputs the light to the ICR 520. The frequency (center frequency) of the local light that is rendered to oscillate by the tunable LD 510 is set to the frequency (center frequency) of a sub-carrier received by the optical receiver 500 at the time of operation.

The ICR 520 is an optical front end that acquires a four-channel received signal by mixing the optical signal output from the optical channel filter 321 illustrated in FIG. 3 with the continuous light output from the tunable LD 510 and photoelectrically converts each light acquired by mixing. For example, the ICR 520 extracts a complex electric field indicating a light intensity or a phase by separating an optical signal into X and Y polarized signals and mixing each separated signal with local light. The ICR 520 photoelectrically converts each light (I and Q channels) that has an intensity corresponding to the real part of the extracted complex electric field.

Accordingly, a received signal of four channels configured of I and Q channels and X and Y polarized channels may be acquired. The ICR 520 outputs the photoelectrically converted four-channel received signal to each of the ADCs 531 to 534. Each of the ADCs 531 to 534 converts the received signal output from the ICR 520 from an analog signal to a digital signal and outputs the converted received signal to the DSP 540.

The DSP 540 decodes sub-carriers by performing a reception process for each received signal output from the ADCs 531 to 534, such as error correction or compensation for dispersion, polarization, or the like that is the cause of degrading signal quality on the optical transfer path 301. The DSP 540 outputs an electrical signal acquired by decoding.

A quality monitor 541 that detects reception quality for a received signal subjected to the reception process is realized in the DSP 540. Reception quality detected by the quality monitor 541 may be various types of reception quality such as above BER. The quality monitor 541 outputs the reception quality information indicating the detected reception quality to the control device 330 illustrated in FIG. 3.

[In Case of Narrow Spacing Between Sub-Carriers]

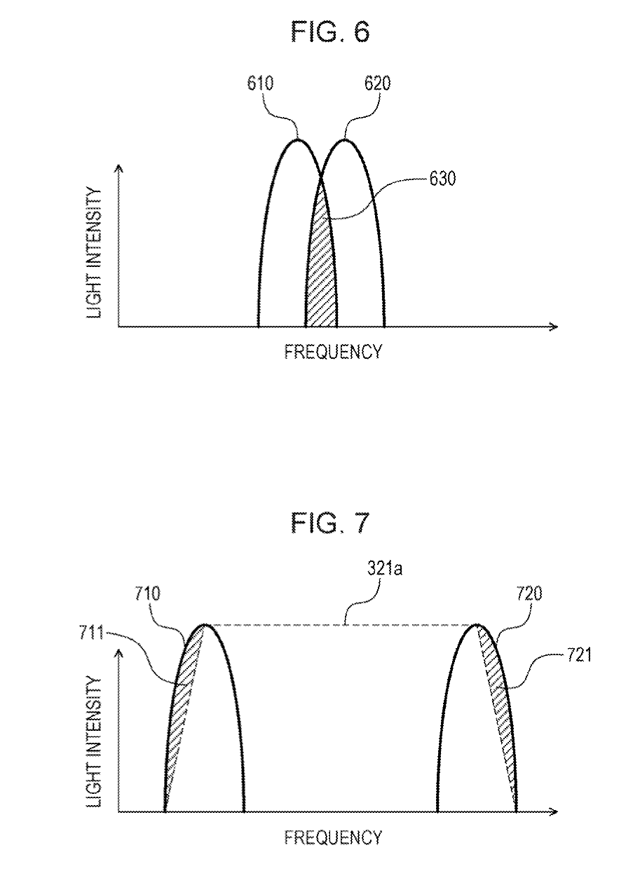

FIG. 6 is a diagram illustrating one example of a case where the spacing between sub-carriers is narrow in the optical transfer system according to the first embodiment. In FIG. 6, the horizontal axis denotes the frequency of an optical signal, and the vertical axis denotes light intensity. Sub-carriers 610 and 620 are adjacent sub-carriers included in the same super-channel.

In the super-channel method, intended is efficient use of a frequency bandwidth that is restricted by the optical channel filter 321. Thus, a frequency grid has to be set as narrowly as possible. However, for example, as illustrated in FIG. 6, when the spacing between each center frequency of the sub-carriers 610 and 620 is excessively narrow, an interference part 630 in which the sub-carriers 610 and 620 interfere with each other is enlarged, and reception quality for the sub-carriers 610 and 620 is degraded.

[In Case of Narrow Spacing Between Sub-Carrier and Restricted Band]

FIG. 7 is a diagram illustrating one example of a case where the spacing between a sub-carrier and a restricted band is narrow in the optical transfer system according to the first embodiment. In FIG. 7, the horizontal axis denotes the frequency of an optical signal, and the vertical axis denotes light intensity. The frequency transmission characteristic 321a is the frequency transmission characteristic of the optical channel filter 321 illustrated in FIG. 3. Sub-carriers 710 and 720 are sub-carriers that are arranged at both ends of sub-carriers included in the same super-channel on the frequency axis.

As illustrated in FIG. 7, when the spacing between each of the sub-carriers 710 and 720 and a restricted band of the frequency transmission characteristic 321a is excessively narrow, reception quality for the sub-carriers 710 and 720 is degraded by bandwidth restriction by the frequency transmission characteristic 321a. An attenuation part 711 illustrates a part of the sub-carrier 710 attenuated by the frequency transmission characteristic 321a. An attenuation part 721 illustrates a part of the sub-carrier 720 attenuated by the frequency transmission characteristic 321a.

As illustrated in FIG. 6 and FIG. 7, in the super-channel method, the center frequency of each sub-carrier has to be set such that the spacing between the sub-carrier and the frequency transmission characteristic 321a is not excessively narrow and that the spacing between the sub-carriers is not excessively narrow.

[Low-Frequency Side Sub-Carrier Frequency Sweep]

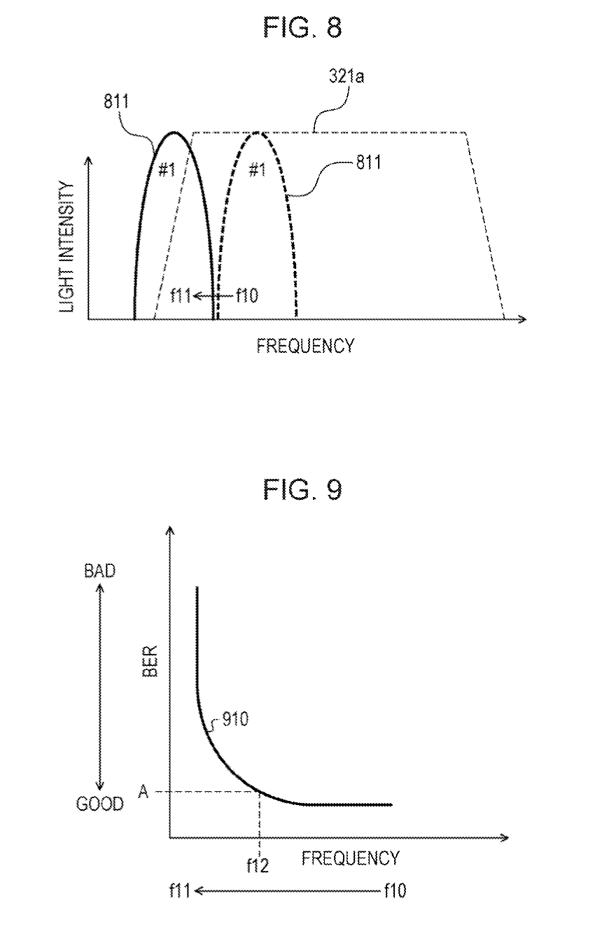

FIG. 8 is a diagram illustrating one example of a low-frequency side sub-carrier sweep in the optical transfer system according to the first embodiment. A sub-carrier 811 illustrated in FIG. 8 is the sub-carrier #1 transmitted from the optical transmitter 311a illustrated in FIG. 3 and is the most low-frequency side sub-carrier of the sub-carriers #1 to #4 included in one super-channel.

For example, the control device 330 illustrated in FIG. 3 instructs the transmission controller 313 of the transmission apparatus 310 to sweep (change) the frequency of the optical transmitter 311a (#1) from a frequency f10 to a frequency f11. The frequencies from the frequency f10 to the frequency f11 are, for example, frequencies that are set in advance as candidates for the frequency of the sub-carrier #1.

The frequency f10 is a frequency that is sufficiently on the high-frequency side from the low-frequency side end portion of the bandwidth of the frequency transmission characteristic 321a and is, for example, a frequency at which degradation of the sub-carrier #1 by the frequency transmission characteristic 321a is sufficiently small as illustrated in FIG. 7. The frequency f11 is a frequency that is sufficiently on the low-frequency side from the frequency f10 and is, for example, a frequency at which degradation of the sub-carrier #1 by the frequency transmission characteristic 321a is significant as illustrated in FIG. 7.

The frequencies f10 and f11 are set to have sufficient spacing so that the frequency of the optical transmitter 311a (#1) is optimal at a frequency f12 between the frequencies f10 and f11. The frequency f12 at which the frequency of the optical transmitter 311a (#1) is optimal is, for example, a frequency at which reception quality for the sub-carrier 811 (#1) is equal to predetermined quality.

[Determination of Frequency of Sub-Carrier #1]

FIG. 9 is a diagram illustrating one example of determining the frequency of the sub-carrier #1 in the optical transfer system according to the first embodiment. In FIG. 9, the horizontal axis denotes the frequency of an optical signal, and the vertical axis denotes BER as one example of reception quality for a sub-carrier. Higher BER indicates lower (worse) reception quality, and lower BER indicates higher (better) reception quality.

A BER detection result 910 is a detection result of the optical receiver 322a (#1) illustrated in FIG. 3 for the BER of the sub-carrier 811 (#1) in a case where the frequency of the optical transmitter 311a (#1) is swept from the frequency f10 to the frequency f11 as illustrated in FIG. 8. As illustrated by the BER detection result 910, as the sub-carrier 811 (#1) that is closest to the low-frequency side end portion of the bandwidth of the optical channel filter 321 is on the low-frequency side, reception quality is degraded by bandwidth restriction of the optical channel filter 321 on the low-frequency side, and the BER is increased.

The control device 330, while sweeping the frequency of the optical transmitter 311a (#1) from the frequency f10 to the frequency f11, monitors the BER of the sub-carrier 811 (#1) based on the reception quality information output from the optical receiver 322a. The control device 330 specifies the frequency f12 of the optical transmitter 311a (#1) at which the BER of the sub-carrier 811 (#1) is equal to a predetermined value A. The predetermined value A is, for example, the maximum BER allowed in the transfer system 100. The predetermined value A is not limited thereto and may be, for example, a BER that is lower than the maximum BER allowed in the transfer system 100. The control device 330 determines the specified frequency f12 as the frequency of the optical transmitter 311a (#1).

While description is provided in a case where the control device 330 sweeps the frequency of the optical transmitter 311a (#1) from the frequency f10 to the frequency f11, the sweeping method is not limited thereto. For example, the control device 330 may sweep the frequency of the optical transmitter 311a (#1) from the frequency f11 to the frequency f10. In this case as well, the frequency f12 at which the BER of the sub-carrier 811 (#1) is equal to the predetermined value A may be specified.

The control device 330 may sweep the frequency of the optical transmitter 311a (#1) from the frequency f10 to the low-frequency side and may stop sweeping at a time point when the BER of the sub-carrier 811 (#1) is equal to the predetermined value A. Alternatively, the control device 330 may sweep the frequency of the optical transmitter 311a (#1) from the frequency f11 to the high-frequency side and may stop sweeping at a time point when the BER of the sub-carrier 811 (#1) is equal to the predetermined value A. Accordingly, the frequency f12 at which the BER of the sub-carrier 811 (#1) is equal to the predetermined value A may be specified, and the amount of time taken for sweeping may be reduced.

A frequency sweep may continuously (linearly or non-linearly) change the frequency or may stepwise change the frequency. For example, in the case of continuously changing the frequency, the frequency at a time point when the BER is equal to the predetermined value A may be the average value or the central value of the frequency in a period for which the BER is calculated.

While the configuration that determines the frequency of the low-frequency side sub-carrier #1 and then determines the frequency of the high-frequency side sub-carrier #4 is described, the present embodiment is not limited to such a configuration. For example, a configuration that determines the frequency of the high-frequency side sub-carrier #4 and then determines the frequency of the low-frequency side sub-carrier #1 may be used.

[High-Frequency Side Sub-Carrier Frequency Sweep]

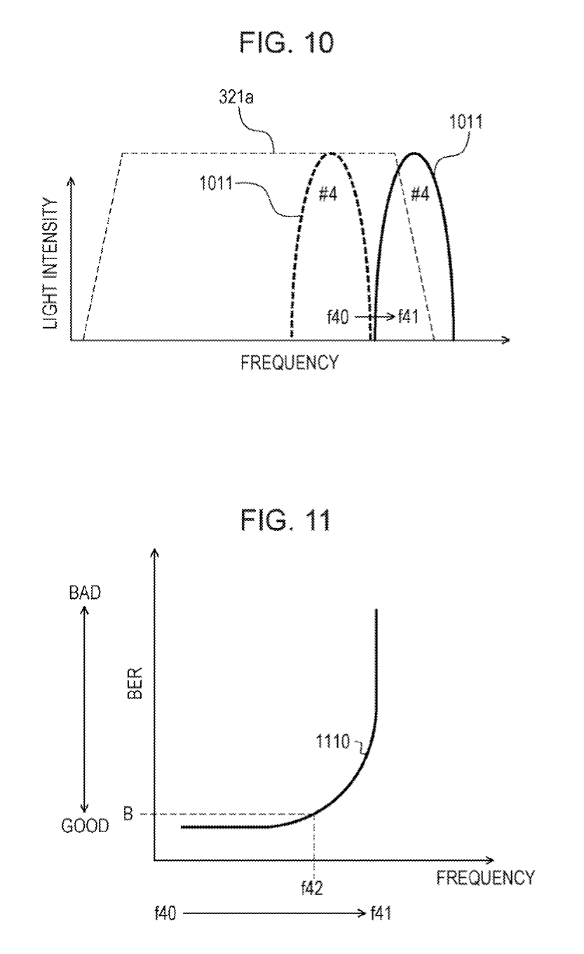

FIG. 10 is a diagram illustrating one example of a high-frequency side sub-carrier sweep in the transfer system according to the first embodiment. A sub-carrier 1011 illustrated in FIG. 10 is the sub-carrier #4 transmitted from the optical transmitter 311d illustrated in FIG. 3 and is the most high-frequency side sub-carrier of the sub-carriers #1 to #4 included in one super-channel.

For example, the control device 330 illustrated in FIG. 3 instructs the transmission controller 313 of the transmission apparatus 310 to sweep (change) the frequency of the optical transmitter 311d (#4) from a frequency f40 to a frequency f41. The frequencies from the frequency f40 to the frequency f41 are, for example, frequencies that are set in advance as candidates for the frequency of the sub-carrier #4.

The frequency f40 is a frequency that is sufficiently on the low-frequency side from the high-frequency side end portion of the bandwidth of the frequency transmission characteristic 321a and is, for example, a frequency at which degradation of the sub-carrier #4 by the frequency transmission characteristic 321a is sufficiently small as illustrated in FIG. 7. The frequency f41 is a frequency that is sufficiently on the high-frequency side from the frequency f40 and is, for example, a frequency at which degradation of the sub-carrier #4 by the frequency transmission characteristic 321a is significant as illustrated in FIG. 7.

The frequencies f40 and f41 are set such that the frequency of the optical transmitter 311d (#4) is optimal at a frequency f42 between the frequencies f40 and f41. The frequency f42 at which the frequency of the optical transmitter 311d (#4) is optimal is, for example, a frequency at which reception quality for the sub-carrier 1011 (#4) is equal to predetermined quality.

[Determination of Frequency of Sub-Carrier #4]

FIG. 11 is a diagram illustrating one example of determining the frequency of the sub-carrier #4 in the transfer system according to the first embodiment. In FIG. 11, the horizontal axis denotes the frequency of an optical signal, and the vertical axis denotes BER as one example of reception quality for a sub-carrier. Higher BER indicates lower (worse) reception quality, and lower BER indicates higher (better) reception quality.

A BER detection result 1110 is a detection result of the optical receiver 322d illustrated in FIG. 3 for the BER of the sub-carrier 1011 (#4) in a case where the frequency of the optical transmitter 311d (#4) is swept from the frequency f40 to the frequency f41 as illustrated in FIG. 10. As illustrated by the BER detection result 1110, as the sub-carrier 1011 (#4) that is closest to the high-frequency side end portion of the bandwidth of the optical channel filter 321 is on the more high-frequency side, reception quality is degraded by bandwidth restriction of the optical channel filter 321 on the high-frequency side, and the BER is increased.

The control device 330, while sweeping the frequency of the optical transmitter 311d (#4) from the frequency f40 to the frequency f41, monitors the BER of the sub-carrier 1011 (#4) based on the reception quality information output from the optical receiver 322d. The control device 330 specifies the frequency f42 of the optical transmitter 311d (#4) at which the BER of the sub-carrier 1011 (#4) is equal to a predetermined value B. The predetermined value B is, for example, the maximum BER allowed in the transfer system 100. The predetermined value B is not limited thereto and may be, for example, a BER that is lower than the maximum BER allowed in the transfer system 100. The predetermined value B may be the same value as the predetermined value A or may be a different value from the predetermined value A. The control device 330 determines the specified frequency f42 as the frequency of the optical transmitter 311d (#4).

While description is provided in a case where the control device 330 sweeps the frequency of the optical transmitter 311d (#4) from the frequency f40 to the frequency f41, the sweeping method is not limited thereto. For example, the control device 330 may sweep the frequency of the optical transmitter 311d (#4) from the frequency f41 to the frequency f40. In this case as well, the frequency f42 at which the BER of the sub-carrier 1011 (#4) is equal to the predetermined value B may be specified.

The control device 330 may sweep the frequency of the optical transmitter 311d (#4) from the frequency f40 to the high-frequency side and may stop sweeping at a time point when the BER of the sub-carrier 1011 (#4) is equal to the predetermined value B. Alternatively, the control device 330 may sweep the frequency of the optical transmitter 311d (#4) from the frequency f41 to the low-frequency side and may stop sweeping at a time point when the BER of the sub-carrier 1011 (#4) is equal to the predetermined value B. Accordingly, the frequency f42 at which the BER of the sub-carrier 1011 (#4) is equal to the predetermined value B may be specified, and the amount of time taken for sweeping may be reduced.

Sweeping the frequencies of the sub-carriers 811 and 1011 (#1 and #4) illustrated in FIG. 8 to FIG. 11 allows the control device 330 to determine the frequency f12 of the optical transmitter 311a (#1) and the frequency f42 of the optical transmitter 311d (#4).

[Determination of Frequency of Sub-Carrier #3]

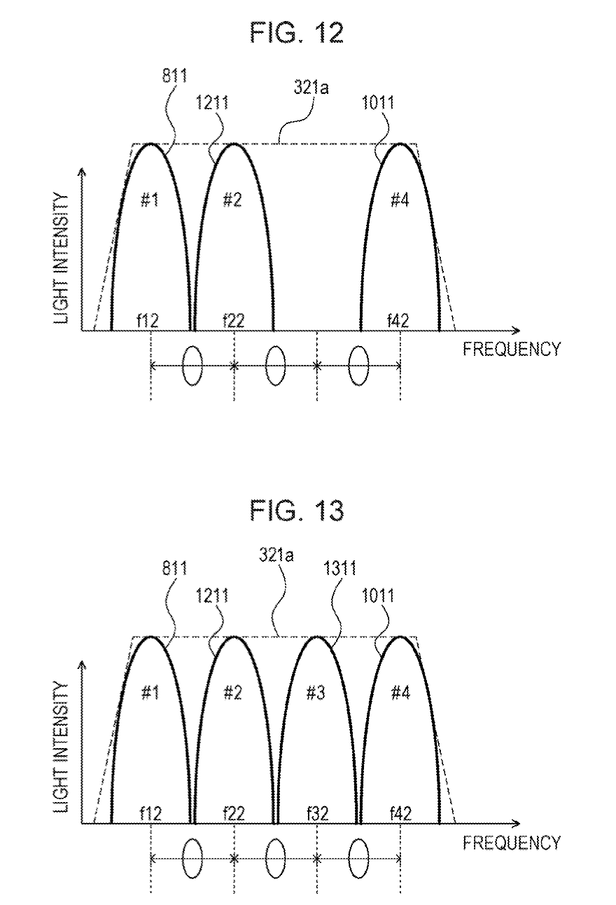

FIG. 12 is a diagram illustrating one example of determining the frequency of the sub-carrier #3 in the optical transfer system according to the first embodiment. The same part of FIG. 12 as the part illustrated in FIG. 8 and FIG. 10 will be designated by the same reference sign and will not be described. A sub-carrier 1211 illustrated in FIG. 12 is the sub-carrier #2 illustrated in FIG. 3 and is a sub-carrier that has the second lowest frequency of the sub-carriers #1 to #4 included in one super-channel.

The control device 330, for example, arranges the frequencies of the remaining sub-carriers #2 and #3 between the determined frequencies f12 and f42 of the sub-carriers 811 and 1011 (#1 and #4) with equal frequency spacing. For example, the control device 330 determines a frequency f22 of the sub-carrier 1211 (#2) by using Expression (1) below.

f22=f12+((f42−f12)/3) (1)

[Determination of Frequency of Sub-Carrier #4]

FIG. 13 is a diagram illustrating one example of determining the frequency of the sub-carrier #4 in the optical transfer system according to the first embodiment. The same part of FIG. 13 as the part illustrated in FIG. 8, FIG. 10, and FIG. 12 will be designated by the same reference sign and will not be described. A sub-carrier 1311 illustrated in FIG. 13 is the sub-carrier #3 illustrated in FIG. 3 and is a sub-carrier that has the third lowest frequency of the sub-carriers #1 to #4 included in one super-channel.

For example, the control device 330 determines a frequency f32 of the sub-carrier 1311 (#3) by using Expression (2) below.

f32=f12+2×((f42−f12)/3) (2)

As illustrated in FIG. 12 and FIG. 13, the control device 330 may determine the frequencies f22 and f32 of the sub-carriers 1211 and 1311 by calculation based on the frequencies f12 and f42 of the sub-carriers 811 and 1011 determined by sweeping. Accordingly, the frequencies f12, f22, f32, and f42 of the sub-carriers 811, 1211, 1311, and 1011 (#1 to #4) included in one super-channel may be determined.

The control device 330 may set start-up frequencies by simple calculation for the sub-carriers #2 and #3 of the sub-carriers in the super-channel except for both end sub-carriers #1 and #4 of the bandwidth of the frequency transmission characteristic 321a. Accordingly, the frequencies of the sub-carriers #1 to #4 that may reduce degradation of reception quality for both end sub-carriers #1 and #4 by bandwidth restriction of the frequency transmission characteristic 321a and reduce degradation of reception quality by interference among the sub-carriers #1 to #4 are acquired in a small amount of time.

[Process Performed at Start of Operation by Control Device]

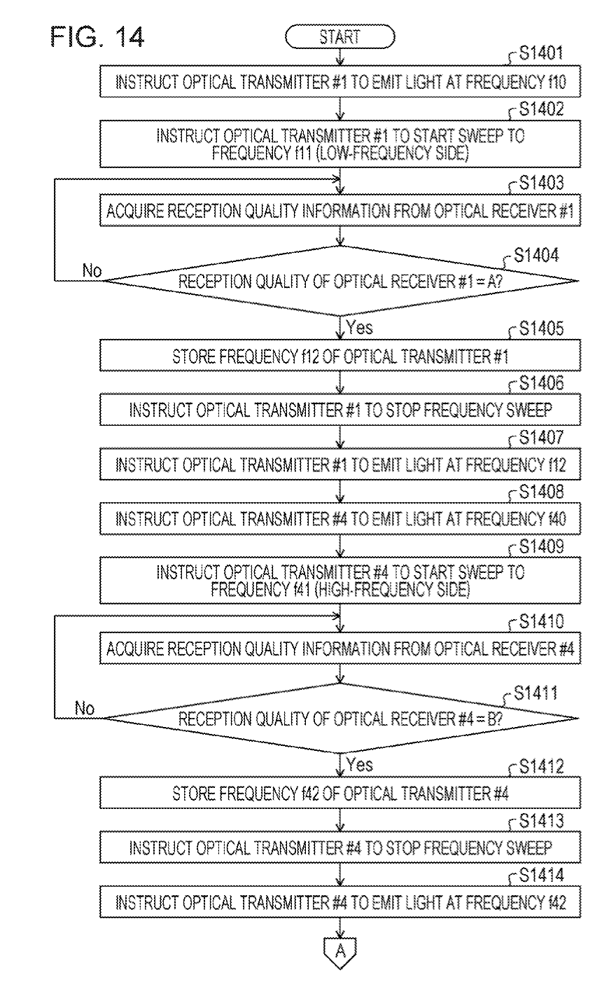

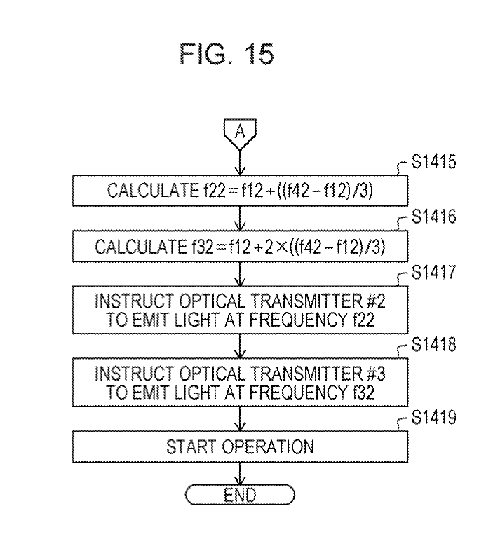

FIG. 14 and FIG. 15 are flowcharts illustrating one example of a process performed at the start of operation by a control device according to the first embodiment. The control device 330 performs, for example, each operation illustrated in FIG. 14 and FIG. 15 at the start of operation of the optical transfer system 300.

For example, as the initial state, the optical transmitters 311a to 311d (#1 to #4) that respectively correspond to the sub-carriers #1 to #4 are in a state of not emitting light. In addition, light emission and a frequency sweep of the optical transmitters 311a to 311d (#1 to #4) are available by transmitting a control signal from the control device 330 to the transmission controller 313. In addition, the optical receivers 322a to 322d (#1 to #4) that respectively correspond to the sub-carriers #1 to #4 are in a state capable of respectively receiving the sub-carriers #1 to #4.

First, as illustrated in FIG. 14, the control device 330 instructs the transmission controller 313 by a control signal to render the optical transmitter 311a (#1) to emit light at the frequency f10 (operation S1401). Accordingly, the transmission controller 313 sets the frequency of the optical transmitter 311a (#1) to the frequency f10 and renders the optical transmitter 311a (#1) to emit light.

Next, the control device 330 instructs the transmission controller 313 by a control signal to start a sweep of the optical transmitter 311a (#1) to the frequency f11 (low-frequency side) (operation S1402). Accordingly, the transmission controller 313 starts a sweep that changes the frequency of the optical transmitter 311a (#1) from the frequency f10 to the frequency f11.

Next, the control device 330 acquires the reception quality information from the optical receiver 322a (#1) (operation S1403). Next, the control device 330 determines whether or not the reception quality of the optical receiver 322a (#1) indicated by the reception quality information acquired in the operation S1403 is equal to the predetermined value A (operation S1404). In a case where the reception quality is not equal to the predetermined value A (No in the operation S1404), the control device 330 returns to the operation S1403.

In a case where the reception quality is equal to the predetermined value A in the operation S1404 (Yes in the operation S1404), the control device 330 stores the frequency f12 of the optical transmitter 311a (#1) at the time point of the reception quality being equal to the predetermined value A (operation S1405). Accordingly, the frequency f12 of the optical transmitter 311a (#1) at which the reception quality of the optical receiver 322a (#1) is equal to the predetermined value A may be acquired.

Next, the control device 330 instructs the transmission controller 313 by a control signal to stop the frequency sweep of the optical transmitter 311a (#1) (operation S1406). Accordingly, the transmission controller 313 stops the frequency sweep of the optical transmitter 311a (#1).

Next, the control device 330 instructs the transmission controller 313 by a control signal to render the optical transmitter 311a (#1) to emit light at the frequency f12 stored in the operation S1405 (operation S1407). Accordingly, the transmission controller 313 sets the frequency of the optical transmitter 311a (#1) to the frequency f12.

Next, the control device 330 instructs the transmission controller 313 by a control signal to render the optical transmitter 311d (#4) to emit light at the frequency f40 (operation S1408). Accordingly, the transmission controller 313 sets the frequency of the optical transmitter 311d (#4) to the frequency f40 and renders the optical transmitter 311d (#4) to emit light.

Next, the control device 330 instructs the transmission controller 313 by a control signal to start a sweep of the optical transmitter 311d (#4) to the frequency f41 (high-frequency side) (operation S1409). Accordingly, the transmission controller 313 starts a sweep that changes the frequency of the optical transmitter 311d (#4) from the frequency f40 to the frequency f41.

Next, the control device 330 acquires the reception quality information from the optical receiver 322d (#4) (operation S1410). Next, the control device 330 determines whether or not the reception quality of the optical receiver 322d (#4) indicated by the reception quality information acquired in the operation S1410 is equal to the predetermined value B (operation S1411). In a case where the reception quality is not equal to the predetermined value B (No in the operation S1411), the control device 330 returns to the operation S1410.

In a case where the reception quality is equal to the predetermined value B in the operation S1411 (Yes in the operation S1411), the control device 330 stores the frequency f42 of the optical transmitter 311d (#4) at the time point of the reception quality being equal to the predetermined value B (operation S1412). Accordingly, the frequency f42 of the optical transmitter 311d (#4) at which the reception quality of the optical receiver 322d (#4) is equal to the predetermined value B may be acquired.

Next, the control device 330 instructs the transmission controller 313 by a control signal to stop the frequency sweep of the optical transmitter 311d (#4) (operation S1413). Accordingly, the transmission controller 313 stops the frequency sweep of the optical transmitter 311d (#4).

Next, the control device 330 instructs the transmission controller 313 by a control signal to render the optical transmitter 311d (#4) to emit light at the frequency f42 stored in the operation S1412 (operation S1414).

Accordingly, the transmission controller 313 sets the frequency of the optical transmitter 311d (#4) to the frequency f42.

Next, as illustrated in FIG. 15, the control device 330 calculates above Expression (1) of f22=f12+((f42−f12)/3) as the frequency of the optical transmitter 311b (#2) (operation S1415). In addition, the control device 330 calculates above Expression (2) of f32=f12+2×((f42−f12)/3) as the frequency of the optical transmitter 311c (#3) (operation S1416).

Next, the control device 330 instructs the transmission controller 313 by a control signal to render the optical transmitter 311b (#2) to emit light at the frequency f22 calculated in the operation S1415 (operation S1417). Accordingly, the transmission controller 313 sets the frequency of the optical transmitter 311b (#2) to the frequency f22.

In addition, the control device 330 instructs the transmission controller 313 by a control signal to render the optical transmitter 311c (#3) to emit light at the frequency f32 calculated in the operation S1416 (operation S1418). Accordingly, the transmission controller 313 sets the frequency of the optical transmitter 311c (#3) to the frequency f32.

Next, the control device 330 performs control to start operation in which an optical signal based on user data is transmitted from the transmission apparatus 310 to the transmission apparatus 320 (operation S1419), and ends a series of processes at the start of operation.

[In Case of Accommodating n Sub-Carriers in One Super-Channel]

While description is provided in the case of accommodating four sub-carriers (the sub-carriers #1 to #4) in one super-channel, any number, for example, three or more, of sub-carriers may be accommodated in one super-channel.

Description will be provided in the case of accommodating n (n is a natural number greater than or equal to three) sub-carriers (sub-carriers #1 to #n) in one super-channel. In this case, the transmission apparatus 310 illustrated in FIG. 3 includes n optical transmitters (#1 to #n) as an optical transmitter corresponding to one super-channel. In addition, the transmission apparatus 320 illustrated in FIG. 3 includes n optical receivers (#1 to #n) as an optical receiver corresponding to one super-channel.

As the initial state, for example, the optical transmitters (#1 to #n) are in a state of not emitting light, and light emission and a frequency sweep of the optical transmitters (#1 to #n) are available by transmitting a control signal from the control device 330 to the transmission controller 313. In addition, the optical receivers (#1 to #n) are in a state capable of respectively receiving the sub-carriers #1 to #n.

First, the control device 330 sweeps the frequency of the optical transmitter (#1) from the frequency f10 to the frequency f11 (low-frequency side) and acquires the frequency f12 of the optical transmitter (#1) at which the reception quality of the optical receiver (#1) is equal to the predetermined value A. In addition, the control device 330 sweeps the frequency of the optical transmitter (#n) from a frequency fn0 to a frequency fn1 (high-frequency side) and acquires a frequency fn2 of the optical transmitter (#n) at which the reception quality of the optical receiver (#n) is equal to the predetermined value B.

Next, the control device 330 calculates Expression (3) of f22, f32, f42, . . . , f(n−2)2, and f(n−1)2 below as the frequencies of the optical transmitters (#2 to #n−1).

$$f 22 = f 12 + ( ( fn 2 - f 12 ) \text{/} ( n - 1 ) ) \\ f 32 = f 12 + 2 \times ( ( fn 2 - f 12 ) \text{/} ( n - 1 ) ) \\ f 42 = f 12 + 3 \times ( ( fn 2 - f 12 ) \text{/} ( n - 1 ) ) \\ ⋮ \\ f ( n - 2 ) 2 = f 12 + ( n - 2 ) \times ( ( fn 2 - f 12 ) \text{/} ( n - 1 ) ) \\ f ( n - 1 ) 2 = f 12 + ( n - 1 ) \times ( ( fn 2 - f 12 ) \text{/} ( n - 1 ) ) \qquad ( 3 )$$

Accordingly, the frequencies f12 to fn2 of the optical transmitters (#1 to #n) may be determined. The control device 330 instructs the transmission controller 313 to set the determined frequencies f12 to fn2 respectively in the optical transmitters (#1 to #n).

According to the transfer system 100 of the first embodiment, while any generator of the generators 111a to 111c changes the wavelength of an optical signal, the reception quality of the transmission apparatus 120 for the optical signal generated by the generator may be monitored. In addition, the generators 111a to 111c may be controlled based on the result of the monitoring such that each wavelength of the first optical signal of the longest wavelength and the second optical signal of the shortest wavelength is determined, that the wavelengths of the remaining optical signals are determined by calculation based on each determined wavelength, and that an optical signal of each determined wavelength is generated.

Accordingly, the wavelength of an optical signal other than the first optical signal and the second optical signal may be determined by simple calculation based on each wavelength of the first optical signal and the second optical signal. Thus, an increase in the size of a calculation circuit may be reduced, and arrangement of wavelengths may be adjusted in a small amount of time.

### Second Embodiment

A different part of a second embodiment from the first embodiment will be described. In the first embodiment, the configuration in which each of the optical transmitters 311a and 311d (#1 and #4) performs a frequency sweep in order to determine the frequency of both end sub-carriers #1 and #4 is described. Regarding this point, in the second embodiment, for example, a configuration in which any optical transmitter of the optical transmitters 311a to 311d sweeps the frequency of an optical signal for monitoring in order to determine the frequencies of both end sub-carriers #1 and #4 will be described.

[High-Frequency Side Sub-Carrier Frequency Sweep]

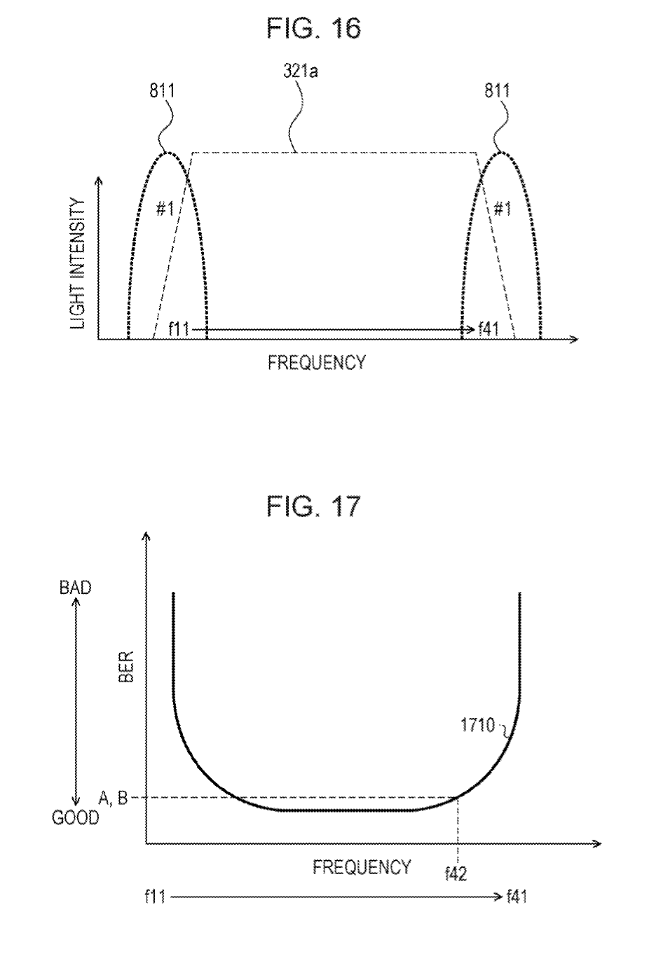

FIG. 16 is a diagram illustrating one example of a high-frequency side sub-carrier sweep in an optical transfer system according to the second embodiment. The same part of FIG. 16 as the part illustrated in FIG. 10 will be designated by the same reference sign and will not be described. For example, the control device 330 may sweep the frequency of the optical transmitter 311a (#1) from the frequency f10 to the frequency f11 as illustrated in FIG. 8 and then may sweep the frequency of the optical transmitter 311a (#1) from the frequency f11 to the frequency f41 as illustrated in FIG. 16.

[Determination of Frequency of Sub-Carrier #1]

FIG. 17 is a diagram illustrating one example of determining the frequency of the sub-carrier #1 in the optical transfer system according to the second embodiment. The same part of FIG. 17 as the part illustrated in FIG. 11 will be designated by the same reference sign and will not be described. In the example illustrated in FIG. 17, the predetermined value A is equal to the predetermined value B. A BER detection result 1710 is a detection result of the optical receiver 322a illustrated in FIG. 3 for the BER of the sub-carrier 811 (#1) in a case where the frequency of the optical transmitter 311a (#1) is swept from the frequency f11 to the frequency f41 as illustrated in FIG. 16.

The control device 330, while sweeping the frequency of the optical transmitter 311a (#1) from the frequency f11 to the frequency f41, monitors the BER of the sub-carrier 811 (#1) based on the reception quality information output from the optical receiver 322a. The control device 330 specifies the frequency f42 of the optical transmitter 311a (#1) at which the BER of the sub-carrier 811 (#1) is equal to the predetermined value B, and determines the specified frequency f42 as the frequency (center frequency) of the optical transmitter 311a (#1).

While description is provided in a case where the control device 330 sweeps the frequency of the optical transmitter 311a (#1) from the frequency f11 to the frequency f41, the sweeping method is not limited thereto. For example, the control device 330 may sweep the frequency of the optical transmitter 311a (#1) from the frequency f40 illustrated in FIG. 10 to the frequency f41 or from the frequency f41 to the frequency f40. In this case as well, the frequency f42 at which the BER of the sub-carrier 811 (#1) is equal to the predetermined value B may be specified.

The control device 330 may sweep the frequency of the optical transmitter 311a (#1) from the frequency f11 or the frequency f40 to the high-frequency side and may stop sweeping at a time point when the BER of the sub-carrier 811 (#1) is equal to the predetermined value B. Alternatively, the control device 330 may sweep the frequency of the optical transmitter 311a (#1) from the frequency f41 to the low-frequency side and may stop sweeping at a time point when the BER of the sub-carrier 811 (#1) is equal to the predetermined value B. Accordingly, the frequency f42 at which the BER of the sub-carrier 811 (#1) is equal to the predetermined value B may be specified, and the amount of time taken for sweeping may be reduced.

[Process Performed at Start of Operation by Control Device]

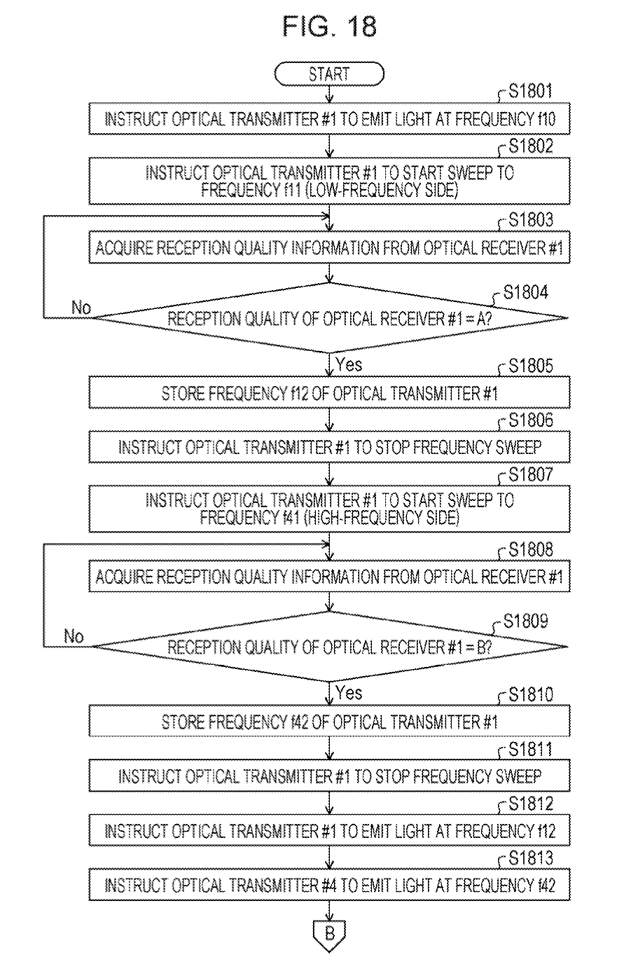

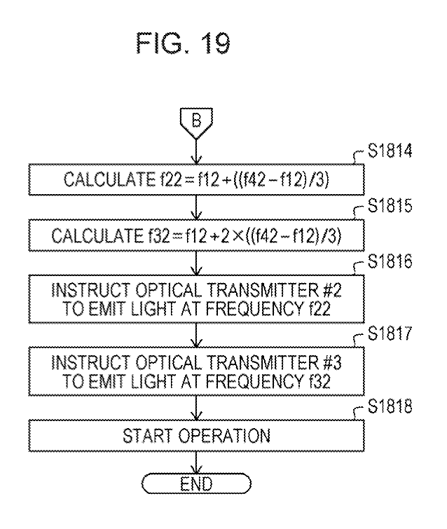

FIG. 18 and FIG. 19 are flowcharts illustrating one example of a process performed at the start of operation by a control device according to the second embodiment. The control device 330 according to the second embodiment performs, for example, each operation illustrated in FIG. 18 and FIG. 19 at the start of operation of the optical transfer system 300. Operations S1801 to S1806 illustrated in FIG. 18 are the same as the operations S1401 to S1406 illustrated in FIG. 14.

After the operation S1806, the control device 330 instructs the transmission controller 313 by a control signal to start a sweep of the optical transmitter 311a (#1) to the frequency f41 (high-frequency side) (operation S1807). Accordingly, the transmission controller 313 starts a sweep that changes the frequency of the optical transmitter 311a (#1) from the frequency f11 to the frequency f41.

Next, the control device 330 acquires the reception quality information from the optical receiver 322a (#1) (operation S1808). Next, the control device 330 determines whether or not the reception quality of the optical receiver 322a (#1) indicated by the reception quality information acquired in the operation S1808 is equal to the predetermined value B (operation S1809). In a case where the reception quality is not equal to the predetermined value B (No in the operation S1809), the control device 330 returns to the operation S1808.

In a case where the reception quality is equal to the predetermined value B in the operation S1809 (Yes in the operation S1809), the control device 330 stores the frequency f42 of the optical transmitter 311a (#1) at the time point of the reception quality being equal to the predetermined value B (operation S1810). Accordingly, the frequency f42 of the optical transmitter 311a (#1) at which the reception quality of the optical receiver 322a (#1) is equal to the predetermined value B may be acquired.

Next, the control device 330 instructs the transmission controller 313 by a control signal to stop the frequency sweep of the optical transmitter 311a (#1) (operation S1811). Accordingly, the transmission controller 313 stops the frequency sweep of the optical transmitter 311a (#1).

Next, the control device 330 instructs the transmission controller 313 by a control signal to render the optical transmitter 311a (#1) to emit light at the frequency f12 stored in the operation S1805 (operation S1812). Accordingly, the transmission controller 313 sets the frequency of the optical transmitter 311a (#1) to the frequency f12.

The control device 330 instructs the transmission controller 313 by a control signal to render the optical transmitter 311d (#4) to emit light at the frequency f42 stored in the operation S1810 (operation S1813). Accordingly, the transmission controller 313 sets the frequency of the optical transmitter 311d (#4) to the frequency f42.

Next, the control device 330 transitions to an operation S1814 illustrated in FIG. 19. Operations S1814 to S1818 illustrated in FIG. 19 are the same as, for example, the operations S1415 to S1419 illustrated in FIG. 15.

As illustrated in FIG. 16 to FIG. 19, an optical transmitter that performs a frequency sweep in order to determine the frequency of the optical transmitter 311d (#4) is not limited to the optical transmitter 311d (#4) and may be the optical transmitter 311a (#1). Similarly, the optical transmitter that performs a frequency sweep in order to determine the frequency of the optical transmitter 311d (#4) may be the optical transmitters 311b and 311c (#2 and #3). In addition, an optical transmitter that performs a frequency sweep in order to determine the frequency of the optical transmitter 311a (#1) is not limited to the optical transmitter 311a (#1) and may be the optical transmitters 311b to 311d (#2 to #4).

That is, optical transmitters that perform a frequency sweep in order to determine the frequencies of the optical transmitters 311a and 311d (#1 and #4) may be any optical transmitters of the optical transmitters 311a to 311d (#1 to #4).

According to the transfer system 100 of the second embodiment, any optical transmitter of the generators 111a to 111c may perform a frequency sweep in order to determine the frequencies of both end sub-carriers #1 and #4. In addition, in the same manner as the transfer system 100 according to the first embodiment, an increase in the size of a calculation circuit may be reduced, and arrangement of wavelengths may be adjusted in a small amount of time.

### Third Embodiment

A different part of a third embodiment from the first and second embodiments will be described. For example, while a method for starting a sub-carrier at start-up is described in the first and second embodiments, reception quality on the receiving side may fluctuate by degradation of each apparatus or according to the state of a transfer path. Regarding this point, in the third embodiment, for example, a method for controlling the frequency of each sub-carrier in the state of operation after starting the sub-carrier will be described.

[Frequency Control Process Performed During Operation by Control Device]

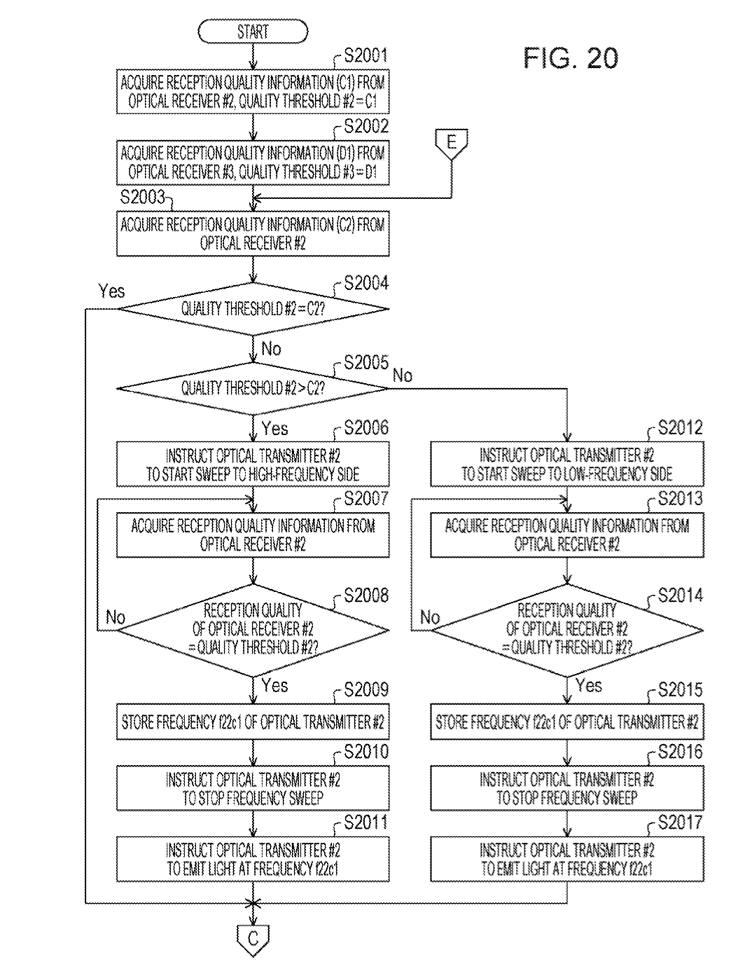

FIG. 20 to FIG. 22 are flowcharts illustrating one example of a frequency control process performed during operation by a control device according to the third embodiment. The control device 330 according to the third embodiment performs, for example, each operation illustrated in FIG. 20 to FIG. 22 after operation of the optical transfer system 300 is started by, for example, the processes illustrated in FIG. 14 and FIG. 15. In FIG. 20 to FIG. 22, description will be provided in the case of fixing the frequencies of both end sub-carriers #1 and #4 and controlling the frequencies of the sub-carriers #2 and #3 arranged between the sub-carriers #1 and #4.

First, as illustrated in FIG. 20, the control device 330 acquires the reception quality information from the optical receiver 322b (#2) and sets reception quality C1 indicated by the acquired reception quality information as a quality threshold #2 of the sub-carrier #2 (operation S2001). In addition, the control device 330 acquires the reception quality information from the optical receiver 322c (#3) and sets reception quality D1 indicated by the acquired reception quality information as a quality threshold #3 of the sub-carrier #3 (operation S2002).

Next, the control device 330 performs a reset process for the frequency of the optical transmitter 311b (#2). That is, the control device 330 acquires the reception quality information from the optical receiver 322b (#2) (operation S2003). Reception quality indicated by the reception quality information acquired in the operation S2003 is C2. Next, the control device 330 determines whether or not the reception quality C2 indicated by the reception quality information acquired in the operation S2003 is equal to the current quality threshold #2 (operation S2004).

In a case where the reception quality C2 is equal to the quality threshold #2 in the operation S2004 (Yes in the operation S2004), the control device 330 transitions to an operation S2018 without resetting the frequency of the optical transmitter 311b (#2). In a case where the reception quality C2 is not equal to the quality threshold #2 (No in the operation S2004), the control device 330 determines whether or not the reception quality C2 is lower than the current quality threshold #2 (operation S2005).

In a case where the reception quality C2 is lower than the quality threshold #2 in the operation S2005 (Yes in the operation S2005), the reception quality of the optical receiver 322b (#2) may be determined to be degraded. In this case, the control device 330 instructs the transmission controller 313 by a control signal to start a sweep of the optical transmitter 311b (#2) to the high-frequency side (operation S2006). Accordingly, the transmission controller 313 starts a sweep that changes the frequency of the optical transmitter 311b (#2) to the high-frequency side.

Next, the control device 330 acquires the reception quality information from the optical receiver 322b (#2) (operation S2007). Next, the control device 330 determines whether or not the reception quality of the optical receiver 322b (#2) indicated by the reception quality information acquired in the operation S2007 is equal to the quality threshold #2 (operation S2008). In a case where the reception quality is not equal to the quality threshold #2 (No in the operation S2008), the control device 330 returns to the operation S2007.

In a case where the reception quality is equal to the quality threshold #2 in the operation S2008 (Yes in the operation S2008), the control device 330 stores a frequency f22c1 of the optical transmitter 311b (#2) at the time point of the reception quality being equal to the quality threshold #2 (operation S2009). Accordingly, the frequency f22c1 of the optical transmitter 311b (#2) at which the reception quality of the optical receiver 322b (#2) is equal to the quality threshold #2 may be acquired.

Next, the control device 330 instructs the transmission controller 313 by a control signal to stop the frequency sweep of the optical transmitter 311b (#2) (operation S2010). Accordingly, the transmission controller 313 stops the frequency sweep of the optical transmitter 311b (#2).

Next, the control device 330 instructs the transmission controller 313 by a control signal to render the optical transmitter 311b (#2) to emit light at the frequency f22c1 stored in the operation S2009 (operation S2011). Accordingly, the transmission controller 313 sets the frequency of the optical transmitter 311b (#2) to the frequency f22c1. The control device 330 transitions to the operation S2018.

In a case where the reception quality C2 is higher than the quality threshold #2 in the operation S2005 (No in the operation S2005), the reception quality of the optical receiver 322b (#2) may be determined to be improved. In this case, the control device 330 instructs the transmission controller 313 by a control signal to start a sweep of the optical transmitter 311b (#2) to the low-frequency side (operation S2012). Accordingly, the transmission controller 313 starts a sweep that changes the frequency of the optical transmitter 311b (#2) to the low-frequency side.

Next, the control device 330 acquires the reception quality information from the optical receiver 322b (#2) (operation S2013). Next, the control device 330 determines whether or not the reception quality of the optical receiver 322b (#2) indicated by the reception quality information acquired in the operation S2013 is equal to the quality threshold #2 (operation S2014). In a case where the reception quality is not equal to the quality threshold #2 (No in the operation S2014), the control device 330 returns to the operation S2013.

In a case where the reception quality is equal to the quality threshold #2 in the operation S2014 (Yes in the operation S2014), the control device 330 stores the frequency f22c1 of the optical transmitter 311b (#2) at the time point of the reception quality being equal to the quality threshold #2 (operation S2015). Accordingly, the frequency f22c1 of the optical transmitter 311b (#2) at which the reception quality of the optical receiver 322b (#2) is equal to the quality threshold #2 may be acquired.

Next, the control device 330 instructs the transmission controller 313 by a control signal to stop the frequency sweep of the optical transmitter 311b (#2) (operation S2016). Accordingly, the transmission controller 313 stops the frequency sweep of the optical transmitter 311b (#2).

Next, the control device 330 instructs the transmission controller 313 by a control signal to render the optical transmitter 311b (#2) to emit light at the frequency f22c1 stored in the operation S2015 (operation S2017). Accordingly, the transmission controller 313 sets the frequency of the optical transmitter 311b (#2) to the frequency f22c1. The control device 330 transitions to the operation S2018.

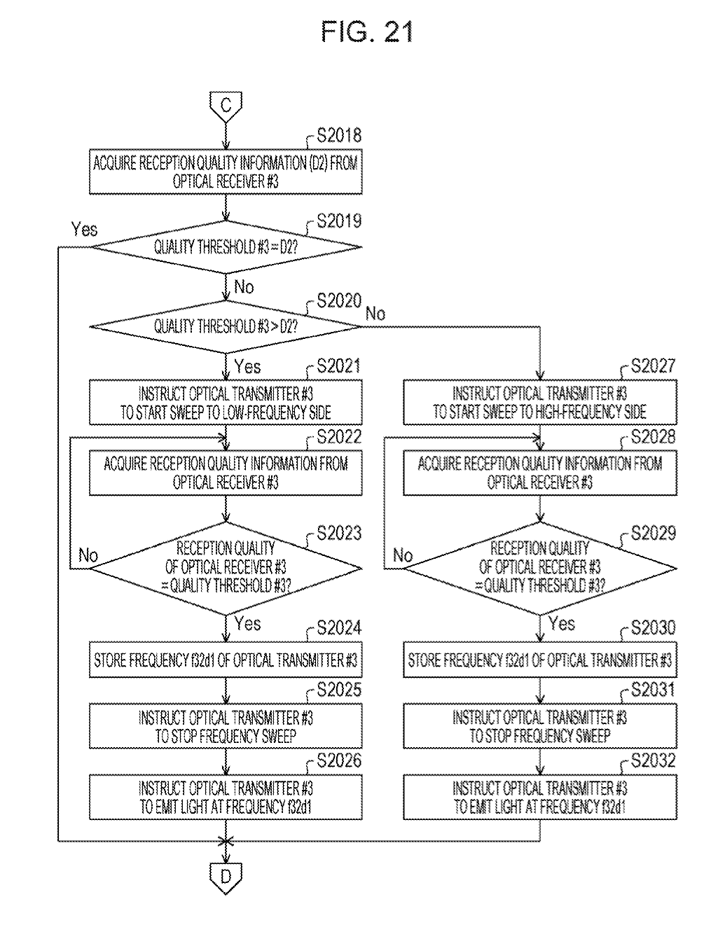

Next, as illustrated in FIG. 21, the control device 330 performs a reset process for the frequency of the optical transmitter 311c (#3). That is, the control device 330 acquires the reception quality information from the optical receiver 322c (#3) (operation S2018). Reception quality indicated by the reception quality information acquired in the operation S2018 is D2. Next, the control device 330 determines whether or not the reception quality D2 indicated by the reception quality information acquired in the operation S2018 is equal to the current quality threshold #3 (operation S2019).

In a case where the reception quality D2 is equal to the quality threshold #3 in the operation S2019 (Yes in the operation S2019), the control device 330 transitions to an operation S2033 without resetting the frequency of the optical transmitter 311c (#3). In a case where the reception quality D2 is not equal to the quality threshold #3 (No in the operation S2019), the control device 330 determines whether or not the reception quality D2 is lower than the current quality threshold #3 (operation S2020).

In a case where the reception quality D2 is lower than the quality threshold #3 in the operation S2020 (Yes in the operation S2020), the reception quality of the optical receiver 322c (#3) may be determined to be degraded. In this case, the control device 330 instructs the transmission controller 313 by a control signal to start a sweep of the optical transmitter 311c (#3) to the low-frequency side (operation S2021). Accordingly, the transmission controller 313 starts a sweep that changes the frequency of the optical transmitter 311c (#3) to the low-frequency side.

Next, the control device 330 acquires the reception quality information from the optical receiver 322c (#3) (operation S2022). Next, the control device 330 determines whether or not the reception quality of the optical receiver 322c (#3) indicated by the reception quality information acquired in the operation S2022 is equal to the quality threshold #3 (operation S2023). In a case where the reception quality is not equal to the quality threshold #3 (No in the operation S2023), the control device 330 returns to the operation S2022.

In a case where the reception quality is equal to the quality threshold #3 in the operation S2023 (Yes in the operation S2023), the control device 330 stores a frequency f32d1 of the optical transmitter 311c (#3) at the time point of the reception quality being equal to the quality threshold #3 (operation S2024). Accordingly, the frequency f32d1 of the optical transmitter 311c (#3) at which the reception quality of the optical receiver 322c (#3) is equal to the quality threshold #3 may be acquired.

Next, the control device 330 instructs the transmission controller 313 by a control signal to stop the frequency sweep of the optical transmitter 311c (#3) (operation S2025). Accordingly, the transmission controller 313 stops the frequency sweep of the optical transmitter 311c (#3).

Next, the control device 330 instructs the transmission controller 313 by a control signal to render the optical transmitter 311c (#3) to emit light at the frequency f32d1 stored in the operation S2024 (operation S2026). Accordingly, the transmission controller 313 sets the frequency of the optical transmitter 311c (#3) to the frequency f32d1. The control device 330 transitions to the operation S2033.

In a case where the reception quality D2 is higher than the quality threshold #3 in the operation S2020 (No in the operation S2020), the reception quality of the optical receiver 322c (#3) may be determined to be improved. In this case, the control device 330 instructs the transmission controller 313 by a control signal to start a sweep of the optical transmitter 311c (#3) to the high-frequency side (operation S2027). Accordingly, the transmission controller 313 starts a sweep that changes the frequency of the optical transmitter 311c (#3) to the high-frequency side.

Next, the control device 330 acquires the reception quality information from the optical receiver 322c (#3) (operation S2028). Next, the control device 330 determines whether or not the reception quality of the optical receiver 322c (#3) indicated by the reception quality information acquired in the operation S2028 is equal to the quality threshold #3 (operation S2029). In a case where the reception quality is not equal to the quality threshold #3 (No in the operation S2029), the control device 330 returns to the operation S2028.

In a case where the reception quality is equal to the quality threshold #3 in the operation S2029 (Yes in the operation S2029), the control device 330 stores the frequency f32d1 of the optical transmitter 311c (#3) at the time point of the reception quality being equal to the quality threshold #3 (operation S2030). Accordingly, the frequency f32d1 of the optical transmitter 311c (#3) at which the reception quality of the optical receiver 322c (#3) is equal to the quality threshold #3 may be acquired.

Next, the control device 330 instructs the transmission controller 313 by a control signal to stop the frequency sweep of the optical transmitter 311c (#3) (operation S2031). Accordingly, the transmission controller 313 stops the frequency sweep of the optical transmitter 311c (#3).

Next, the control device 330 instructs the transmission controller 313 by a control signal to render the optical transmitter 311c (#3) to emit light at the frequency f32d1 stored in the operation S2030 (operation S2032). Accordingly, the transmission controller 313 sets the frequency of the optical transmitter 311c (#3) to the frequency f32d1. The control device 330 transitions to the operation S2033.

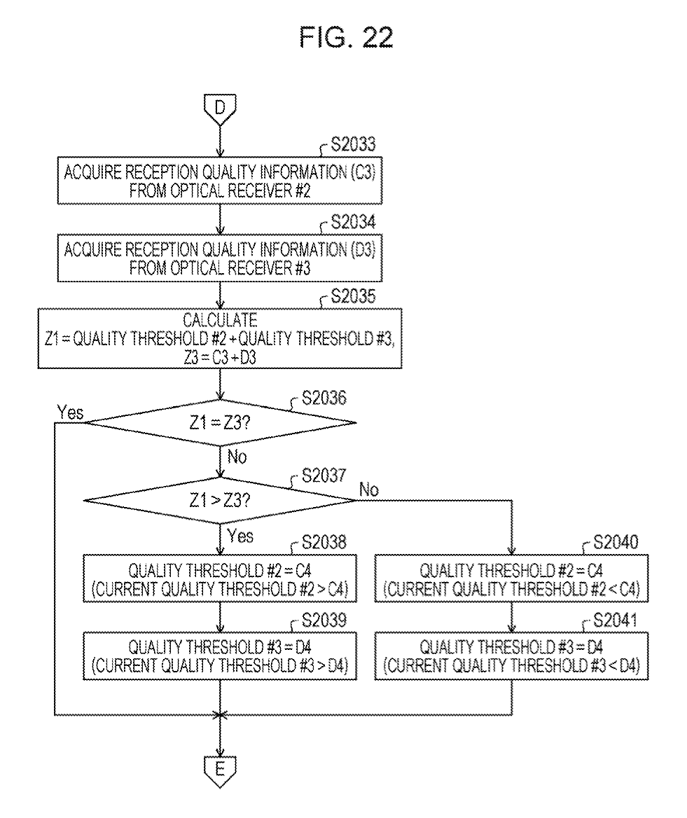

Next, as illustrated in FIG. 22, the control device 330 acquires the reception quality information from the optical receiver 322b (#2) (operation S2033). Reception quality indicated by the reception quality information acquired in the operation S2033 is C3. In addition, the control device 330 acquires the reception quality information from the optical receiver 322c (#3) (operation S2034). Reception quality indicated by the reception quality information acquired in the operation S2034 is D3.

Next, the control device 330 calculates Z1=quality threshold #2+quality threshold #3 and Z3=C3+D3 (operation S2035). Z1 is the reference total reception quality of the optical receivers 322b and 322c (#2 and #3). Z3 is the current total reception quality of the optical receivers 322b and 322c (#2 and #3).

Next, the control device 330 determines whether or not Z1 and Z3 calculated in the operation S2035 are equal to each other (operation S2036). In a case where Z1 and Z3 are equal to each other (Yes in the operation S2036), the control device 330 returns to the operation S2003 without resetting the quality threshold. In a case where Z1 and Z3 are not equal to each other (No in the operation S2036), the control device 330 determines whether or not Z3 is lower than Z1 (operation S2037).

In a case where Z3 is lower than Z1 in the operation S2037 (Yes in the operation S2037), the total reception quality of the optical receivers 322b and 322c (#2 and #3) may be determined to be degraded. In this case, the control device 330 sets the quality threshold #2 of the optical receiver 322b (#2) to C4 that is lower than the current quality threshold #2 (operation S2038). In addition, the control device 330 sets the quality threshold #3 of the optical receiver 322c (#3) to D4 that is lower than the current quality threshold #3 (operation S2039) and returns to the operation S2003.

In a case where Z3 is higher than Z1 in the operation S2037 (No in the operation S2037), the total reception quality of the optical receivers 322b and 322c (#2 and #3) may be determined to be improved. In this case, the control device 330 sets the quality threshold #2 of the optical receiver 322b (#2) to C4 that is higher than the current quality threshold #2 (operation S2040). In addition, the control device 330 sets the quality threshold #3 of the optical receiver 322c (#3) to D4 that is higher than the current quality threshold #3 (operation S2041) and returns to the operation S2003.

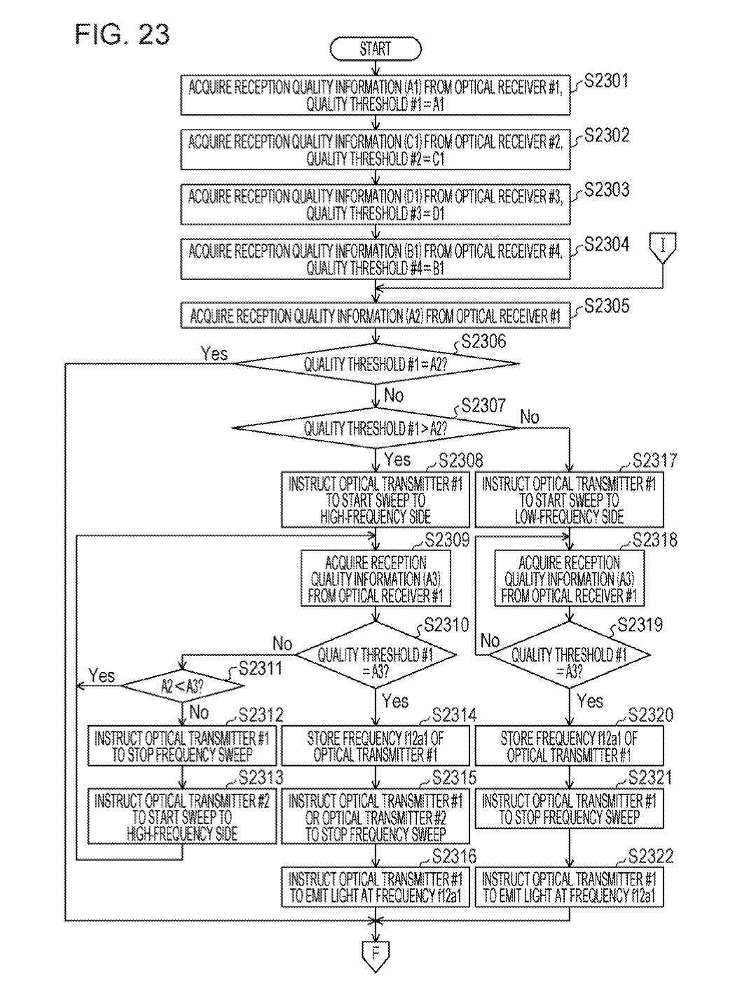

FIG. 23 to FIG. 26 are flowcharts illustrating another example of the frequency control process performed during operation by the control device according to the third embodiment. The control device 330 according to the third embodiment may perform, for example, each operation illustrated in FIG. 23 to FIG. 26 after operation of the optical transfer system 300 is started by, for example, the processes illustrated in FIG. 14 and FIG. 15. In FIG. 23 to FIG. 26, description will be provided in the case of controlling the frequencies of the sub-carriers #1 to #4.

First, as illustrated in FIG. 23, the control device 330 acquires the reception quality information from the optical receiver 322a (#1) and sets reception quality A1 indicated by the acquired reception quality information as a quality threshold #1 of the sub-carrier #1 (operation S2301). In addition, the control device 330 acquires the reception quality information from the optical receiver 322b (#2) and sets the reception quality C1 indicated by the acquired reception quality information as the quality threshold #2 of the sub-carrier #2 (operation S2302).

In addition, the control device 330 acquires the reception quality information from the optical receiver 322c (#3) and sets the reception quality D1 indicated by the acquired reception quality information as the quality threshold #3 of the sub-carrier #3 (operation S2303). In addition, the control device 330 acquires the reception quality information from the optical receiver 322d (#4) and sets reception quality B1 indicated by the acquired reception quality information as a quality threshold #4 of the sub-carrier #4 (operation S2304).

Next, the control device 330 performs a reset process for the frequency of the optical transmitter 311a (#1). That is, the control device 330 acquires the reception quality information from the optical receiver 322a (#1) (operation S2305). Reception quality indicated by the reception quality information acquired in the operation S2305 is A2. Next, the control device 330 determines whether or not the reception quality A2 indicated by the reception quality information acquired in the operation S2305 is equal to the current quality threshold #1 (operation S2306).

In a case where the reception quality A2 is equal to the quality threshold #1 in the operation S2306 (Yes in the operation S2306), the control device 330 transitions to an operation S2323 without resetting the frequency of the optical transmitter 311a (#1). In a case where the reception quality A2 is not equal to the quality threshold #1 (No in the operation S2306), the control device 330 determines whether or not the reception quality A2 is lower than the current quality threshold #1 (operation S2307).

In a case where the reception quality A2 is lower than the quality threshold #1 in the operation S2307 (Yes in the operation S2307), the reception quality of the optical receiver 322a (#1) may be determined to be degraded. In this case, the control device 330 instructs the transmission controller 313 by a control signal to start a sweep of the optical transmitter 311a (#1) to the high-frequency side (operation S2308). Accordingly, the transmission controller 313 starts a sweep that changes the frequency of the optical transmitter 311a (#1) to the high-frequency side.

Next, the control device 330 acquires the reception quality information from the optical receiver 322a (#1) (operation S2309). Reception quality indicated by the reception quality information acquired in the operation S2309 is A3. Next, the control device 330 determines whether or not the reception quality A3 is equal to the quality threshold #1 (operation S2310).

In a case where the reception quality A3 is not equal to the quality threshold #1 in the operation S2310 (No in the operation S2310), the control device 330 transitions to an operation S2311. That is, the control device 330 determines whether or not the reception quality A3 of the optical receiver 322a (#1) indicated by the reception quality information acquired in the operation S2309 is higher than the reception quality A2 (operation S2311).

In a case where the reception quality A3 is higher than the reception quality A2 in the operation S2311 (Yes in the operation S2311), reception quality for the sub-carrier #1 may be determined to be improved by the current sweep. In this case, the control device 330 returns to the operation S2309 and renders the sweep to continue.

In a case where the reception quality A3 is not higher than the reception quality A2 in the operation S2311 (No in the operation S2311), reception quality for the sub-carrier #1 may be determined to be degraded by the current sweep. In this case, the control device 330 instructs the transmission controller 313 by a control signal to stop the frequency sweep of the optical transmitter 311a (#1) (operation S2312). Accordingly, the transmission controller 313 stops the frequency sweep of the optical transmitter 311a (#1). In a case where the reception quality A3 is equal to the reception quality A2 in the operation S2311, the control device 330 may transition to any of the operation S2309 and the operation S2312.

Next, the control device 330 instructs the transmission controller 313 by a control signal to start a sweep, to the high-frequency side, of the optical transmitter 311b (#2) that corresponds to the sub-carrier #2 adjacent to the sub-carrier #1 (operation S2313) and returns to the operation S2309. Accordingly, the transmission controller 313 starts a sweep that changes the frequency of the optical transmitter 311b (#2) to the high-frequency side.

In a case where the reception quality A3 is equal to the quality threshold #1 in the operation S2310 (Yes in the operation S2310), the control device 330 stores a frequency f12a1 of the optical transmitter 311a (#1) at the time point of the reception quality A3 being equal to the quality threshold #1 (operation S2314). Accordingly, the frequency f12a1 of the optical transmitter 311a (#1) at which the reception quality of the optical receiver 322a (#1) is equal to the quality threshold #1 may be acquired.

Next, the control device 330 instructs the transmission controller 313 by a control signal to stop the frequency sweep of the optical transmitter 311a (#1) or the optical transmitter 311b (#2) (operation S2315). That is, the control device 330 instructs an optical transmitter of the optical transmitter 311a (#1) and the optical transmitter 311b (#2) sweeping the frequency thereof to stop the frequency sweep. Accordingly, the transmission controller 313 stops the frequency sweep of the optical transmitter 311a (#1) or the optical transmitter 311b (#2).

Next, the control device 330 instructs the transmission controller 313 by a control signal to render the optical transmitter 311a (#1) to emit light at the frequency f12a1 stored in the operation S2314 (operation S2316). Accordingly, the transmission controller 313 sets the frequency of the optical transmitter 311a (#1) to the frequency f12a1. The control device 330 transitions to the operation S2323.

In a case where the reception quality A2 is higher than the quality threshold #1 in the operation S2307 (No in the operation S2307), the reception quality of the optical receiver 322a (#1) may be determined to be improved. In this case, the control device 330 instructs the transmission controller 313 by a control signal to start a sweep of the optical transmitter 311a (#1) to the low-frequency side (operation S2317). Accordingly, the transmission controller 313 starts a sweep that changes the frequency of the optical transmitter 311a (#1) to the low-frequency side.

Next, the control device 330 acquires the reception quality information from the optical receiver 322a (#1) (operation S2318). Reception quality indicated by the reception quality information acquired in the operation S2318 is A3. Next, the control device 330 determines whether or not the reception quality A3 of the optical receiver 322a (#1) indicated by the reception quality information acquired in the operation S2318 is equal to the quality threshold #1 (operation S2319).

In a case where the reception quality A3 is not equal to the quality threshold #1 in the operation S2319 (No in the operation S2319), the control device 330 returns to the operation S2318. In a case where the reception quality A3 is equal to the quality threshold #1 (Yes in the operation S2319), the control device 330 stores the frequency f12a1 of the optical transmitter 311a (#1) at the time point of the reception quality A3 being equal to the quality threshold #1 (operation S2320). Accordingly, the frequency f12a1 of the optical transmitter 311a (#1) at which the reception quality of the optical receiver 322a (#1) is equal to the quality threshold #1 may be acquired.

Next, the control device 330 instructs the transmission controller 313 by a control signal to stop the frequency sweep of the optical transmitter 311a (#1) (operation S2321). Accordingly, the transmission controller 313 stops the frequency sweep of the optical transmitter 311a (#1).

Next, the control device 330 instructs the transmission controller 313 by a control signal to render the optical transmitter 311a (#1) to emit light at the frequency f12a1 stored in the operation S2320 (operation S2322). Accordingly, the transmission controller 313 sets the frequency of the optical transmitter 311a (#1) to the frequency f12a1. The control device 330 transitions to the operation S2323.

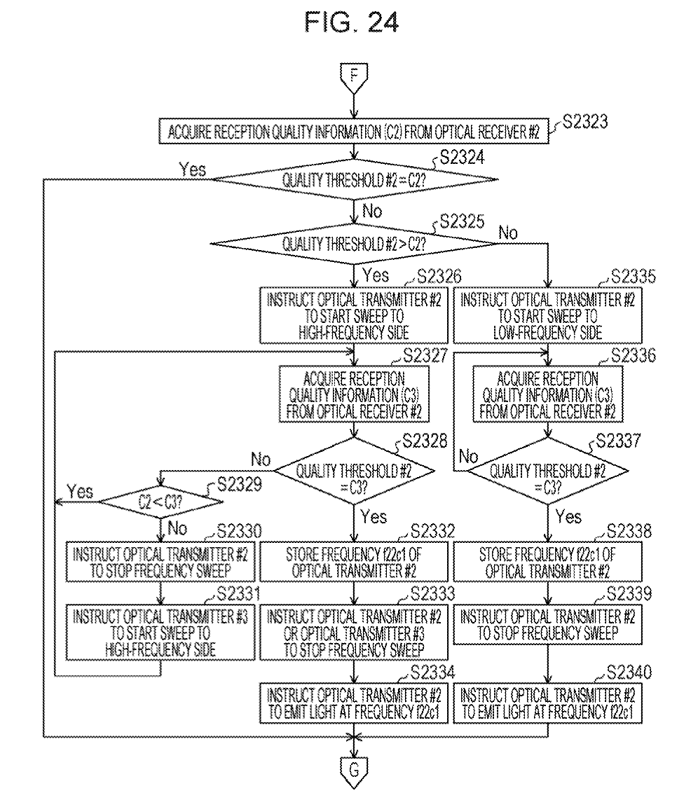

Next, as illustrated in FIG. 24, the control device 330 performs a reset process for the frequency of the optical transmitter 311b (#2). That is, the control device 330 acquires the reception quality information from the optical receiver 322b (#2) (operation S2323). Reception quality indicated by the reception quality information acquired in the operation S2323 is C2. Next, the control device 330 determines whether or not the reception quality C2 indicated by the reception quality information acquired in the operation S2323 is equal to the current quality threshold #2 (operation S2324).

In a case where the reception quality C2 is equal to the quality threshold #2 in the operation S2324 (Yes in the operation S2324), the control device 330 transitions to an operation S2341 without resetting the frequency of the optical transmitter 311b (#2). In a case where the reception quality C2 is not equal to the quality threshold #2 (No in the operation S2324), the control device 330 determines whether or not the reception quality C2 is lower than the current quality threshold #2 (operation S2325).

In a case where the reception quality C2 is lower than the quality threshold #2 in the operation S2325 (Yes in the operation S2325), the reception quality of the optical receiver 322b (#2) may be determined to be degraded. In this case, the control device 330 instructs the transmission controller 313 by a control signal to start a sweep of the optical transmitter 311b (#2) to the high-frequency side (operation S2326). Accordingly, the transmission controller 313 starts a sweep that changes the frequency of the optical transmitter 311b (#2) to the high-frequency side.

Next, the control device 330 acquires the reception quality information from the optical receiver 322b (#2) (operation S2327). Reception quality indicated by the reception quality information acquired in the operation S2327 is C3. Next, the control device 330 determines whether or not the reception quality C3 is equal to the quality threshold #2 (operation S2328).

In a case where the reception quality C3 is not equal to the quality threshold #2 in the operation S2328 (No in the operation S2328), the control device 330 transitions to an operation S2329. That is, the control device 330 determines whether or not the reception quality C3 of the optical receiver 322b (#2) indicated by the reception quality information acquired in the operation S2327 is higher than the reception quality C2 (operation S2329).

In a case where the reception quality C3 is higher than the reception quality C2 in the operation S2329 (Yes in the operation S2329), reception quality for the sub-carrier #2 may be determined to be improved by the current sweep. In this case, the control device 330 returns to the operation S2327 and renders the sweep to continue.

In a case where the reception quality C3 is not higher than the reception quality C2 in the operation S2329 (No in the operation S2329), the control device 330 may determine that reception quality for the sub-carrier #2 is degraded by the current sweep. In this case, the control device 330 instructs the transmission controller 313 by a control signal to stop the frequency sweep of the optical transmitter 311b (#2) (operation S2330). Accordingly, the transmission controller 313 stops the frequency sweep of the optical transmitter 311b (#2). In a case where the reception quality C3 is equal to the reception quality C2 in the operation S2329, the control device 330 may transition to any of the operation S2327 and the operation S2330.

Next, the control device 330 instructs the transmission controller 313 by a control signal to start a sweep, to the high-frequency side, of the optical transmitter 311c (#3) that corresponds to the sub-carrier #3 adjacent to the sub-carrier #2 (operation S2331) and returns to the operation S2327. Accordingly, the transmission controller 313 starts a sweep that changes the frequency of the optical transmitter 311c (#3) to the high-frequency side.

In a case where the reception quality C3 is equal to the quality threshold #2 in the operation S2328 (Yes in the operation S2328), the control device 330 stores the frequency f22c1 of the optical transmitter 311b (#2) at the time point of the reception quality C3 being equal to the quality threshold #2 (operation S2332). Accordingly, the frequency f22c1 of the optical transmitter 311b (#2) at which the reception quality of the optical receiver 322b (#2) is equal to the quality threshold #2 may be acquired.

Next, the control device 330 instructs the transmission controller 313 by a control signal to stop the frequency sweep of the optical transmitter 311b (#2) or the optical transmitter 311c (#3) (operation S2333). That is, the control device 330 instructs an optical transmitter of the optical transmitter 311b (#2) and the optical transmitter 311c (#3) sweeping the frequency thereof to stop the frequency sweep. Accordingly, the transmission controller 313 stops the frequency sweep of the optical transmitter 311b (#2) or the optical transmitter 311c (#3).

Next, the control device 330 instructs the transmission controller 313 by a control signal to render the optical transmitter 311b (#2) to emit light at the frequency f22c1 stored in the operation S2332 (operation S2334). Accordingly, the transmission controller 313 sets the frequency of the optical transmitter 311b (#2) to the frequency f22c1. The control device 330 transitions to the operation S2341.

In a case where the reception quality C2 is higher than the quality threshold #2 in the operation S2325 (No in the operation S2325), the reception quality of the optical receiver 322b (#2) may be determined to be improved. In this case, the control device 330 instructs the transmission controller 313 by a control signal to start a sweep of the optical transmitter 311b (#2) to the low-frequency side (operation S2335). Accordingly, the transmission controller 313 starts a sweep that changes the frequency of the optical transmitter 311b (#2) to the low-frequency side.

Next, the control device 330 acquires the reception quality information from the optical receiver 322b (#2) (operation S2336). Reception quality indicated by the reception quality information acquired in the operation S2336 is C3. Next, the control device 330 determines whether or not the reception quality C3 of the optical receiver 322b (#2) indicated by the reception quality information acquired in the operation S2336 is equal to the quality threshold #2 (operation S2337).

In a case where the reception quality C3 is not equal to the quality threshold #2 in the operation S2337 (No in the operation S2337), the control device 330 returns to the operation S2336. In a case where the reception quality C3 is equal to the quality threshold #2 (Yes in the operation S2337), the control device 330 stores the frequency f22c1 of the optical transmitter 311b (#2) at the time point of the reception quality C3 being equal to the quality threshold #2 (operation S2338). Accordingly, the frequency f22c1 of the optical transmitter 311b (#2) at which the reception quality of the optical receiver 322b (#2) is equal to the quality threshold #2 may be acquired.

Next, the control device 330 instructs the transmission controller 313 by a control signal to stop the frequency sweep of the optical transmitter 311b (#2) (operation S2339). Accordingly, the transmission controller 313 stops the frequency sweep of the optical transmitter 311b (#2).

Next, the control device 330 instructs the transmission controller 313 by a control signal to render the optical transmitter 311b (#2) to emit light at the frequency f22c1 stored in the operation S2338 (operation S2340). Accordingly, the transmission controller 313 sets the frequency of the optical transmitter 311b (#2) to the frequency f22c1. The control device 330 transitions to the operation S2341.

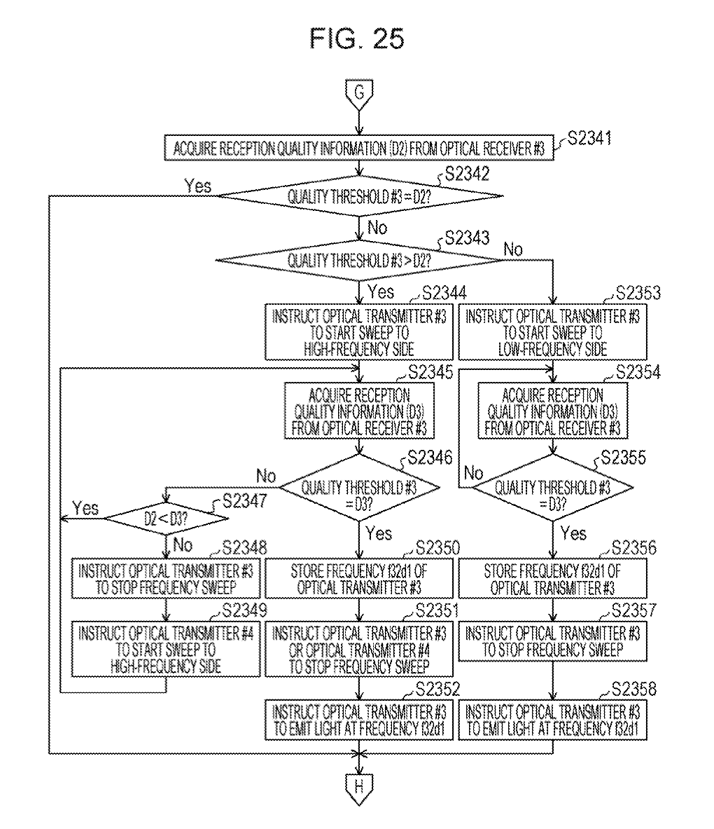

Next, as illustrated in FIG. 25, the control device 330 acquires the reception quality information from the optical receiver 322c (#3) (operation S2341). Reception quality indicated by the reception quality information acquired in the operation S2341 is D2. Next, the control device 330 determines whether or not the reception quality D2 indicated by the reception quality information acquired in the operation S2341 is equal to the current quality threshold #3 (operation S2342).

In a case where the reception quality D2 is equal to the quality threshold #3 in the operation S2342 (Yes in the operation S2342), the control device 330 transitions to an operation S2359 without resetting the frequency of the optical transmitter 311c (#3). In a case where the reception quality D2 is not equal to the quality threshold #3 (No in the operation S2342), the control device 330 determines whether or not the reception quality D2 is lower than the current quality threshold #3 (operation S2343).

In a case where the reception quality D2 is lower than the quality threshold #3 in the operation S2343 (Yes in the operation S2343), the reception quality of the optical receiver 322c (#3) may be determined to be degraded. In this case, the control device 330 instructs the transmission controller 313 by a control signal to start a sweep of the optical transmitter 311c (#3) to the high-frequency side (operation S2344). Accordingly, the transmission controller 313 starts a sweep that changes the frequency of the optical transmitter 311c (#3) to the high-frequency side.

Next, the control device 330 acquires the reception quality information from the optical receiver 322c (#3) (operation S2345). Reception quality indicated by the reception quality information acquired in the operation S2345 is D3. Next, the control device 330 determines whether or not the reception quality D3 is equal to the quality threshold #3 (operation S2346).

In a case where the reception quality D3 is not equal to the quality threshold #3 in the operation S2346 (No in the operation S2346), the control device 330 transitions to an operation S2347. That is, the control device 330 determines whether or not the reception quality D3 of the optical receiver 322c (#3) indicated by the reception quality information acquired in the operation S2345 is higher than the reception quality D2 (operation S2347).

In a case where the reception quality D3 is higher than the reception quality D2 in the operation S2347 (Yes in the operation S2347), reception quality for the sub-carrier #3 may be determined to be improved by the current sweep. In this case, the control device 330 returns to the operation S2345 and renders the sweep to continue.

In a case where the reception quality D3 is not higher than the reception quality D2 in the operation S2347 (No in the operation S2347), reception quality for the sub-carrier #3 may be determined to be degraded by the current sweep. In this case, the control device 330 instructs the transmission controller 313 by a control signal to stop the frequency sweep of the optical transmitter 311c (#3) (operation S2348). Accordingly, the transmission controller 313 stops the frequency sweep of the optical transmitter 311c (#3). In a case where the reception quality D3 is equal to the reception quality D2 in the operation S2347, the control device 330 may transition to any of the operation S2345 and the operation S2348.

Next, the control device 330 instructs the transmission controller 313 by a control signal to start a sweep, to the high-frequency side, of the optical transmitter 311d (#4) that corresponds to the sub-carrier #4 adjacent to the sub-carrier #3 (operation S2349) and returns to the operation S2345. Accordingly, the transmission controller 313 starts a sweep that changes the frequency of the optical transmitter 311d (#4) to the high-frequency side.

In a case where the reception quality D3 is equal to the quality threshold #3 in the operation S2346 (Yes in the operation S2346), the control device 330 stores the frequency f32d1 of the optical transmitter 311c (#3) at the time point of the reception quality D3 being equal to the quality threshold #3 (operation S2350). Accordingly, the frequency f32d1 of the optical transmitter 311c (#3) at which the reception quality of the optical receiver 322c (#3) is equal to the quality threshold #3 may be acquired.

Next, the control device 330 instructs the transmission controller 313 by a control signal to stop the frequency sweep of the optical transmitter 311c (#3) or the optical transmitter 311d (#4) (operation S2351). That is, the control device 330 instructs an optical transmitter of the optical transmitter 311c (#3) and the optical transmitter 311d (#4) sweeping the frequency thereof to stop the frequency sweep. Accordingly, the transmission controller 313 stops the frequency sweep of the optical transmitter 311c (#3) or the optical transmitter 311d (#4).

Next, the control device 330 instructs the transmission controller 313 by a control signal to render the optical transmitter 311c (#3) to emit light at the frequency f32d1 stored in the operation S2350 (operation S2352). Accordingly, the transmission controller 313 sets the frequency of the optical transmitter 311c (#3) to the frequency f32d1. The control device 330 transitions to the operation S2359.

In a case where the reception quality D2 is higher than the quality threshold #3 in the operation S2343 (No in the operation S2343), the reception quality of the optical receiver 322c (#3) may be determined to be improved. In this case, the control device 330 instructs the transmission controller 313 by a control signal to start a sweep of the optical transmitter 311c (#3) to the low-frequency side (operation S2353). Accordingly, the transmission controller 313 starts a sweep that changes the frequency of the optical transmitter 311c (#3) to the low-frequency side.

Next, the control device 330 acquires the reception quality information from the optical receiver 322c (#3) (operation S2354). Reception quality indicated by the reception quality information acquired in the operation S2354 is D3. Next, the control device 330 determines whether or not the reception quality D3 of the optical receiver 322c (#3) indicated by the reception quality information acquired in the operation S2354 is equal to the quality threshold #3 (operation S2355).

In a case where the reception quality D3 is not equal to the quality threshold #3 in the operation S2355 (No in the operation S2355), the control device 330 returns to the operation S2354. In a case where the reception quality D3 is equal to the quality threshold #3 (Yes in the operation S2355), the control device 330 stores the frequency f32d1 of the optical transmitter 311c (#3) at the time point of the reception quality D3 being equal to the quality threshold #3 (operation S2356). Accordingly, the frequency f32d1 of the optical transmitter 311c (#3) at which the reception quality of the optical receiver 322c (#3) is equal to the quality threshold #3 may be acquired.

Next, the control device 330 instructs the transmission controller 313 by a control signal to stop the frequency sweep of the optical transmitter 311c (#3) (operation S2357). Accordingly, the transmission controller 313 stops the frequency sweep of the optical transmitter 311c (#3).

Next, the control device 330 instructs the transmission controller 313 by a control signal to render the optical transmitter 311c (#3) to emit light at the frequency f32d1 stored in the operation S2356 (operation S2358). Accordingly, the transmission controller 313 sets the frequency of the optical transmitter 311c (#3) to the frequency f32d1. The control device 330 transitions to the operation S2359.

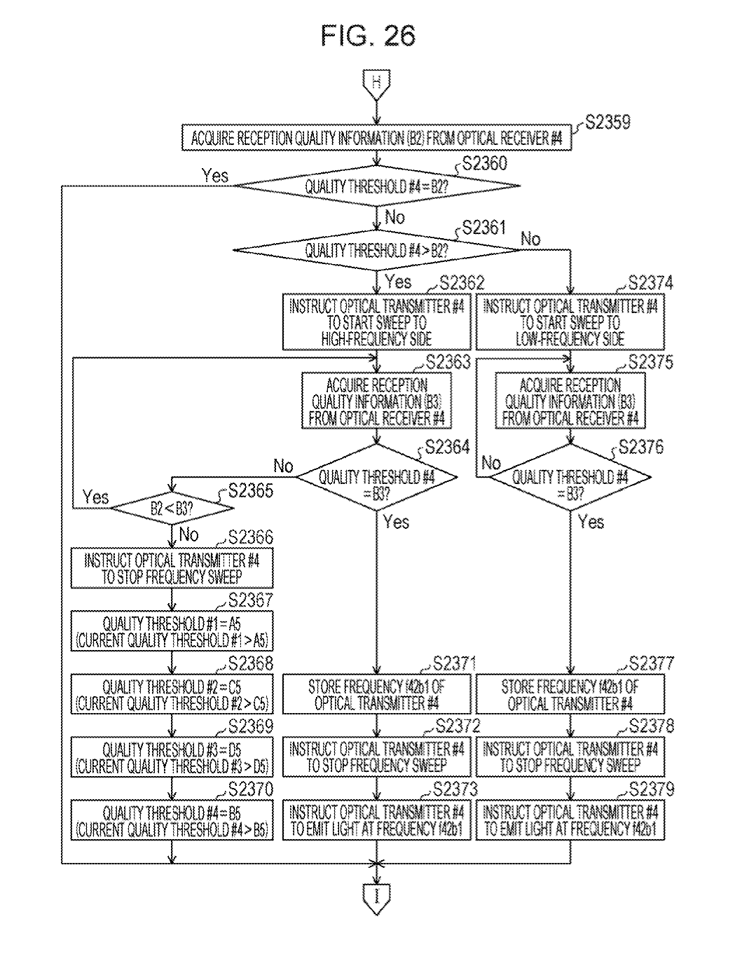

Next, as illustrated in FIG. 26, the control device 330 acquires the reception quality information from the optical receiver 322d (#4) (operation S2359). Reception quality indicated by the reception quality information acquired in the operation S2359 is B2. Next, the control device 330 determines whether or not the reception quality B2 indicated by the reception quality information acquired in the operation S2359 is equal to the current quality threshold #4 (operation S2360).

In a case where the reception quality B2 is equal to the quality threshold #4 in the operation S2360 (Yes in the operation S2360), the control device 330 returns to the operation S2305 without resetting the quality thresholds #1 to #4. In a case where the reception quality B2 is not equal to the quality threshold #4 (No in the operation S2360), the control device 330 determines whether or not the reception quality B2 is lower than the current quality threshold #4 (operation S2361).

In a case where the reception quality B2 is lower than the quality threshold #4 in the operation S2361 (Yes in the operation S2361), the reception quality of the optical receiver 322d (#4) may be determined to be degraded. In this case, the control device 330 instructs the transmission controller 313 by a control signal to start a sweep of the optical transmitter 311d (#4) to the high-frequency side (operation S2362). Accordingly, the transmission controller 313 starts a sweep that changes the frequency of the optical transmitter 311d (#4) to the high-frequency side.

Next, the control device 330 acquires the reception quality information from the optical receiver 322d (#4) (operation S2363). Reception quality indicated by the reception quality information acquired in the operation S2363 is B3. Next, the control device 330 determines whether or not the reception quality B3 is equal to the quality threshold #4 (operation S2364).

In a case where the reception quality B3 is not equal to the quality threshold #4 in the operation S2364 (No in the operation S2364), a transition is made to an operation S2365. That is, the control device 330 determines whether or not the reception quality B3 of the optical receiver 322d (#4) indicated by the reception quality information acquired in the operation S2363 is higher than the reception quality B2 (operation S2365).

In a case where the reception quality B3 is higher than the reception quality B2 in the operation S2365 (Yes in the operation S2365), reception quality for the sub-carrier #4 may be determined to be improved by the current sweep. In this case, the control device 330 returns to the operation S2363 and renders the sweep to continue.

In a case where the reception quality B3 is not higher than the reception quality B2 in the operation S2365 (No in the operation S2365), the control device 330 may determine that reception quality for the sub-carrier #4 is degraded by the current sweep. In this case, the control device 330 instructs the transmission controller 313 by a control signal to stop the frequency sweep of the optical transmitter 311d (#4) (operation S2366). Accordingly, the transmission controller 313 stops the frequency sweep of the optical transmitter 311d (#4). In a case where the reception quality B3 is equal to the reception quality B2 in the operation S2365, the control device 330 may transition to any of the operation S2363 and the operation S2366.

Next, the control device 330 sets the quality threshold #1 of the sub-carrier #1 to A5 that is lower than the current quality threshold #1 (operation S2367). In addition, the control device 330 sets the quality threshold #2 of the sub-carrier #2 to C5 that is lower than the current quality threshold #2 (operation S2368). In addition, the control device 330 sets the quality threshold #3 of the sub-carrier #3 to D5 that is lower than the current quality threshold #3 (operation S2369). In addition, the control device 330 sets the quality threshold #4 of the sub-carrier #4 to B5 that is lower than the current quality threshold #4 (operation S2370) and returns to the operation S2305.

In a case where the reception quality B3 is equal to the quality threshold #4 in the operation S2364 (Yes in the operation S2364), the control device 330 stores a frequency f42b1 of the optical transmitter 311d (#4) at the time point of the reception quality B3 being equal to the quality threshold #4 (operation S2371). Accordingly, the frequency f42b1 of the optical transmitter 311d (#4) at which the reception quality of the optical receiver 322d (#4) is equal to the quality threshold #4 may be acquired.

Next, the control device 330 instructs the transmission controller 313 by a control signal to stop the frequency sweep of the optical transmitter 311d (#4) (operation S2372). Accordingly, the transmission controller 313 stops the frequency sweep of the optical transmitter 311d (#4).

Next, the control device 330 instructs the transmission controller 313 by a control signal to render the optical transmitter 311d (#4) to emit light at the frequency f42b1 stored in the operation S2371 (operation S2373). Accordingly, the transmission controller 313 sets the frequency of the optical transmitter 311d (#4) to the frequency f42b1. The control device 330 returns to the operation S2305.

In a case where the reception quality B2 is higher than the quality threshold #4 in the operation S2361 (No in the operation S2361), the reception quality of the optical receiver 322d (#4) may be determined to be improved. In this case, the control device 330 instructs the transmission controller 313 by a control signal to start a sweep of the optical transmitter 311d (#4) to the low-frequency side (operation S2374). Accordingly, the transmission controller 313 starts a sweep that changes the frequency of the optical transmitter 311d (#4) to the low-frequency side.

Next, the control device 330 acquires the reception quality information from the optical receiver 322d (#4) (operation S2375). Reception quality indicated by the reception quality information acquired in the operation S2375 is B3. Next, the control device 330 determines whether or not the reception quality B3 of the optical receiver 322d (#4) indicated by the reception quality information acquired in the operation S2375 is equal to the quality threshold #4 (operation S2376).

In a case where the reception quality B3 is not equal to the quality threshold #4 in the operation S2376 (No in the operation S2376), the control device 330 returns to the operation S2375. In a case where the reception quality B3 is equal to the quality threshold #4 (Yes in the operation S2376), the control device 330 stores the frequency f42b1 of the optical transmitter 311d (#4) at the time point of the reception quality B3 being equal to the quality threshold #4 (operation S2377). Accordingly, the frequency f42b1 of the optical transmitter 311d (#4) at which the reception quality of the optical receiver 322d (#4) is equal to the quality threshold #4 may be acquired.

Next, the control device 330 instructs the transmission controller 313 by a control signal to stop the frequency sweep of the optical transmitter 311d (#4) (operation S2378). Accordingly, the transmission controller 313 stops the frequency sweep of the optical transmitter 311d (#4).

Next, the control device 330 instructs the transmission controller 313 by a control signal to render the optical transmitter 311d (#4) to emit light at the frequency f42b1 stored in the operation S2377 (operation S2379). Accordingly, the transmission controller 313 sets the frequency of the optical transmitter 311d (#4) to the frequency f42b1. The control device 330 returns to the operation S2305.

As illustrated in FIG. 20 to FIG. 26, even during typical operation after start-up, the transmission apparatus 320 detects reception quality for each sub-carrier, and a control signal is transmitted from the control device 330 to the transmission controller 313 in order to secure desired reception quality. The transmission controller 313 controls the tunable LDs 430 of the optical transmitters 311a to 311d in accordance with the control signal from the control device 330. Accordingly, even if each apparatus is degraded or the state of the transfer path fluctuates, a decrease in the reception quality of the transmission apparatus 320 may be reduced.

According to the transfer system 100 of the third embodiment, the wavelength of at least any of sub-carriers may be controlled after the start of operation based on the reception quality of the transmission apparatus 120 for at least any of the sub-carriers. The operation is, for example, operation of the transmission apparatus 110 in which each optical signal generated based on the user data is multiplexed and transmitted to the transmission apparatus 120. Accordingly, even if each apparatus is degraded or the state of the transfer path fluctuates, a decrease in the reception quality of the transmission apparatus 120 may be reduced.

### Fourth Embodiment

A different part of a fourth embodiment from the first to third embodiments will be described. In the fourth embodiment, for example, a configuration that sweeps the frequency of the tunable LD 510 of the optical receiver 500 as well when sweeping the frequency of the tunable LD 430 of the optical transmitter 400 will be described.

[Optical Transfer System]

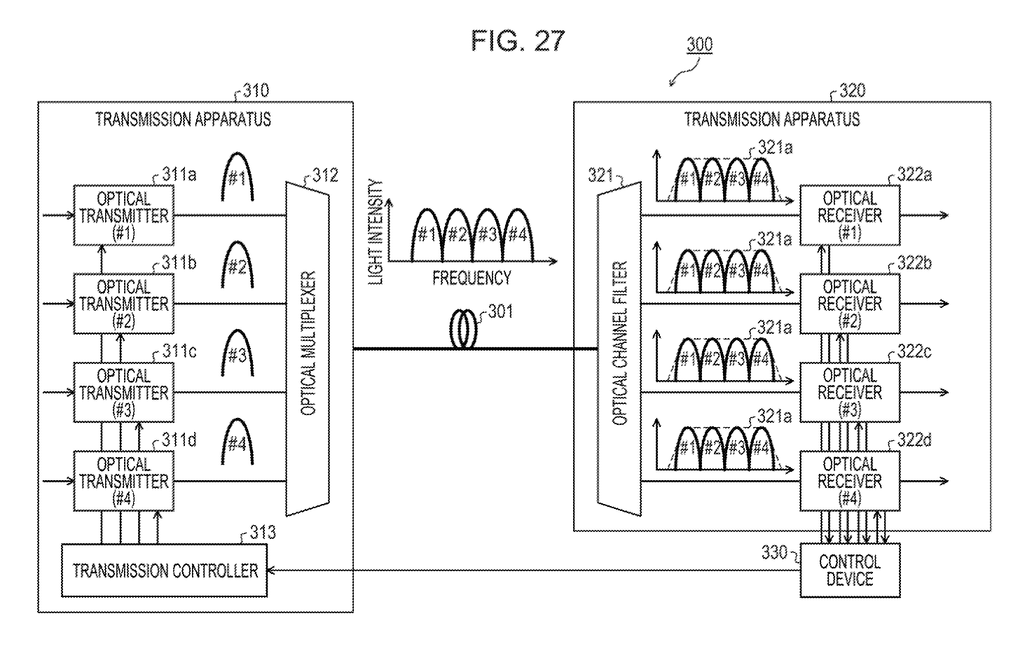

FIG. 27 is a diagram illustrating one example of an optical transfer system according to the fourth embodiment. The same part of FIG. 27 as the part illustrated in FIG. 3 will be designated by the same reference sign and will not be described. The control device 330 according to the fourth embodiment, when sweeping the frequencies of the optical transmitters 311a to 311d, performs control to set the frequencies of the tunable LDs 510 of the optical receivers 322a to 322d in respective correspondence with the optical transmitters 311a to 311d.

For example, the control device 330, when sweeping the frequency of the optical transmitter 311a from the frequency f10 to the frequency f11, sweeps the frequency of the tunable LD 510 of the optical receiver 322a from the frequency f10 to the frequency f11 in synchronization with the optical transmitter 311a. Accordingly, a shift in the frequency of the optical receiver 322a due to the frequency sweep of the optical transmitter 311a is reduced, and the reception quality of the optical receiver 322a such as BER may be accurately detected.

The control device 330, when sweeping the frequency of the optical transmitter 311d from the frequency f40 to the frequency f41, sweeps the frequency of the tunable LD 510 of the optical receiver 322d from the frequency f40 to the frequency f41 in synchronization with the optical transmitter 311d. Accordingly, a shift in the frequency of the optical receiver 322d due to the frequency sweep of the optical transmitter 311d is reduced, and the reception quality of the optical receiver 322d such as BER may be accurately detected.

[Optical Receiver]

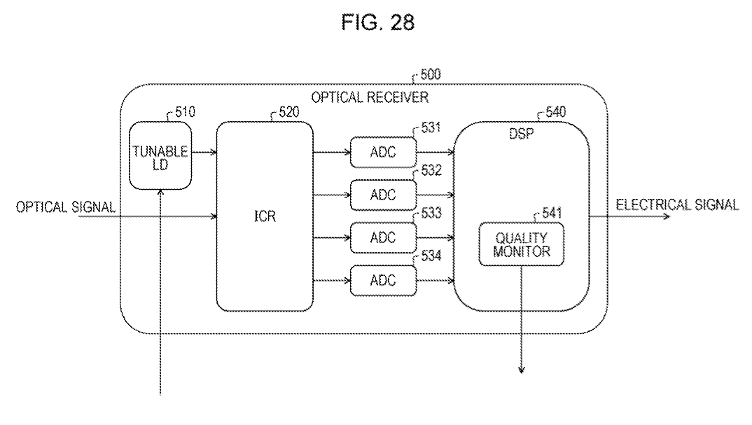

FIG. 28 is a diagram illustrating one example of an optical receiver according to the fourth embodiment. The same part of FIG. 28 as the part illustrated in FIG. 5 will be designated by the same reference sign and will not be described. As illustrated in FIG. 28, the frequency of the tunable LD 510 of the optical receiver 500 according to the fourth embodiment may be controlled by the control device 330.

The frequency of the tunable LD 510, during operation, is set in correspondence with the frequency of the tunable LD 430 of the optical transmitter 400 of the corresponding sub-carrier. In addition, in the fourth embodiment, the control device 330 sweeps the frequency of the tunable LD 510 in correspondence with a frequency sweep of the tunable LD 430 when initial arrangement of each sub-carrier is determined before operation.

[Process Performed at Start of Operation by Control Device]

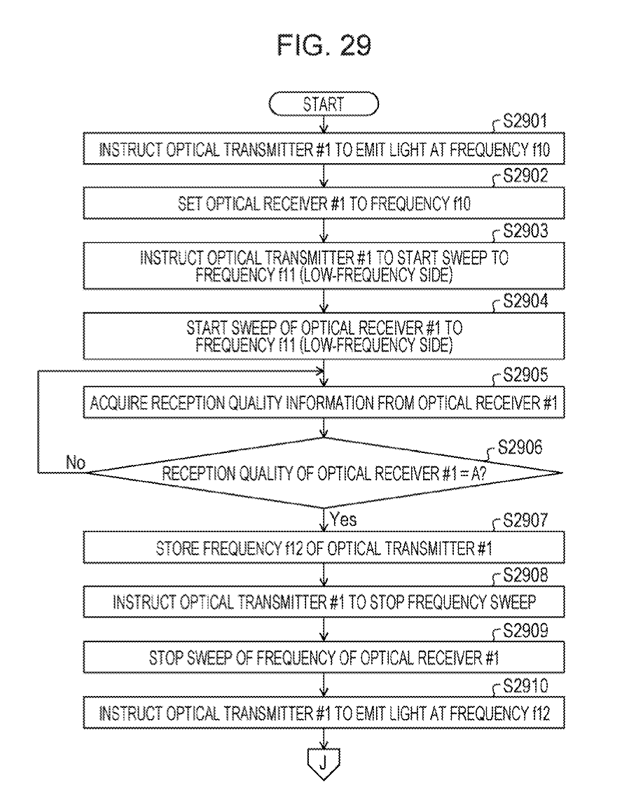

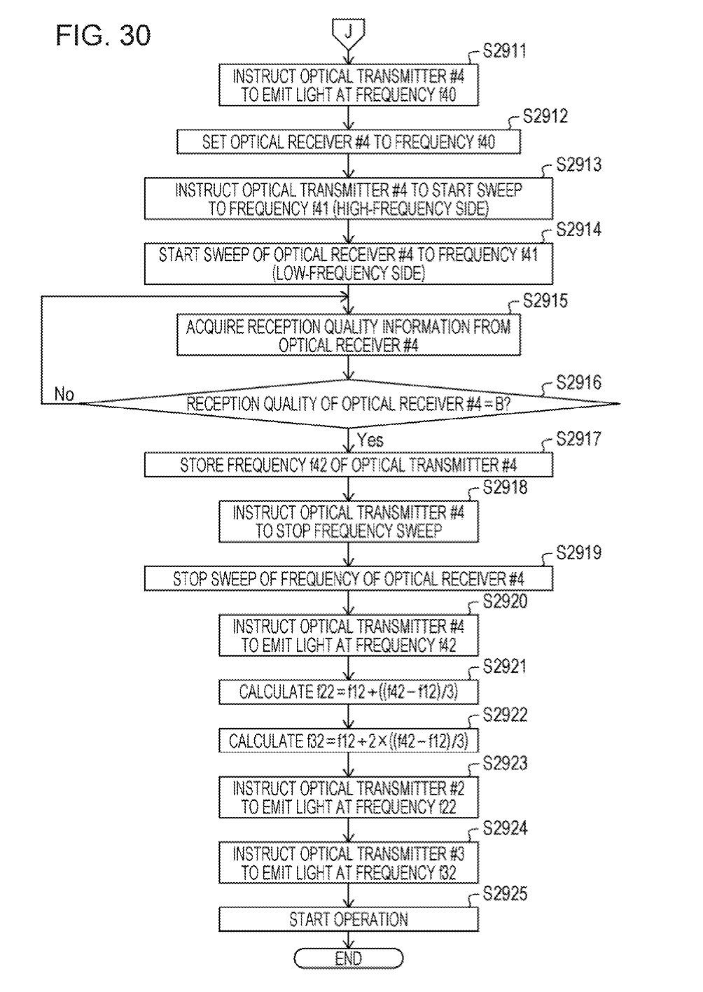

FIG. 29 and FIG. 30 are flowcharts illustrating one example of a process performed at the start of operation by a control device according to the fourth embodiment. The control device 330 according to the fourth embodiment performs, for example, each operation illustrated in FIG. 29 and FIG. 30 at the start of operation of the optical transfer system 300.

An operation S2901 illustrated in FIG. 29 is the same as the operation S1401 illustrated in FIG. 14. After the operation S2901, the control device 330 sets the frequency of the tunable LD 510 of the optical receiver 322a (#1) to the frequency f10 (operation S2902). An operation S2903 is the same as the operation S1402 illustrated in FIG. 14.

After the operation S2903, the control device 330 starts a sweep of the tunable LD 510 of the optical receiver 322a (#1) to the frequency f11 (low-frequency side) (operation S2904). At this point, the control device 330 sweeps the frequency of the tunable LD 510 of the optical receiver 322a (#1) in synchronization with the frequency sweep of the optical transmitter 311a (#1) started by the transmission controller 313 in the operation S2903.

Operations S2905 to S2908 are the same as the operations S1403 to S1406 illustrated in FIG. 14. Along with the operation S2908, the control device 330 stops the frequency sweep of the tunable LD 510 of the optical receiver 322a (#1) (operation S2909).

Operations S2910 and S2911 illustrated in FIG. 29 and FIG. 30 are the same as the operations S1407 and S1408 illustrated in FIG. 14. After the operation S2911, the control device 330 sets the frequency of the tunable LD 510 of the optical receiver 322d (#4) to the frequency f40 (operation S2912). An operation S2913 is the same as the operation S1409 illustrated in FIG. 14.

After the operation S2913, the control device 330 starts a sweep of the tunable LD 510 of the optical receiver 322d (#4) to the frequency f41 (low-frequency side) (operation S2914). At this point, the control device 330 sweeps the frequency of the tunable LD 510 of the optical receiver 322d (#4) in synchronization with the frequency sweep of the optical transmitter 311d (#4) started by the transmission controller 313 in the operation S2913.

Operations S2915 to S2918 are the same as the operations S1410 to S1413 illustrated in FIG. 14. After the operation S2918, the control device 330 stops the frequency sweep of the tunable LD 510 of the optical receiver 322d (#4) (operation S2919). Operations S2920 to S2925 are the same as the operations S1414 to S1419 illustrated in FIG. 14 and FIG. 15.

According to the transfer system 100 of the fourth embodiment, when the wavelength of an optical signal generated by any generator of the generators 111a to 111c is changed, the wavelength of local light in the transmission apparatus 120 may be changed in correspondence with the wavelength of the optical signal. Accordingly, the accuracy of detecting the reception quality of the transmission apparatus 120 for the optical signal having a wavelength thereof changed may be improved. Thus, arrangement of wavelengths may be adjusted to improve reception quality for each sub-carrier more accurately.

### Fifth Embodiment

A different part of a fifth embodiment from the first to fourth embodiments will be described. In the fifth embodiment, for example, a configuration that narrows the transmission bandwidth of the optical channel filter 321 when the wavelength of each sub-carrier is determined at the start-up of the transfer system 100 and that widens the transmission bandwidth of the optical channel filter 321 at the start of operation will be described.

[Optical Transfer System]

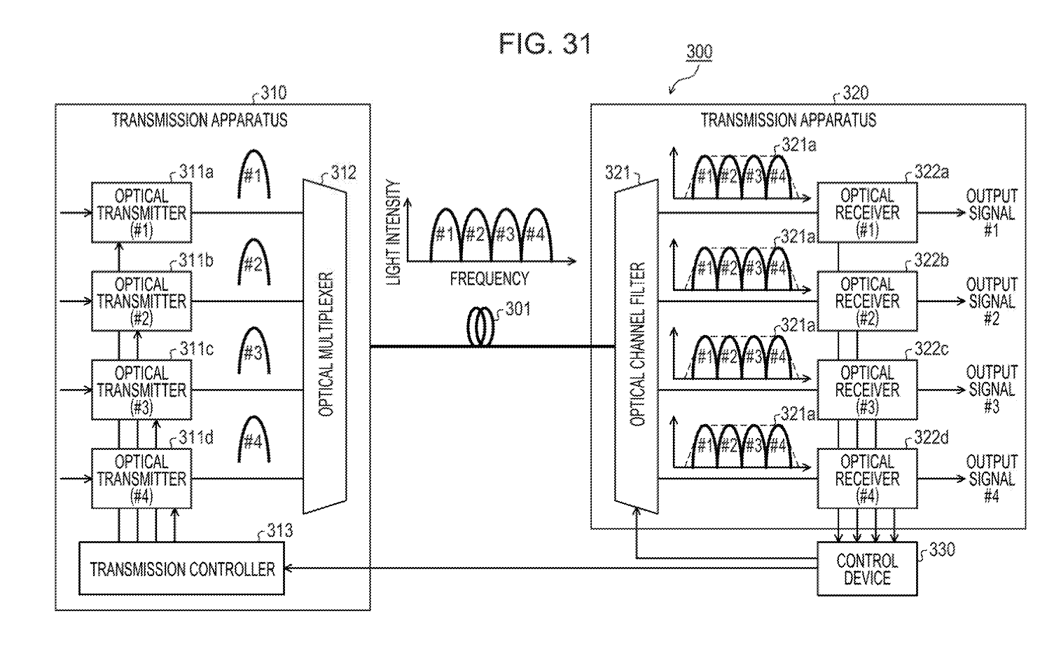

FIG. 31 is a diagram illustrating one example of an optical transfer system according to the fifth embodiment. The same part of FIG. 31 as the part illustrated in FIG. 3 will be designated by the same reference sign and will not be described. The optical channel filter 321 according to the fifth embodiment is a filter, such as an LCOS element, of which the transmission bandwidth may be changed. The control device 330 narrows the transmission bandwidth of the optical channel filter 321 from the transmission bandwidth thereof at the time of operation when adjusting the frequencies of the sub-carriers #1 to #4 before operation.

For example, in the optical channel filter 321 for which an LCOS element is used, the LCOS element is irradiated with input light to reflect the light, and the reflective light is guided to a predetermined output port. The refractive index when light is reflected by the LCOS element is controlled in order to guide the reflective light to the predetermined output port. The refractive index of the LCOS varies according to the wavelength of the input light and varies according to the temperature of the LCOS element or a voltage applied thereto.

Therefore, in the optical channel filter 321 for which an LCOS element is used, the transmission bandwidth for a target optical wavelength may be controlled by controlling the temperature or the voltage of the LCOS element based on the temperature characteristic or the voltage characteristic of the LCOS element.

When the refractive index to temperature characteristic or the voltage characteristic of the LCOS element changes with the passage of time or when the performance of a peripheral circuit controlling the temperature or the voltage of the LCOS element changes with the passage of time, the transmission bandwidth of the optical channel filter 321 may change with the passage of time. These changes with the passage of time widen or narrow the transmission characteristic of the optical channel filter 321 near the wavelength to be blocked.

Assume a case where, for example, the transmission bandwidth of the optical channel filter 321 is changed and narrowed with the passage of time after a time point when setting the wavelength of an optical signal is completed in accordance with the first embodiment. In this case, for an optical signal that is present near the wavelength to be blocked, the set wavelength value of the optical signal at the time point when setting the wavelength of the optical signal is completed becomes inappropriate after the optical channel filter 321 changes with the passage of time. The reason is that, for example, when the bandwidth of the optical channel filter 321 is narrowed with the set wavelength of the optical signal maintained, a part of the optical signal is removed, and signal quality is degraded.

Regarding this point, the fifth embodiment provides a method for adjusting the wavelength of an optical signal by predicting in advance, when a sub-carrier is started, the size of the transmission bandwidth of the optical channel filter 321 changed and narrowed with the passage of time.

[Setting Transmission Bandwidth of Optical Channel Filter]

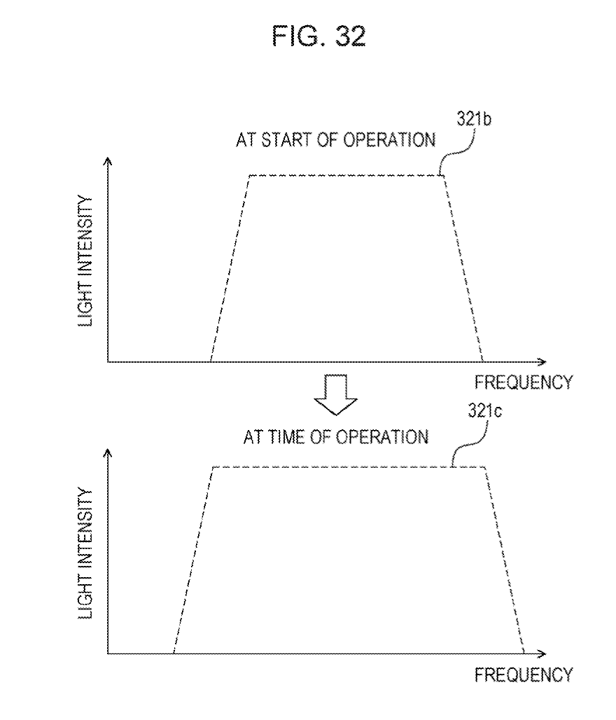

FIG. 32 is a diagram illustrating one example of setting the transmission bandwidth of an optical channel filter according to the fifth embodiment. A frequency transmission characteristic 321b illustrated in FIG. 32 is the frequency transmission characteristic 321a at the start of operation of each sub-carrier that is set by the control device 330. A frequency transmission characteristic 321c illustrated in FIG. 32 is the frequency transmission characteristic 321a at the time of operation of each sub-carrier that is set by the control device 330. As illustrated in FIG. 32, the control device 330 sets the transmission bandwidth of the frequency transmission characteristic 321b at the start of operation of each sub-carrier to be narrower than the transmission bandwidth of the frequency transmission characteristic 321c at the time of operation of each sub-carrier.

The frequency transmission characteristic 321b at the start of operation of each sub-carrier is, for example, the narrowest transmission bandwidth of the optical channel filter 321 that is compensated even after the optical channel filter 321 changes with the passage of time. The frequency transmission characteristic 321c at the time of operation of each sub-carrier is, for example, the transmission bandwidth of the optical channel filter 321 that is most widely set to the extent not interfering with another super-channel.

[Process Performed at Start of Operation by Control Device]

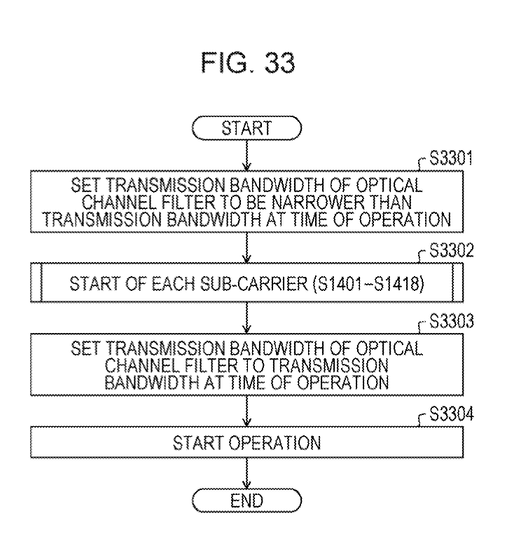

FIG. 33 is a flowchart illustrating one example of a process performed at the start of operation by a control device according to the fifth embodiment. The control device 330 according to the fifth embodiment performs, for example, each operation illustrated in FIG. 33 at the start of operation of the optical transfer system 300.

First, the control device 330 sets the transmission bandwidth of the optical channel filter 321 to be narrower than the transmission bandwidth thereof at the time of operation (operation S3301). For example, the control device 330 sets the frequency transmission characteristic 321a to the frequency transmission characteristic 321b illustrated in FIG. 32 by controlling the voltage applied to the optical channel filter 321.

Next, the control device 330 renders each sub-carrier to start by setting the frequencies of the optical transmitters 311a to 311d (#1 to #4) (operation S3302). The start of each sub-carrier in the operation S3302 may be rendered by, for example, the same processes as the operations S1401 to S1418 illustrated in FIG. 14 and FIG. 15.

Next, the control device 330 sets the transmission bandwidth of the optical channel filter 321 to the transmission bandwidth thereof at the time of operation (operation S3303). For example, the control device 330 sets the frequency transmission characteristic 321a to the frequency transmission characteristic 321c illustrated in FIG. 32 by controlling the voltage applied to the optical channel filter 321.

Next, the control device 330 performs control to start operation in which an optical signal based on the user data is transmitted from the transmission apparatus 310 to the transmission apparatus 320 (operation S3304), and ends a series of processes at the start of operation.

According to the transfer system 100 of the fifth embodiment, the transmission bandwidth (predetermined bandwidth) of the optical filter 121 when control is performed to set the frequency of each sub-carrier at the start of operation may be set to be narrower than the transmission bandwidth of the optical filter 121 at the time of operation. Accordingly, the frequency of each sub-carrier is set to have a margin with the transmission bandwidth of the optical filter 121, and a decrease in reception quality for each sub-carrier may be reduced even if the transmission bandwidth of the optical filter 121 is changed and narrowed with the passage of time.

The way reception quality for an optical signal received by the transmission apparatus 120 is changed in the state of operation is not easily quantified. The reason is that reception quality for an optical signal is changed by various parameters such as OSNR, PMD, PDL, and polarization state or by a change in the bandwidth of the optical filter 121. OSNR is the abbreviation for optical signal noise ratio. PMD is the abbreviation for polarization mode dispersion. PDL is the abbreviation for polarization dependent loss.

Regarding this point, according to the transfer system 100 of the fifth embodiment, the frequency of each sub-carrier may be set to have a margin with the transmission band of the optical filter 121. Accordingly, even if the transmission bandwidth of the optical filter 121 is changed and narrowed with the passage of time, a decrease in reception quality for each sub-carrier may be reduced.

### Sixth Embodiment

A different part of a sixth embodiment from the first to fifth embodiments will be described. In the sixth embodiment, for example, a configuration that increases the spectrum width of each sub-carrier from the width thereof at the time of operation when the wavelength of each sub-carrier is determined at the start-up of the transfer system 100 and that decreases the spectrum width of each sub-carrier at the start of operation will be described.

The spectrum width of a sub-carrier is changed according to, for example, setting of the baud rate of the sub-carrier or setting of a Nyquist filter. The baud rate of the sub-carrier is changed according to, for example, a modulation scheme for the sub-carrier.

[Setting Baud Rate of Each Sub-Carrier Performed by Control Device]

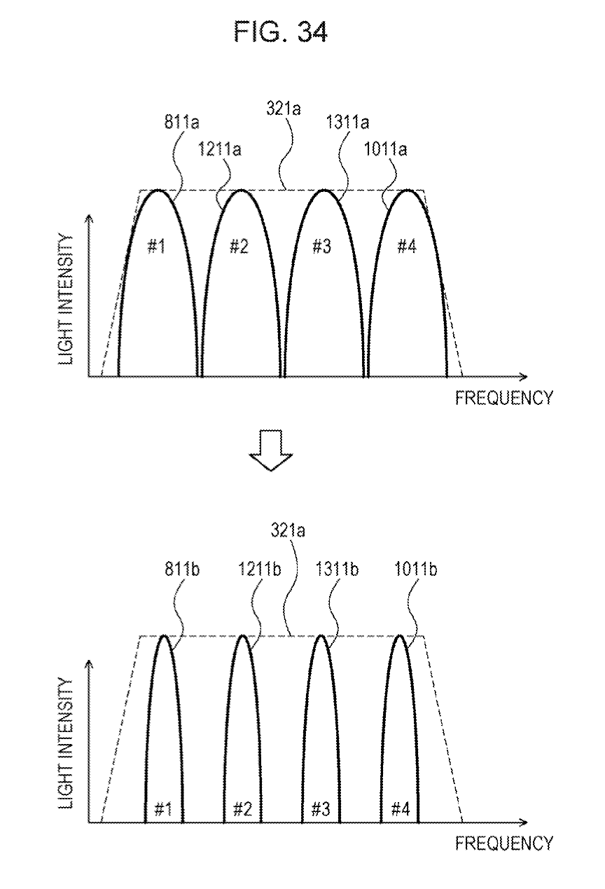

FIG. 34 is a diagram illustrating one example of setting the baud rate of each sub-carrier performed by a control device according to the sixth embodiment. Sub-carriers 811a, 1011a, 1211a, and 1311a illustrated in FIG. 34 are the sub-carriers #1 to #4 of which the baud rates are set by the control device 330 at the start of operation of the sub-carriers #1 to #4. Sub-carriers 811b, 1011b, 1211b, and 1311b illustrated in FIG. 34 are the sub-carriers #1 to #4 of which the baud rates are set by the control device 330 at the time of operation of the sub-carriers #1 to #4.

For example, the sub-carriers 811a, 1011a, 1211a, and 1311a are formed by dual polarization quadrature phase shift keying (DP-QPSK) and have a baud rate of 32 [Gbps]. For example, a sub-carrier of DP-QPSK is transferred at a speed of 32 [Gbps] baud rate×2 (2 [bits])×2 (X and Y polarizations)=128 [Gbps].

The sub-carriers 811b, 1011b, 1211b, and 1311b are formed by DP-16 quadrature amplitude modulation (QAM) and have a baud rate of 16 [Gbps]. For example, a sub-carrier of DP-16QAM is transferred at a speed of 16 [Gbps] baud rate×4 (4 [bits])×2 (X and Y polarizations)=128 [Gbps].

Each sub-carrier of DP-QPSK and DP-16QAM, even though having the same transfer speed, has a different baud rate and accordingly has a different spectrum width. As illustrated in FIG. 34, the control device 330 increases the spectrum width of each sub-carrier from the spectrum width thereof at the time of operation by setting the baud rate of each sub-carrier at the start of operation thereof to be higher than the baud rate of each sub-carrier at the time of operation.

[Process Performed at Start of Operation by Control Device]

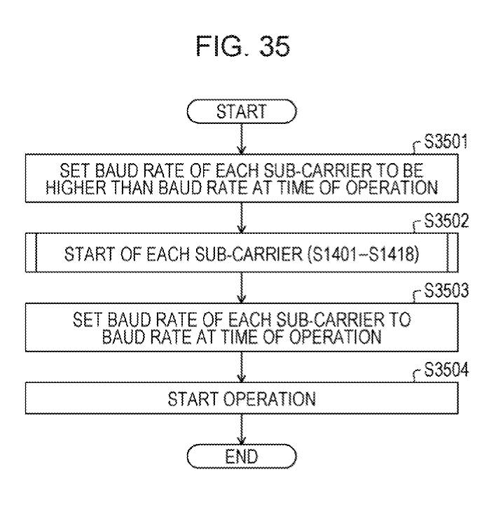

FIG. 35 is a flowchart illustrating one example of a process performed at the start of operation by the control device according to the sixth embodiment. The control device 330 according to the sixth embodiment performs, for example, each operation illustrated in FIG. 33 at the start of operation of the optical transfer system 300.

First, the control device 330 transmits a control signal to the transmission controller 313 to set the baud rates of the sub-carriers #1 to #4 to be higher than the baud rates thereof at the time of operation (operation S3501). For example, the control device 330 sets the baud rates of the sub-carriers #1 to #4 to 32 [Gbps] in the same manner as the sub-carriers 811a, 1011a, 1211a, and 1311a illustrated in FIG. 34.

Next, the control device 330 renders each sub-carrier to start by setting the frequencies of the optical transmitters 311a to 311d (#1 to #4) (operation S3502). The start of each sub-carrier in the operation S3502 may be rendered by, for example, the same processes as the operations S1401 to S1418 illustrated in FIG. 14 and FIG. 15.

Next, the control device 330 sets the baud rates of the sub-carriers #1 to #4 to the baud rates thereof at the time of operation (operation S3503). For example, the control device 330 sets the baud rates of the sub-carriers #1 to #4 to 16 [Gbps] in the same manner as the sub-carriers 811b, 1011b, 1211b, and 1311b illustrated in FIG. 34.

Next, the control device 330 performs control to start operation in which an optical signal based on the user data is transmitted from the transmission apparatus 310 to the transmission apparatus 320 (operation S3504), and ends a series of processes at the start of operation.

While description is provided in the case of switching a modulation scheme in order to increase the baud rate of a sub-carrier at the start of operation thereof, Nyquist filters of the optical transmitters 311a to 311d may be controlled in order to widen the spectrum of the sub-carrier at the start of operation thereof.

For example, the optical transmitters 311a to 311d respectively control the spectra of the sub-carriers #1 to #4 by using Nyquist filters. The Nyquist filter is realized by, for example, an electrical signal filter using an equalizer. The spectrum width of each sub-carrier may be changed by controlling the gain and the like of the electrical signal filter.

[Setting Nyquist Filter Performed at Start of Operation by Control Device]

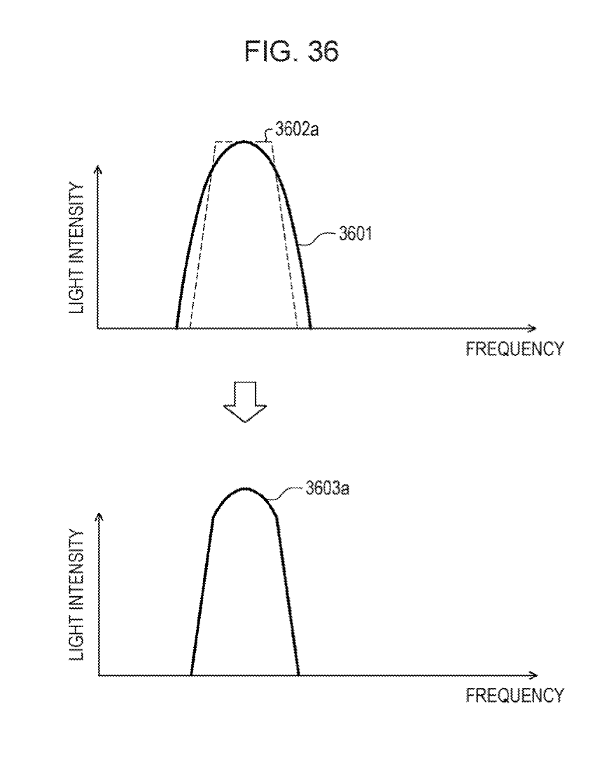

FIG. 36 is a diagram illustrating one example of setting a Nyquist filter performed at the start of operation by the control device according to the sixth embodiment. In FIG. 36, the horizontal axis denotes the frequency of an optical signal, and the vertical axis denotes light intensity. A sub-carrier 3601 illustrated in FIG. 36 illustrates a sub-carrier before being processed by the Nyquist filters in the optical transmitters 311a to 311d.

A filter characteristic 3602a illustrates a characteristic of the Nyquist filters of the optical transmitters 311a to 311d before starting of each sub-carrier. A sub-carrier 3603a is a sub-carrier that is acquired by processing the sub-carrier 3601 by using the Nyquist filter of the filter characteristic 3602a.

As illustrated in FIG. 36, the spectrum of the sub-carrier 3603a transmitted by the optical transmitters 311a to 311d may be widened by setting the filter characteristic of the Nyquist filter to the filter characteristic 3602a that has a comparatively wide transmission bandwidth.

[Setting Nyquist Filter Performed at Time of Operation by Control Device]

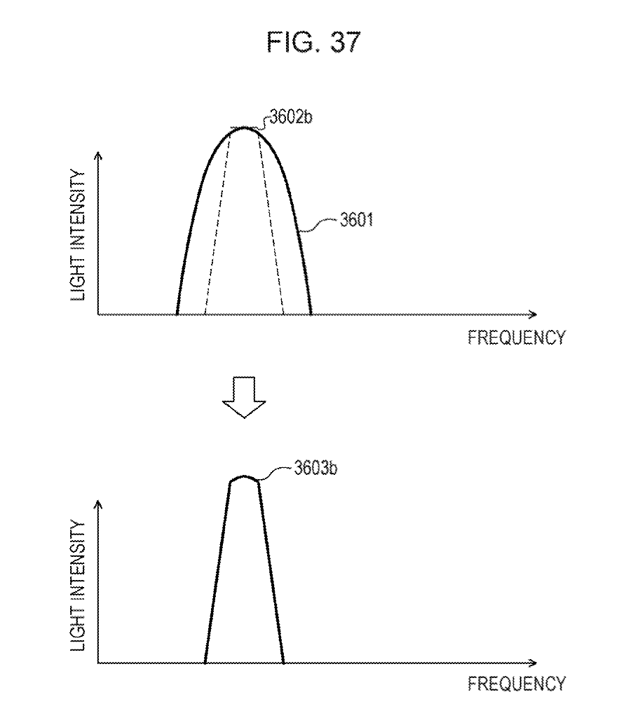

FIG. 37 is a diagram illustrating one example of setting the Nyquist filter performed at the time of operation by the control device according to the sixth embodiment. The same part of FIG. 37 as the part illustrated in FIG. 36 will be designated by the same reference sign and will not be described. A filter characteristic 3602b illustrated in FIG. 36 illustrates a characteristic of the Nyquist filters of the optical transmitters 311a to 311d at the time of operation of each sub-carrier. A sub-carrier 3603b is a sub-carrier that is acquired by processing the sub-carrier 3601 by using the Nyquist filter of the filter characteristic 3602b.

As illustrated in FIG. 37, the spectrum of the sub-carrier 3603a transmitted by the optical transmitters 311a to 311d may be narrowed by setting the filter characteristic of the Nyquist filter to the filter characteristic 3602b that has a comparatively narrow transmission bandwidth.

According to the transfer system 100 of the sixth embodiment, the spectrum width of an optical signal having a wavelength thereof changed at the time of monitoring reception quality for the optical signal for monitoring may be set to be greater than the spectrum width of each optical signal at the time of operation.

Accordingly, in a state where reception quality is likely to be decreased from reception quality at the time of operation by interference between adjacent sub-carriers, the frequency of each sub-carrier at the start of operation may be set based on a monitoring result for reception quality. Therefore, the accuracy of detecting reception quality for an optical signal having a wavelength thereof changed may be improved. Thus, arrangement of wavelengths may be adjusted to improve reception quality for each sub-carrier more accurately.

The frequency of each sub-carrier may be set to have a margin with the transmission band of the optical filter 121 by setting the frequency of each sub-carrier with the spectrum widths of the sub-carriers widened. Thus, for example, even if the transmission bandwidth of the optical filter 121 is changed and narrowed by the passage of time or even if each apparatus is degraded or the state of the transfer path fluctuates, a decrease in the reception quality of the transmission apparatus 120 for each sub-carrier may be reduced.

The spectrum width of an optical signal having a wavelength thereof changed may be increased from the spectrum width thereof at the time of operation by adjusting the baud rate of the optical signal having a wavelength thereof changed to be higher than the baud rate thereof at the time of operation. Alternatively, the spectrum width of the optical signal having a wavelength thereof changed may be increased from the spectrum width thereof at the time of operation by adjusting the transmission bandwidth of the Nyquist filter generating the optical signal having a wavelength thereof changed to be wider than the transmission bandwidth thereof at the time of operation.

### Seventh Embodiment

A different part of a seventh embodiment from the first to sixth embodiments will be described. In the seventh embodiment, for example, a configuration that sets, according to a determination result for the frequency of one of the sub-carriers #1 and #4, the range of a frequency sweep of the other of the sub-carriers #1 and #4 will be described.

[Low-Frequency Side Sub-Carrier Sweep]

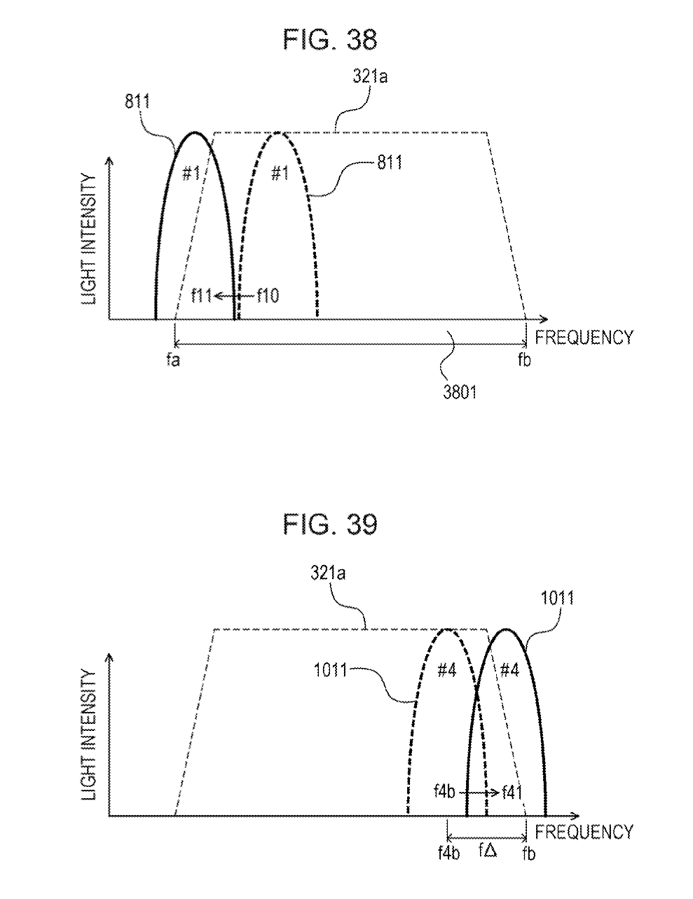

FIG. 38 is a diagram illustrating one example of a low-frequency side sub-carrier sweep in an optical transfer system according to the seventh embodiment. The control device 330 according to the seventh embodiment, for example, sweeps the frequency of the optical transmitter 311a (#1) from the frequency f10 to the frequency f11 in the same manner as the first embodiment for the most low-frequency side sub-carrier #1. Accordingly, the frequency f12 of the optical transmitter 311a (#1) at which the reception quality thereof is equal to the predetermined value A may be specified.

A transmission bandwidth 3801 illustrated in FIG. 38 is a known transmission bandwidth in the frequency transmission characteristic 321a of the optical channel filter 321. The most low-frequency side frequency of the transmission bandwidth 3801 is a frequency fa, and the most high-frequency side frequency of the transmission bandwidth 3801 is a frequency fb.

The control device 330 calculates a difference fΔ between the specified frequency f12 and the frequency fa by using, for example, Expression (4) below.

fΔ=f12−fa (4)

The control device 330 uses, for example, Expression (5) below to determine an initial frequency f4b at the time of sweeping the frequency of the optical transmitter 311d (#4) in order to determine the frequency of the most high-frequency side sub-carrier #4.

f4b=fb−fΔ (5)

The control device 330 may determine, as the initial frequency f4b at the time of sweeping the frequency of the optical transmitter 311d (#4), a frequency that is lower than fb−fΔ of above Expression (5) by a certain amount of margin.

[High-Frequency Side Sub-Carrier Sweep]

FIG. 39 is a diagram illustrating one example of a high-frequency side sub-carrier sweep in the optical transfer system according to the seventh embodiment. The control device 330 according to the seventh embodiment sweeps the frequency of the optical transmitter 311a (#1) from the frequency f4b determined by above Expression (5) to the frequency f41 for the most high-frequency side sub-carrier #4.

As illustrated in FIG. 38 and FIG. 39, the control device 330 sets the range of a frequency sweep of the high-frequency side sub-carrier #2 according to a determination result for the frequency f12 of the low-frequency side sub-carrier #1. For example, in a case where the difference fΔ between the frequency f12 and the frequency fa based on above Expression (4) is small, BER reaches the predetermined value A comparatively late after a sweep of the sub-carrier #1 is started.

In such a situation, BER may be estimated to reach the predetermined value B comparatively late after a sweep of the sub-carrier #4 is started. That is, in such a situation, a sweep of a low-frequency side candidate for the frequency of the sub-carrier #4 is highly likely to be useless. Such a situation is considered to be, for example, a situation where the transmission bandwidth of the optical channel filter 321 is wider than a set value or an average value or a situation where reception quality is likely to be comparatively high according to the status of the apparatuses or the transfer path.

Regarding this point, according to above Expression (5), the initial frequency f4b at the time of starting a sweep of the sub-carrier #4 may be set to be comparatively high in a case where the difference fΔ is small. Thus, the amount of time taken for a frequency sweep of the sub-carrier #4 in order to specify the frequency f42 at which the BER of the sub-carrier #4 is equal to the predetermined value B may be reduced.

While the configuration that sets the range of a frequency sweep of the high-frequency side sub-carrier #2 according to a detection result for the low-frequency side frequency f12 with both end frequencies fa and fb of the transmission bandwidth 3801 as a reference is described in the example illustrated in FIG. 38 and FIG. 39, the present embodiment is not limited to such a configuration.

For example, in a case where the center frequency of the optical channel filter 321 is known to be a frequency fc, the control device 330 may calculate the difference fΔ between the determined frequency f12 and the frequency fc by using, for example, Expression (6) below.

fΔ=fc−f12 (6)

In this case, the control device 330 uses, for example, Expression (7) below to determine the initial frequency f4b at the time of sweeping the frequency of the optical transmitter 311d (#4) in order to determine the frequency of the most high-frequency side sub-carrier #4.

f4b=fc+fΔ (7)

Alternatively, the control device 330 may determine, as the initial frequency f4b at the time of sweeping the frequency of the optical transmitter 311d (#4), a frequency that is lower than fc+fΔ of above Expression (7) by a certain amount of margin.

In addition, as described above, the configuration that determines the frequency f42 of the high-frequency side sub-carrier #4 and then determines the frequency f12 of the low-frequency side sub-carrier #1 may be used. In this case, the control device 330 may set the range of a frequency sweep of the low-frequency side sub-carrier #1 according to a detection result for the frequency f42 of the high-frequency side sub-carrier #4.

According to the transfer system 100 of the seventh embodiment, a wavelength range (the range of candidates) at the time of changing the wavelength of the optical signal for monitoring to a plurality of candidates for the wavelength of the second optical signal having the shortest wavelength may be set based on a determination result for the wavelength of the first optical signal having the longest wavelength. Accordingly, a process (sweep) of changing the wavelength of the second optical signal may be efficiently performed. For example, the process of changing the wavelength of the second optical signal may be performed in a small amount of time.

According to the transfer system 100 of the seventh embodiment, a wavelength range (the range of candidates) at the time of changing the wavelength of the optical signal for monitoring to a plurality of candidates for the wavelength of the first optical signal having the longest wavelength may be set based on a determination result for the wavelength of the second optical signal having the shortest wavelength. Accordingly, a process (sweep) of changing the wavelength of the first optical signal may be efficiently performed. For example, the process of changing the wavelength of the first optical signal may be performed in a small amount of time.

### Eighth Embodiment

A different part of an eighth embodiment from the first to seventh embodiments will be described. In the eighth embodiment, for example, a configuration that sets the initial wavelength of each sub-carrier and then achieves uniform reception quality for the first optical signal or the second optical signal and for an optical signal except for the first optical signal and the second optical signal will be described.

[Process Performed at Start of Operation by Control Device]

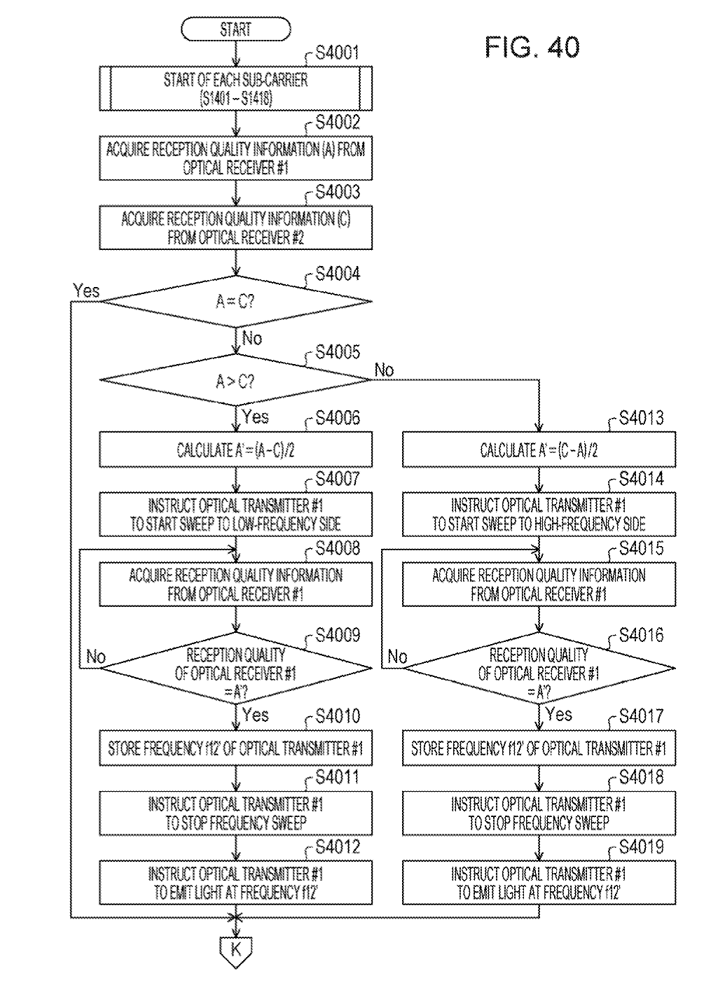

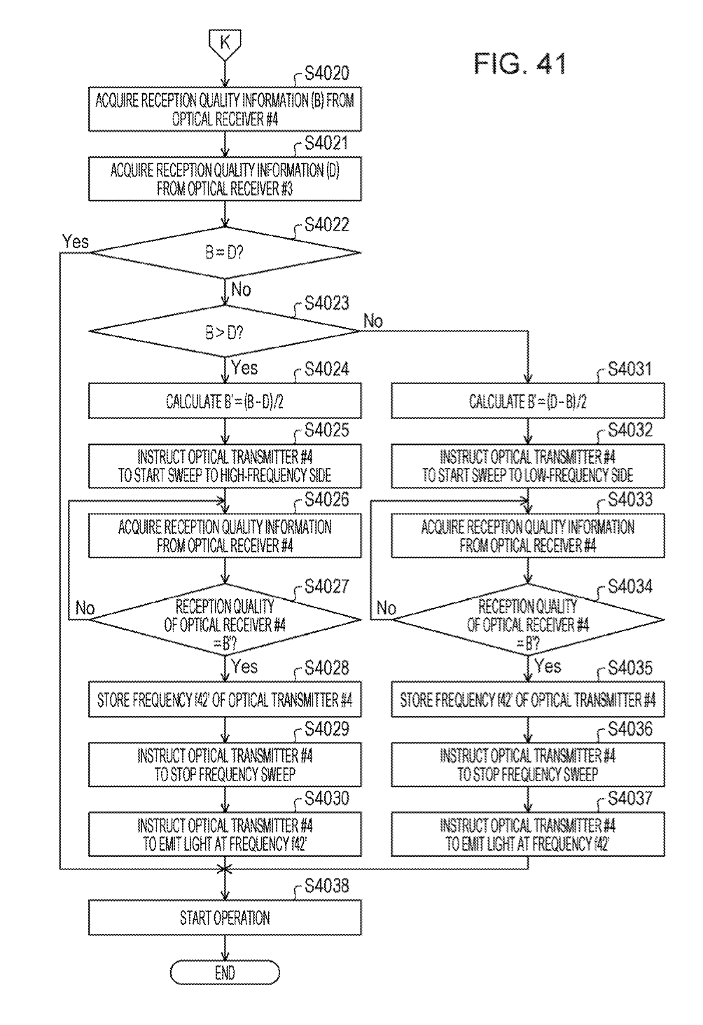

FIG. 40 and FIG. 41 are flowcharts illustrating one example of a process performed at the start of operation by a control device according to the eighth embodiment. The control device 330 according to the eighth embodiment performs, for example, each operation illustrated in FIG. 40 and FIG. 41 at the start of operation of the optical transfer system 300.

First, the control device 330 renders each sub-carrier to start by setting the frequencies of the optical transmitters 311a to 311d (#1 to #4) (operation S4001). The start of each sub-carrier in the operation S4001 may be rendered by, for example, the same processes as the operations S1401 to S1418 illustrated in FIG. 14 and FIG. 15.

Next, the control device 330 acquires the reception quality information from the optical receiver 322a (#1) (operation S4002). Reception quality indicated by the reception quality information acquired in the operation S4002 is A. In addition, the control device 330 acquires the reception quality information from the optical receiver 322b (#2) (operation S4003). Reception quality indicated by the reception quality information acquired in the operation S4003 is C.

Next, the control device 330 determines whether or not the reception quality A and the reception quality C indicated by each reception quality information acquired in the operations S4002 and S4003 are equal to each other (operation S4004). In a case where the reception quality A and the reception quality C are equal to each other (Yes in the operation S4004), the control device 330 transitions to an operation S4020. In a case where the reception quality A and the reception quality C are not equal to each other (No in the operation S4004), the control device 330 determines whether or not the reception quality A is higher than the reception quality C (operation S4005).

In a case where the reception quality A is higher than the reception quality C in the operation S4005 (Yes in the operation S4005), the extent of quality degradation for the sub-carrier #1 by the optical channel filter 321 may be determined to be smaller than the extent of quality degradation by interference between the sub-carriers #1 and #2. In this case, the control device 330 calculates A′=(A−C)/2 as a new quality threshold of the sub-carrier #1 (operation S4006). The quality threshold A′ is the average value of current each reception quality for the sub-carriers #1 and #2 and is a quality threshold that degrades reception quality for the sub-carrier #1 from the current reception quality therefor.

Next, the control device 330 instructs the transmission controller 313 by a control signal to start a sweep of the optical transmitter 311a (#1) to the low-frequency side (operation S4007). Accordingly, the transmission controller 313 starts a sweep that changes the frequency of the optical transmitter 311a (#1) to the low-frequency side.

Next, the control device 330 acquires the reception quality information from the optical receiver 322a (#1) (operation S4008). Next, the control device 330 determines whether or not the reception quality of the optical receiver 322a (#1) indicated by the reception quality information acquired in the operation S4008 is equal to the quality threshold A′ calculated in the operation S4006 (operation S4009). In a case where the reception quality is not equal to the quality threshold A′ (No in the operation S4009), the control device 330 returns to the operation S4008.

In a case where the reception quality is equal to the quality threshold A′ in the operation S4009 (Yes in the operation S4009), the control device 330 stores a frequency f12′ of the optical transmitter 311a (#1) at the time point of the reception quality being equal to the quality threshold A′ (operation S4010). Accordingly, the frequency f12′ of the optical transmitter 311a (#1) at which the reception quality of the optical receiver 322a (#1) is equal to the quality threshold A′ may be acquired.

Next, the control device 330 instructs the transmission controller 313 by a control signal to stop the frequency sweep of the optical transmitter 311a (#1) (operation S4011). Accordingly, the transmission controller 313 stops the frequency sweep of the optical transmitter 311a (#1).

Next, the control device 330 instructs the transmission controller 313 by a control signal to render the optical transmitter 311a (#1) to emit light at the frequency f12′ stored in the operation S4010 (operation S4012). Accordingly, the transmission controller 313 sets the frequency of the optical transmitter 311a (#1) to the frequency f12′. The control device 330 transitions to the operation S4020.

In a case where the reception quality A is lower than the reception quality C in the operation S4005 (No in the operation S4005), the extent of quality degradation for the sub-carrier #1 by the optical channel filter 321 may be determined to be greater than the extent of quality degradation by interference between the sub-carriers #1 and #2. In this case, the control device 330 calculates A′=(C−A)/2 as a new quality threshold of the sub-carrier #1 (operation S4013). The quality threshold A′ is the average value of current each reception quality for the sub-carriers #1 and #2 and is a quality threshold that improves reception quality for the sub-carrier #1 from the current reception quality therefor.

Next, the control device 330 instructs the transmission controller 313 by a control signal to start a sweep of the optical transmitter 311a (#1) to the high-frequency side (operation S4014). Accordingly, the transmission controller 313 starts a sweep that changes the frequency of the optical transmitter 311a (#1) to the high-frequency side.

Next, the control device 330 acquires the reception quality information from the optical receiver 322a (#1) (operation S4015). Next, the control device 330 determines whether or not the reception quality of the optical receiver 322a (#1) indicated by the reception quality information acquired in the operation S4015 is equal to the quality threshold A′ calculated in the operation S4013 (operation S4016). In a case where the reception quality is not equal to the quality threshold A′ (No in the operation S4016), the control device 330 returns to the operation S4015.

In a case where the reception quality is equal to the quality threshold A′ in the operation S4016 (Yes in the operation S4016), the control device 330 stores the frequency f12′ of the optical transmitter 311a (#1) at the time point of the reception quality being equal to the quality threshold A′ (operation S4017). Accordingly, the frequency f12′ of the optical transmitter 311a (#1) at which the reception quality of the optical receiver 322a (#1) is equal to the quality threshold A′ may be acquired.

Next, the control device 330 instructs the transmission controller 313 by a control signal to stop the frequency sweep of the optical transmitter 311a (#1) (operation S4018). Accordingly, the transmission controller 313 stops the frequency sweep of the optical transmitter 311a (#1).

Next, the control device 330 instructs the transmission controller 313 by a control signal to render the optical transmitter 311a (#1) to emit light at the frequency f12′ stored in the operation S4017 (operation S4019). Accordingly, the transmission controller 313 sets the frequency of the optical transmitter 311a (#1) to the frequency f12′. The control device 330 transitions to the operation S4020.

Next, the control device 330 acquires the reception quality information from the optical receiver 322d (#4) (operation S4020). Reception quality indicated by the reception quality information acquired in the operation S4020 is B. In addition, the control device 330 acquires the reception quality information from the optical receiver 322c (#3) (operation S4021). Reception quality indicated by the reception quality information acquired in the operation S4021 is D.

Next, the control device 330 determines whether or not the reception quality B and the reception quality D indicated by each reception quality information acquired in the operations S4020 and S4021 are equal to each other (operation S4022). In a case where the reception quality B and the reception quality D are equal to each other (Yes in the operation S4022), the control device 330 transitions to an operation S4038. In a case where the reception quality B and the reception quality D are not equal to each other (No in the operation S4022), the control device 330 determines whether or not the reception quality B is higher than the reception quality D (operation S4023).

In a case where the reception quality B is higher than the reception quality D in the operation S4023 (Yes in the operation S4023), the extent of quality degradation for the sub-carrier #4 by the optical channel filter 321 may be determined to be smaller than the extent of quality degradation by interference between the sub-carriers #3 and #4. In this case, the control device 330 calculates B′=(B−D)/2 as a new quality threshold of the sub-carrier #4 (operation S4024). The quality threshold B′ is the average value of current each reception quality for the sub-carriers #3 and #4 and is a quality threshold that degrades reception quality for the sub-carrier #4 from the current reception quality therefor.

Next, the control device 330 instructs the transmission controller 313 by a control signal to start a sweep of the optical transmitter 311d (#4) to the high-frequency side (operation S4025). Accordingly, the transmission controller 313 starts a sweep that changes the frequency of the optical transmitter 311d (#4) to the high-frequency side.

Next, the control device 330 acquires the reception quality information from the optical receiver 322d (#4) (operation S4026). Next, the control device 330 determines whether or not the reception quality of the optical receiver 322d (#4) indicated by the reception quality information acquired in the operation S4026 is equal to the quality threshold B′ calculated in the operation S4024 (operation S4027). In a case where the reception quality is not equal to the quality threshold B′ (No in the operation S4027), the control device 330 returns to the operation S4026.

In a case where the reception quality is equal to the quality threshold B′ in the operation S4027 (Yes in the operation S4027), the control device 330 stores a frequency f42′ of the optical transmitter 311d (#4) at the time point of the reception quality being equal to the quality threshold B′ (operation S4028). Accordingly, the frequency f42′ of the optical transmitter 311d (#4) at which the reception quality of the optical receiver 322d (#4) is equal to the quality threshold B′ may be acquired.

Next, the control device 330 instructs the transmission controller 313 by a control signal to stop the frequency sweep of the optical transmitter 311d (#4) (operation S4029). Accordingly, the transmission controller 313 stops the frequency sweep of the optical transmitter 311d (#4).

Next, the control device 330 instructs the transmission controller 313 by a control signal to render the optical transmitter 311d (#4) to emit light at the frequency f42′ stored in the operation S4028 (operation S4030). Accordingly, the transmission controller 313 sets the frequency of the optical transmitter 311d (#4) to the frequency f42′. The control device 330 transitions to the operation S4038.

In a case where the reception quality B is lower than the reception quality D in the operation S4023 (No in the operation S4023), the extent of quality degradation for the sub-carrier #4 by the optical channel filter 321 may be determined to be greater than the extent of quality degradation by interference between the sub-carriers #3 and #4. In this case, the control device 330 calculates B′=(D−B)/2 as a new quality threshold of the sub-carrier #4 (operation S4031). The quality threshold B′ is the average value of current each reception quality for the sub-carriers #3 and #4 and is a quality threshold that improves reception quality for the sub-carrier #4 from the current reception quality therefor.

Next, the control device 330 instructs the transmission controller 313 by a control signal to start a sweep of the optical transmitter 311d (#4) to the low-frequency side (operation S4032). Accordingly, the transmission controller 313 starts a sweep that changes the frequency of the optical transmitter 311d (#4) to the low-frequency side.

Next, the control device 330 acquires the reception quality information from the optical receiver 322d (#4) (operation S4033). Next, the control device 330 determines whether or not the reception quality of the optical receiver 322d (#4) indicated by the reception quality information acquired in the operation S4033 is equal to the quality threshold B′ calculated in the operation S4031 (operation S4034). In a case where the reception quality is not equal to the quality threshold B′ (No in the operation S4034), the control device 330 returns to the operation S4033.

In a case where the reception quality is equal to the quality threshold B′ in the operation S4034 (Yes in the operation S4034), the control device 330 stores the frequency f42′ of the optical transmitter 311d (#4) at the time point of the reception quality being equal to the quality threshold B′ (operation S4035). Accordingly, the frequency f42′ of the optical transmitter 311d (#4) at which the reception quality of the optical receiver 322d (#4) is equal to the quality threshold B′ may be acquired.

Next, the control device 330 instructs the transmission controller 313 by a control signal to stop the frequency sweep of the optical transmitter 311d (#4) (operation S4036). Accordingly, the transmission controller 313 stops the frequency sweep of the optical transmitter 311d (#4).

Next, the control device 330 instructs the transmission controller 313 by a control signal to render the optical transmitter 311d (#4) to emit light at the frequency f42′ stored in the operation S4035 (operation S4037). Accordingly, the transmission controller 313 sets the frequency of the optical transmitter 311d (#4) to the frequency f42′. The control device 330 transitions to the operation S4038.

Next, control is performed to start operation in which an optical signal based on the user data is transmitted from the transmission apparatus 310 to the transmission apparatus 320 (operation S4038), and a series of processes at the start of operation is ended. The frequencies f12 and f42 of the sub-carriers #1 and #4 may be changed in a case where the frequency of the optical transmitter 311a is reset in the operations S4005 to S4019 or the frequency of the optical transmitter 311d is reset in the operations S4023 to S4037.

Thus, the control device 330, for example, may reset the frequencies of the sub-carriers #2 and #4 based on the changed frequencies f12 and f42 of the sub-carriers #1 and #4 before the operation S4038. Resetting the frequencies of the sub-carriers #2 and #4 based on the frequencies f12 and f42 may be performed by, for example, the same processes as the operations S1415 to S1418 illustrated in FIG. 15.

While the configuration that resets the frequency of the optical transmitter 311a in the operations S4005 to S4019 and resets the frequency of the optical transmitter 311d in the operations S4020 to S4037 is described in FIG. 40 and FIG. 41, the present embodiment is not limited to such a configuration. For example, a configuration that either resets the frequency of the optical transmitter 311a (#1) or resets the frequency of the optical transmitter 311d (#4) may be used.

According to the transfer system 100 of the eighth embodiment, reception quality for at least one of the first optical signal and the second optical signal may be compared with reception quality for an optical signal except for the first optical signal and the second optical signal after the initial wavelength of each sub-carrier is set. In addition, the wavelength of at least one of the first optical signal and the second optical signal may be controlled based on the result of comparison between each reception quality. Accordingly, uniform reception quality may be achieved for at least one of the first optical signal and the second optical signal and for an optical signal except for the first optical signal and the second optical signal.

For example, when the above predetermined values A and B are excessively low, the sub-carrier #1 is set to be on the more high-frequency side, and the sub-carrier #4 is set to be on the more low-frequency side. Thus, the spacing between the sub-carriers #1 to #4 is narrowed, and the extent of quality degradation by interference between the sub-carriers #1 to #4 becomes greater than the extent of quality degradation for the sub-carriers #1 and #4 by the optical channel filter 321.

In such a case, the control device 330 resets the sub-carrier #1 to be on the more low-frequency side and resets the sub-carrier #4 to be on the more high-frequency side. Accordingly, the extent of quality degradation by interference between the sub-carriers #1 to #4 is the same as the extent of quality degradation for the sub-carriers #1 and #4 by the optical channel filter 321, and uniform reception quality may be achieved for the sub-carriers #1 to #4.

Meanwhile, when the above predetermined values A and B are excessively high, the sub-carrier #1 is set to be on the more low-frequency side, and the sub-carrier #4 is set to be on the more high-frequency side. Thus, the sub-carriers #1 and #4 approaches the restricted band of the optical channel filter 321, and the extent of quality degradation for the sub-carriers #1 and #4 by the optical channel filter 321 becomes greater than the extent of quality degradation by interference between the sub-carriers #1 to #4.

In such a case, the control device 330 resets the sub-carrier #1 to be on the more high-frequency side and resets the sub-carrier #4 to be on the more low-frequency side. Accordingly, the extent of quality degradation by interference between the sub-carriers #1 to #4 is the same as the extent of quality degradation for the sub-carriers #1 and #4 by the optical channel filter 321, and uniform reception quality may be achieved for the sub-carriers #1 to #4.

### Ninth Embodiment

A different part of a ninth embodiment from the first to eighth embodiments will be described. While description is provided in the case of determining the frequency of each of both end sub-carriers and then determining the frequencies of sub-carriers except for both end sub-carriers so as to have equal frequency spacing in the first to eighth embodiment, a method for determining the frequency of each sub-carrier other than both end sub-carriers is not limited thereto. In the ninth embodiment, for example, the frequencies of the sub-carriers #2 and #3 are determined such that the frequency spacing between each sub-carrier is equal to frequency spacing corresponding to the spectrum width of each sub-carrier.

[Each Sub-Carrier]

FIG. 42 is a diagram illustrating one example of each sub-carrier in an optical transfer system according to a ninth embodiment. The same part of FIG. 42 as the part illustrated in FIG. 8, FIG. 10, FIG. 11, and FIG. 13 will be designated by the same reference sign and will not be described.

The spectrum width of a sub-carrier varies according to the above baud rate, setting of the Nyquist filter, and the like. For example, as illustrated in FIG. 42, the spectrum width of the sub-carrier #3 is twice as great as the spectrum widths of the sub-carriers #1, #2, and #4.

In this case, if the frequencies of the sub-carriers #1 to #4 are set with equal frequency spacing, the spacing among the sub-carriers #2 to #4 is narrower than the spacing between the sub-carriers #1 and #2. Thus, for example, reception quality for the sub-carriers #2 to #4 is lower than reception quality for the sub-carrier #1, and reception quality is not uniform for the sub-carriers #1 to #4.

[Determination of Frequency of Sub-Carrier Other than Both End Sub-Carriers]

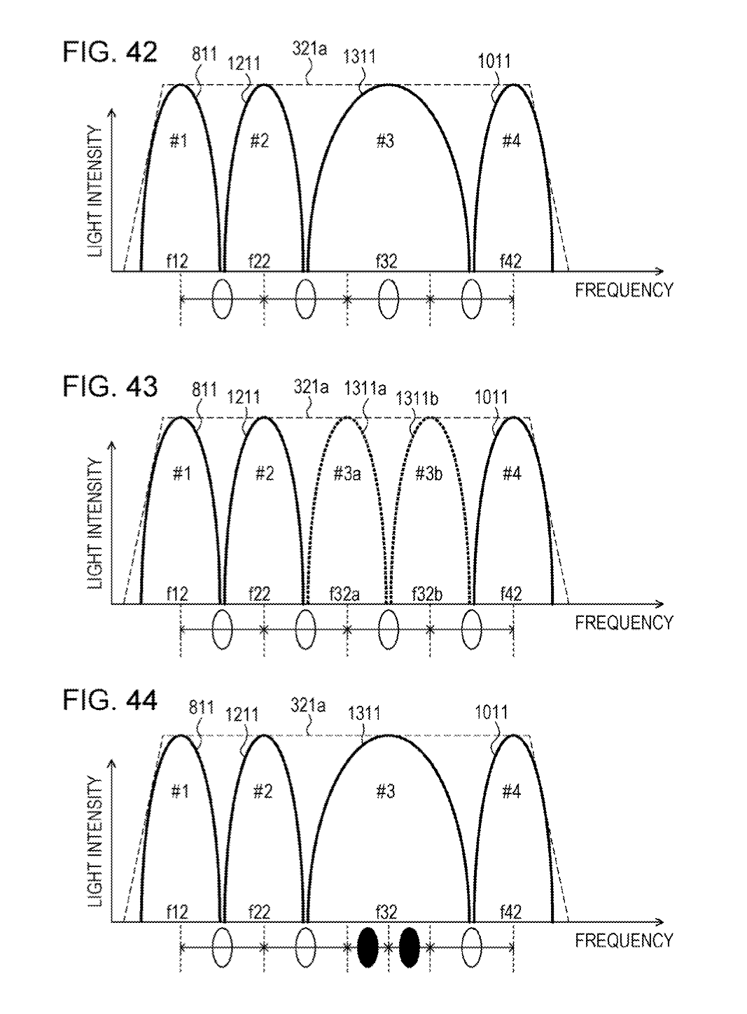

FIG. 43 and FIG. 44 are diagrams illustrating one example of determining the frequency of a sub-carrier other than both end sub-carriers in an optical transfer system according to the ninth embodiment. The same part of FIG. 43 and FIG. 44 as the part illustrated in FIG. 42 will be designated by the same reference sign and will not be described.

For example, the sub-carrier #3 has a width twice as great as the widths of the sub-carriers #1, #2, and #4. Thus, as illustrated in FIG. 43, the sub-carrier #3 is regarded as two sub-carriers 1311a and 1311b (#3a and #3b). That is, after both end sub-carriers #1 and #4 are determined, the bandwidth between the sub-carriers #1 and #4 is divided in four equal parts on the assumption that three sub-carriers 1211, 1311a, and 1311b exist between the sub-carriers #1 and #4.

For example, the control device 330 determines the frequency f22 of the sub-carrier 1211 (#2) by using Expression (8) below.

f22=f12+((f42−f12)/4) (8)

The control device 330 determines a frequency f32a of the sub-carrier 1311a (#3a) by using Expression (9) below.

f32a=f12+2×((f42−f12)/4) (9)

The control device 330 determines a frequency f32b of the sub-carrier 1311b (#3b) by using Expression (10) below.

f32b=f12+3×((f42−f12)/4) (10)

As illustrated in FIG. 44, the control device 330 determines the actual frequency f32 of the sub-carrier 1311 (#3) by using Expression (11) below.

f32=(f32b−f32a)/2 (11)

According to the transfer system 100 of the ninth embodiment, the wavelength of an optical signal except for the first optical signal and the second optical signal may be determined such that frequency spacing between optical signals is equal to frequency spacing corresponding to the spectrum width of each optical signal. For example, the wavelength of an optical signal except for the first optical signal and the second optical signal is determined such that the frequency spacing between optical signals having adjacent wavelengths is increased as the spectrum widths of the optical signals are widened.

Accordingly, uniform reception quality may be achieved for each optical signal.

For example, the sub-carrier #3 has a wider spectrum width than the other sub-carriers #1, #2, and #4 in the example illustrated in FIG. 42. Thus, since the sub-carrier #3 is adjacent to the sub-carriers #2 and #4, the frequency spacing over the sub-carriers #2 to #4 is set to be wider than the frequency spacing between the sub-carriers #1 and #2. The frequency spacing between the sub-carrier #3 having a wide spectrum width and an adjacent sub-carrier is set to be wide, and a decrease in reception quality for the sub-carrier #3 and for the sub-carriers #2 and #4 adjacent to the sub-carrier #3 may be reduced.

Any part or the entirety of various processing functions performed by the transmission controller 313 and the control device 330 may be performed on a central processing unit (CPU), a digital signal processor (DSP), a field programmable gate array (FPGA), or the like. In addition, any part or the entirety of the various processing functions may be performed on a program interpreted and executed by a CPU or the like or on hardware configured of a wired logic.

A region storing various types of information may be configured of, for example, a read only memory (ROM) or a random access memory (RAM) such as a synchronous dynamic random access memory (SDRAM), a magnetoresistive random access memory (MRAM), or a non-volatile random access memory (NVRAM).

As described heretofore, according to the transmission apparatus and the wavelength setting method, an increase in the size of a calculation circuit may be reduced, and arrangement of wavelengths may be adjusted in a small amount of time. In addition, each above embodiment may be realized in an appropriate combination thereof.

For example, in recent years, the transfer capacity of communication devices tends to be increased, and communication devices have to have a large capacity and a high speed. Regarding this point, in optical communication transfer, a transfer speed of 40 [Gbps] to 100 [Gbps] is mainly used for the purpose of achieving a high speed, and a WDM system that communicates by using a plurality of frequencies at the same time is used for the purpose of achieving a large capacity. A general WDM system is defined by optical internetworking forum (OIF) to have optical signals arranged at frequency spacing of 50 [GHz].

While a further increase in transfer capacity is desired, a super-channel method that may achieve a higher transfer efficiency than the WDM system in the related art is suggested. Frequencies are flexibly set in the super-channel, and thus the transfer capacity may be increased compared with the WDM type in the related art by efficiently using a transfer frequency.

In the super-channel method, for example, a frequency bandwidth that is restricted by a receiving side optical channel filter has to be efficiently used. Thus, in order to improve the efficiency in use of frequencies, a frequency grid has to be set to be as narrow as possible.

However, when the spacing between each sub-carrier or the spacing between the restricted band of the optical channel filter and the sub-carrier is excessively narrowed in order to achieve frequency efficiency, interference between adjacent sub-carriers, attenuation by the restricted band, and the like are caused, and signal quality is degraded. Thus, appropriate frequency arrangement (wavelength arrangement) is desired in order to improve reception quality for each sub-carrier.

Regarding this point, in order to perform tuning to reduce interference between adjacent channels, for example, considered is a technique that detects a frequency gap on the receiving side and controls a transmission frequency from a detection result. However, this method acquires correspondence data between a large amount of IQ vectors and time to perform a digital Fourier transform and calculates precise frequency spacing and thus uses a large-scale memory and a complex calculation processing circuit. In addition, since control is repeated to perform micro adjustment based on the calculated frequency gap information, a large amount of time may be desired until adjustment is performed to a desired frequency gap. A large-scale memory and a complex calculation processing circuit or a large amount of time until a frequency gap is adjusted are exemplified as problems.

Regarding this point, according to above each embodiment, the wavelengths of both end sub-carriers of a super-channel may be determined by monitoring reception quality while the wavelength of an optical signal transmitted is changed, and the wavelengths of the remaining sub-carriers may be determined by using the determined wavelengths. Accordingly, the amount of calculation is reduced, and wavelength arrangement may be performed in a small amount of time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a plurality of generators configured to generate a plurality of optical signals having wavelengths included in a predetermined band, the wavelengths being variable;
a transmitter configured to multiplex the plurality of optical signals generated by the plurality of generators and transmit the plurality of optical signals multiplexed thereby to another transmission apparatus;
a memory; and
a processor coupled to the memory and the processor configured to:
monitor reception quality of an optical signal for monitoring received by the another transmission apparatus while changing a wavelength of the optical signal for monitoring which is generated by a generator of the plurality of generators,
determine a first wavelength of a first optical signal having a longest wavelength in the plurality of optical signals and a second wavelength of a second optical signal having a shortest wavelength in the plurality of optical signals, based on the reception quality monitored,
determine a wavelength of an optical signal of the plurality of optical signals except for the first optical signal and the second optical signal, based on the first wavelength and the second wavelength, and
control the wavelengths of the plurality of optical signals generated by the plurality of generators, based on the wavelength of the plurality of optical signals determined.

2. The transmission apparatus according to claim 1,
wherein the processor determines the first wavelength and the second wavelength so that reception qualities of the first optical signal and the second optical signal have predetermined qualities, respectively.

3. The transmission apparatus according to claim 1,
wherein the processor
determines the first wavelength when the wavelength of the optical signal for monitoring is changed within a range assignable for the first wavelength, and
determines the second wavelength when the wavelength of the optical signal for monitoring is changed within a range assignable for the second wavelength.

4. The transmission apparatus according to claim 1,
wherein the processor determines the wavelength of the optical signal of the plurality of optical signals except for the first optical signal and the second optical signal so that the wavelengths of the plurality of optical signals are set with equal frequency spacing.

5. The transmission apparatus according to claim 1,
wherein the processor
controls the wavelengths of the plurality of optical signals generated by the plurality of generators before operation in which the plurality of optical signals generated by the plurality of generators are multiplexed and transmitted, and
after the operation is started, controls the wavelength of at least any of the plurality of optical signals to be generated by the plurality of generators, based on reception quality of at least any of the plurality of optical signals which are generated by the plurality of generators and received by the another transmission apparatus.

6. The transmission apparatus according to claim 1,
wherein the processor, when changing the wavelength of the optical signal for monitoring, changes a wavelength of local light in correspondence with the wavelength of the optical signal for monitoring, the local light being multiplexed with the plurality of optical signals transmitted by the transmitter.

7. The transmission apparatus according to claim 1,
wherein the processor sets a spectrum width of the optical signal for monitoring at a time of the monitoring to be greater than spectrum widths of the plurality of optical signals at a time of operation in which the plurality of optical signals generated by the plurality of generators are multiplexed and transmitted.

8. The transmission apparatus according to claim 7,
wherein the processor increases the spectrum width of the optical signal for monitoring at the time of the monitoring by adjusting a baud rate of the optical signal for monitoring.

9. The transmission apparatus according to claim 7,
wherein the controller increases the spectrum width of the optical signal for monitoring at the time of the monitoring by adjusting a Nyquist filter that processes the optical signal for monitoring in a generator of the plurality of generators.

10. The transmission apparatus according to claim 1,
wherein the processor
determines the first wavelength when a wavelength of the optical signal for monitoring is changed within a first range assignable for the first wavelength,
sets a second range assignable for the second wavelength, based on the first wavelength determined, and
determines the second wavelength when the wavelength of the optical signal for monitoring is changed within the second range set, or
wherein the processor
determines the second wavelength when the wavelength of the optical signal for monitoring is changed within the second range assignable for the second wavelength,
sets the first range assignable for the first wavelength, based on the second wavelength determined, and
determines the first wavelength when the wavelength of the optical signal for monitoring is changed within the first range set.

11. The transmission apparatus according to claim 1,
wherein the processor, after controlling the wavelengths of the plurality of optical signals generated by the plurality of generators,
compares the reception quality monitored of at least one of the first optical signal and the second optical signal with the reception quality monitored of at least one of the plurality of optical signals except for the first optical signal and the second optical signal, and
controls the wavelength of at least one of the first optical signal and the second optical signal, based on a comparison result for the reception quality.

12. The transmission apparatus according to claim 1,
wherein the processor determines the wavelength of an optical signal of the plurality of optical signals except for the first optical signal and the second optical signal so that the wavelength of the optical signal is set with frequency spacing corresponding to a spectrum width of the optical signal.

13. The transmission apparatus according to claim 12,
wherein the processor determines the wavelength of the optical signal of the plurality of optical signals except for the first optical signal and the second optical signal so that frequency spacing between optical signals of the plurality of optical signals having adjacent wavelengths is increased as spectrum widths of the optical signals having adjacent wavelengths are increased.

14. The transmission apparatus according to claim 1,
wherein the predetermined bandwidth is a bandwidth of a super-channel that is a channel in which the plurality of optical signals are combined.

15. A transmission apparatus comprising:
an optical filter configured to extract a plurality of optical signals having wavelengths in a predetermined band from an optical signal transmitted by another transmission apparatus which multiplexes the plurality of optical signals;
a plurality of receivers each configured to receive the plurality of optical signals extracted by the optical filter, and detect reception quality of an optical signal of the plurality of optical signals received thereby;
a memory; and
a processor coupled to the memory and the processor configured to:
monitor the reception quality of the optical signal for monitoring detected thereby while changing a wavelength of the optical signal for monitoring,
determine a first wavelength of a first optical signal having a longest wavelength in the plurality of optical signals and a second wavelength of a second optical signal having a shortest wavelength in the plurality of optical signals, based on the reception quality monitored,
determine a wavelength of an optical signal of the plurality of optical signals except for the first optical signal and the second optical signal, based on the first wavelength and the second wavelength, and
generate a control signal to control the wavelengths of the plurality of optical signals generated in the another transmission apparatus, based on wavelengths of the plurality of optical signals determined.

16. The transmission apparatus according to claim 15,
wherein the processor control the optical filter to set the predetermined bandwidth at a time of the monitoring to be narrower than the predetermined bandwidth at a time of operation in which the plurality of optical signals are multiplexed and transmitted by the another transmission apparatus.

17. A wavelength setting method of transmission system including a first transmission apparatus configured to transmit a plurality of optical signals having wavelengths included in a predetermined band, and a second transmission apparatus configured to receive the plurality of optical signals transmitted by the first transmission apparatus, the wavelength setting method comprising:
generating the plurality of optical signals having wavelengths included in the predetermined band, the wavelengths being variable, by the first transmission apparatus;
multiplexing the plurality of optical signals, by the first transmission apparatus;
transmitting the plurality of optical signals multiplexed by the first transmission apparatus to the second transmission apparatus;
extracting the plurality of optical signals having wavelengths included in the predetermined band received by the second transmission apparatus, by the second transmission apparatus;
detecting reception quality of an optical signal of the plurality of optical signals extracted, by the second transmission apparatus;
monitoring the reception quality of the optical signal for monitoring detected while changing the wavelength of the optical signal for monitoring, by the first transmission apparatus;
determining a first wavelength of a first optical signal having a longest wavelength in the plurality of optical signals and a second wavelength of a second optical signal having a shortest wavelength in the plurality of optical signals, based on the reception quality monitored, by the first transmission apparatus;
determining a wavelength of an optical signal of the plurality of optical signals except for the first optical signal and the second optical signal, based on the first wavelength and the second wavelength, by the first transmission apparatus; and
controlling the wavelengths of the plurality of optical signals, based on the wavelength of the plurality of optical signals determined, by the first transmission apparatus.
